(19) United States
(12) Patent Application Publication
(10) Pub. No.: US 2025/0139765 A1
(43) Pub. Date: May 1, 2025

(54) COMPUTATIONAL TECHNIQUES FOR THREE-DIMENSIONAL RECONSTRUCTION AND MULTI-LABELING OF SERIALLY SECTIONED TISSUE

(71) Applicant: The Johns Hopkins University, Baltimore, MD (US)

(72) Inventors: Ashley Kiemen, Baltimore, MD (US); Pei-Hsun Wu, Towson, MD (US); Laura D. Wood, Towson, MD (US); Denis Gaston Wirtz, Washington, DC (US); Ralph Hruban, Baltimore, MD (US); Alexandra Sneider, Baltimore, MD (US); Luo Gu, Baltimore, MD (US); Mehran Habibi, Perry Hall, MD (US); Joo Ho Kim, Baltimore, MD (US)

(21) Appl. No.: 18/572,352

(22) PCT Filed: Jun. 24, 2022
(86) PCT No.: PCT/US2022/034827

§ 371 Date: Dec. 20, 2023

Related U.S. Application Data
(60) Provisional application No. 63/215,198, filed on Jun. 25, 2021.
(60) Provisional application No. 63/215,206, filed on Jun. 25, 2021.

(51) Int. Cl. G06T 7/00; G06T 7/62; G06T 15/08; G06V 10/762

(52) U.S. Cl. CPC G06T 7/0012; G06T 7/62; G06T 15/08; G06V 10/762; G06T 2200/04; G06T 2207/30024

(57) ABSTRACT

This document generally describes methods and systems for generating digital reconstructions of tissue from humans or other species. The method can, for example, include receiving, at a computing system, image data of a tissue sample, where one or more sections of the tissue sample are stained with hematoxylin and eosin (H&E), registering the image data to generate registered image data, identifying tissue subtypes based on application of a machine learning model to the registered image data, annotating the identified tissue subtypes to generate annotated image data, and determining a digital volume of the tissue sample in three dimensional (3D) space based on the annotated image data. The disclosed technology can provide for single-cell analysis and other analysis of tissue samples, such as early detection of cancer in human tissue samples.

### INCORPORATION BY REFERENCE

This application claims priority to U.S. Provisional Application Ser. No. 63/215,198, filed on Jun. 25, 2021, entitled COMPUTATIONAL TECHNIQUES FOR THREE-DIMENSIONAL RECONSTRUCTION AND MULTI-LABELING OF SERIALLY SECTIONED TISSUE and 63/215,206, filed on Jun. 25, 2021, entitled DEEP LEARNING IDENTIFICATION OF STIFFNESS MARKERS IN BREAST CANCER, the disclosures of which are incorporated by reference in their entirety.

This invention was made with government support under grants CA210173 and CA174388 awarded by the National Institutes of Health, as well as DGE-1746891 awarded by the National Science Foundation. The government has certain rights in the invention.

### TECHNICAL FIELD

This document generally describes devices, systems, and methods related to three-dimensional reconstruction of tissue from image data.

### BACKGROUND

Tissue in human and/or animal bodies can have a variety of densities. Sometimes, researchers may not be able to visualize and quantify dense tissue structures. Moreover, researchers may not be able to visualize and quantify such structures in three-dimensional (3D) space. Some serial histological sectioning models use tissue markers and/or manual annotations in order to reconstruct tissue in 3D space. Tissue clearing is another type of model that can use specific markers to visualize tissue components. Tissue clearing methods may be limited to small volumes and limited numbers of tissue markers due to clearing and stain penetration challenges.

The growth and spread of invasive cancer, and the relationship of invasive cancers to pre-existing structures such as vessels, nerves, and ducts, may be analyzed through two-dimensional (2D) representations. Pancreatic ductal adenocarcinoma (PDAC), for example, is one of the deadliest forms of cancer, with a 5-year survival rate of only 9%. PDAC can arise from well-characterized precursor lesions in pancreatic ducts, is surrounded by an immunosuppressive desmoplastic stroma, and has a proclivity for vascular invasion and metastasis to the liver. These biological factors may be insufficiently understood when studied in 2D, as it can be difficult if not impossible to infer information such as connectivity and 3D cell density and morphology from 2D media.

In pancreatic cancer, tissue clearing can be used to show that sustained epithelial-to-mesenchymal transition may not be required for vascular invasion. However, inconsistent clearing and poor antibody penetration into dense desmoplastic stroma that characterizes PDAC, as well as limits on size of tissues that can be successfully cleared, hinder the power of tissue clearing techniques when applied to pancreatic cancer. Reconstruction of serial, hematoxylin and eosin (H&E) stained sections can also be implemented to study disease in 3D. Time-consuming manual annotations or costly immunohistochemical (IHC) labeling or mass spectrometry that can be used to identify biological components make labelling cellular and structural bodies in serial sections a timely and costly process that limits its applicability.

### SUMMARY

The document generally describes to computational pipelines that can be used for 3D reconstruction and analysis of different volumes of tissue. The disclosed technology can generate 3D tissue reconstructions using, for example, (1) nonlinear image registration to create a digital tissue volume from scans of serially sectioned histological samples, (2) color deconvolution, filtering, and identification of 2D intensity minima to identify single cells, and (3) deep learning semantic segmentation to identify tissue subtypes. The disclosed technology can be used to generate a multi-labelled digital 3D map of tissue, for example, at cm-scale, micrometer, single cell resolution, and/or other scales or resolutions. The disclosed technology can also be used for visualization and quantification of tissue volume matrices.

The disclosed technology therefore provides for 3D reconstruction and quantification of large tissue volumes at single-cell resolution. The disclosed technology can digitally reconstruct 3D tissues from scanned, serially sectioned H&E tissue sections using image registration techniques. The disclosed technology can incorporate deep learning semantic segmentation to label distinct tissue types of a human pancreas without incorporation of additional stains. The disclosed technology can provide for single-cell analysis and can be utilized to quantify in 3D cellular content and spatial distributions amongst different non-neoplastic and neoplastic tissue types, information that can be used in design of early detection tests. The disclosed technology can be used to analyze normal pancreas tissue and pancreas tissue containing cancer precursors and PDAC in tissues of cm-dimension and μm-resolution. The disclosed technology can therefore be used to determine 3D insight of PDAC development and progression in situ. Moreover, the disclosed technology empowers enumeration of cellularity and structure of tumor microenvironments, allowing identification of distinct pre-cancer phenotypes that may vary in 3D morphology. Cancer tends to spread along collagen fibers that are highly aligned to the existing ductal, lobular, vascular, and neural structures in the pancreas, allowing distant extension from the bulk tumor. Accordingly, the disclosed technology establishes ways to transform broadly a structural study of human diseases and provide fundamental quantitative metrics for improved design of physio-pathologically relevant 3D model biological systems.

The disclosed technology can provide for identifying characteristics of various cancers that may only be possible through 3D analysis of tissue samples. For example, the disclosed technology provides for visualizing complex, curved, and tubular structure of a pancreatic ductal system. Using the disclosed technology reveals that many anatomically separate precursor lesions can develop in small or large ducts, and that individual precursors commonly present both in the pancreatic ducts and in foci of ADM in the acinar lobules. The disclosed technology also reveals that invasive cancer cells can extend from the central tumor along existing structures such as veins, nerves and peri-ductal, vascular, lobular, and neural collagen. Moreover, the disclosed technology provides for accurate and reliable identification of cancer cells protruding along aligned fibers, which can suggest that pancreatic cancer cells, or other cancer cells, in-situ may invade more easily in regions of aligned collagen and nerve fibers.

The disclosed technology provides a powerful complement to tissue clearing and current serial sectioning techniques used to study 3D tissue microarchitecture. Tissue clearing can be a popular approach to study 3D tissues, wherein intact samples can be rendered semi-transparent, labeled, and imaged using confocal or light-sheet microscopy. However, long wait times of days to weeks between protocol steps, inconsistent antibody penetration, limits on the size of tissues that can be cleared, number of labels that can be used, and longstanding complications in quantification of the rendered 3D datasets may present challenges in using such techniques. Current serial sectioning methods may also bypass some of the shortcomings of tissue clearing, albeit through introduction of new challenges. The sectioning of tissue can, for example, cause unpredictable warping, thereby requiring sophisticated registration techniques. Additionally, many serial sectioning methods may rely on expensive techniques for labeling including IHC labeling, mass spectrometry, and manual annotation. The disclosed technology, on the other hand, can be a powerful and effective tool to integrate current tissue imaging techniques into a computationally efficient and accurate technique for use in analyzing various types of cancer cells and/or tissue samples. For example, the disclosed technology incorporates nonlinear image registration and deep learning techniques to create multi-labelled tissue volumes using H&E images, which is a relatively inexpensive histological technique. The disclosed technology can derive quality 3D reconstructions while skipping at least two intervening sections, future addition of IHC labeling, spatial ‘omics’, and gene expression imaging to the intervening sections will increase the number of labels beyond what is currently achievable. The number of tissue and molecular phenotypes that the disclosed technology can label in the pancreas and tissues of other origin can also unlock previously unknown insights into human tissue, health, and disease.

In some implementations, the disclosed technology can be used to analyze invasive cancers. Increased knowledge of a 3D microenvironment of tissues and changes to this microenvironment with progressive tumorigenesis can lead to a better understanding of underlying biology of cancers, such as pancreatic cancer. For example, PDAC is one of the deadliest forms of cancer. A tumor microenvironment of PDAC can be associated with tumorigenesis through regulation of cellular physiology, signaling systems, and gene expression profiles of cancer cells. The disclosed technology provides methods, systems, and processes to reconstruct 3D centimeter-scale tissues containing billions of cells from serially sectioned histological samples, utilizing deep learning approaches to recognize eight distinct tissue subtypes from hematoxylin and eosin stained sections at micrometer and single-cell resolution. Using samples from a range of normal, precancerous, and invasive pancreatic cancer tissue, cancer invasion in a tumor environment can be mapped into 3D space.

The disclosed technology can also be used and applied to a variety of types of tissues. For example, the disclosed technology can be applied to human samples of breast, pancreas, liver, and skin tissue. The disclosed technology can also be applied to samples from animals, such as mouse samples of breast, lung, skin, and prostate tissue. Even more so, the disclosed technology can be applied to engineered tissues designed to emulate human bone, liver, and skin. Human or other animal tissues can be compared to model systems, such as mouse models of human disease, or engineered tissue systems via 3D reconstruction of human, animal, and/or engineered tissue.

Thus, the disclosed technology is generally applicable to all frozen and/or FFPE tissue, so long as that tissue is amenable to H&E, IHC, immunofluorescence (IF), imaging mass cytometry (IMC), and/or spatial transcriptomics staining.

In addition to the embodiments of the attached claims and the embodiments described above, the following numbered embodiments are also innovative.

Embodiment 1 is a method for generating a digital reconstruction of tissue, the method comprising: receiving, at a computing system, image data of a tissue sample, wherein one or more sections of the tissue sample are stained with hematoxylin and eosin (H&E); registering, by the computing system, the image data to generate registered image data based on mapping independent serial images of the image data to a common coordinate system using non-linear image registration; identifying, by the computing system, tissue subtypes based on application of a machine learning model to the registered image data; annotating, by the computing system, the identified tissue subtypes to generate annotated image data; determining, by the computing system, a digital volume of the tissue sample in three dimensional (3D) space based on the annotated image data; and returning, by the computing system, the digital volume of the tissue sample in 3D space to be presented in a graphical user interface (GUI) display at a user computing device.

Embodiment 2 is the method of embodiment 1, wherein the tissue sample is at least one of a pancreatic tissue sample, a skin tissue sample, a breast tissue sample, a lung tissue sample, and a small intestines tissue sample.

Embodiment 3 is the method of any one of embodiments 1 and 2, further comprising determining, by the computing system, 3D radial density of each identified tissue subtype and each cell in the digital volume of the tissue sample.

Embodiment 4 is the method of any one of embodiments 1 through 3, wherein the image data is between 1× and 40× magnification, wherein lateral x and y resolution is between 0.2 μm and 10 μm and axial z resolution is between 0.5 μm and 40 μm.

Embodiment 5 is the method of any one of embodiments 1 through 4, wherein registering, by the computing system, the image data to generate registered image data further comprises: identifying, as a point of reference, a center image of the image data; and calculating global registration for each of the image data based on the point of reference.

Embodiment 6 is the method of any one of embodiments 1 through 5, wherein calculating global registration further comprises iteratively calculating registration angle and translation for each of the image data.

Embodiment 7 is the method of any one of embodiments 1 through 6, further comprising calculating elastic registration for each of the image data based on calculating rigid registration of cropped image tiles of each of the globally registered image data at intervals that range between 0.1 mm and 5 mm.

Embodiment 8 is the method of any one of embodiments 1 through 7, wherein the tissue sample includes at least one of normal human tissue, precancerous human tissue, and cancerous human tissue.

Embodiment 9 is the method of any one of embodiments 1 through 8, further comprising normalizing, by the computing system, the registered image data to generate normalized image data based on: correcting two dimensional (2D) serial cell counts based on in-situ measured nuclear diameter of cells in the tissue sample; locating nuclei in each histological section of the registered image data based on color deconvolution; for each located nuclei, measuring in-situ diameters of each cell type; mapping the nuclei in a serial 2D z plane; and extrapolating true cell counts from the serial 2D z plane.

Embodiment 10 is the method of any one of embodiments 1 through 9, further comprising normalizing, by the computing system, the registered image data to generate normalized image data based on: extracting, using color deconvolution, a hemotoxylin channel from each of the image data depicting the one or more sections of the tissue samples stained with H&E; and for each of the image data depicting the one or more sections of the tissue samples stained with H&E: identifying a tissue region in the image data based on detecting regions of the image data with low green channel intensity and high red-green-blue (rbg) standard deviation; converting rgb channels in the image data to optical density; identifying clusters, based on kmeans clustering, to represent one or more optical densities of the image data; and deconvolving the image data, based on the one or more optical densities, into hemotoxylin, eosin, and background channel images.

Embodiment 11 is the method of any one of embodiments 1 through 10, further comprising: smoothing, for each of the image data, the hemotoxylin channel image; and identifying, for each of the image data, a nuclei in the smoothed hemotoxylin channel image.

Embodiment 12 is the method of any one of embodiments 1 through 11, wherein the machine learning model was trained, by the computing system, with manual annotations of one or more tissue subtypes in a plurality of training tissue image data, wherein the machine learning model is at least one of a deep learning semantic segmentation model, a convolutional neural network (CNN), and a U-net structure.

Embodiment 13 is the method of any one of embodiments 1 through 12, further comprising training, by the computing system, the machine learning model based on randomly overlaying extracted annotated regions of one or more tissue samples on a training image and cutting the training image into the plurality of training tissue image data.

Embodiment 14 is the method of any one of embodiments 1 through 13, wherein training the machine learning model further comprises: identifying, by the computing system, bounding boxes around each annotated region of the one or more tissue samples; and randomly overlaying each identified bounding box containing a least represented tissue subtype on a blank image tile until the tile is at least 65% full of annotated regions of the one or more tissue samples.

Embodiment 15 is the method of any one of embodiments 1 through 14, wherein the image tile is an rgb image composed of overlaid manual annotations, and wherein the image tile is cut, by the computing system, into a plurality of image tiles for use with the machine learning model.

Embodiment 16 is the method of any one of embodiments 1 through 15, wherein the machine learning model is trained, by the computing system, to identify at least one of inflammation, cancer cells, and extracellular matrix (ECM) in the image data.

Embodiment 17 is the method of any one of embodiments 1 through 16, wherein the tissue subtypes include at least one of normal ductal epithelium, pancreatic intraepithelial neoplasia, intraductal papillary mucinous neoplasm, PDAC, smooth muscle and nerves, acini, fat, ECM, and islets of Langerhans.

Embodiment 18 is the method of any one of embodiments 1 through 17, wherein determining, by the computing system, the digital volume of the tissue sample in 3D space based on the annotated image data comprises consolidating multi-labeled image data into a 3D matrix based on registering (i) the annotated image data and (ii) cell coordinates counted on unregistered histological sections of the annotated image data.

Embodiment 19 is the method of any one of embodiments 1 through 18, wherein the 3D matrix is subsampled, by the computing system, using nearest neighbor interpolation from original voxel dimensions of 2×2×12 μm³/voxel to an isotropic 12×12×12 μm³/voxel.

Embodiment 20 is the method of any one of embodiments 1 through 19, further comprising classifying, by the computing system, the image data based on pixel resolution, annotation tissue classes, color definitions for labeling of tissue classes, and names of tissue subtypes corresponding to labels associated with each class of tissue subtypes.

Embodiment 21 is the method of any one of embodiments 1 through 20, further comprising, for each tissue subtype: summing, by the computing system, pixels of the tissue sample in a z dimension; generating, by the computing system, a projection of a volume of the tissue sample on an xy axis; normalizing, by the computing system, the projection based on the projection's maximum; and visualizing, by the computing system, the projection using a same color scheme created for visualization of the tissue sample in the 3D space.

Embodiment 22 is the method of any one of embodiments 1 through 21, further comprising calculating, by the computing system, cell density of each tissue subtype in the tissue sample using the digital volume of the tissue sample.

Embodiment 23 is the method of any one of embodiments 1 through 22, further comprising measuring, by the computing system, tissue connectivity in the tissue sample using the digital volume of the tissue sample.

Embodiment 24 is the method of any one of embodiments 1 through 23, further comprising calculating, by the computing system, collagen fiber alignment in the tissue sample using the digital volume of the tissue sample.

Embodiment 25 is the method of any one of embodiments 1 through 24, further comprising calculating, by the computing system, a fibroblast aspect ratio of the tissue sample based on measuring a length of major and minor axis of nuclei in a ductal submucosa in the digital volume of the tissue sample.

Embodiment 26 is the method of any one of embodiments 1 through 25, further comprising generating, by the computing system, immune cell heatmaps of pancreatic cancer precursor legions based on the digital volume of the tissue sample and using at least one of H&E, immunocytochemistry (HC), immunofluorescence (IF), imaging mass cytometry (IMC), and spatial transcriptomics.

Embodiment 27 is the method of any one of embodiments 1 through 26, further comprising: retrieving, by the computing system and from a data store, one or more deep learning models that were trained using patient tissue training data, wherein the one or more deep learning models are configured to (i) generate multi-dimensional volumes of patient tissue from patient tissue image data and (ii) determine stiffness measurements of tissue components in the multi-dimensional volumes of patient tissue, wherein the patient tissue training data is different than the tissue sample and wherein the patient tissue image data is different than the image data; generating, by the computing system, the digital volume of the tissue sample in 3D space based on applying the one or more deep learning models to the image data; determining, by the computing system, stiffness measurements of the tissue components of the tissue sample based on applying the one or more deep learning models to the digital volume of the tissue sample; and returning, by the computing system, the determined stiffness measurements for the tissue components of the tissue sample.

Embodiment 28 is the method of any one of embodiments 1 through 27, wherein the tissue sample is a breast tissue.

Embodiment 29 is the method of any one of embodiments 1 through 28, wherein determining, by the computing system, stiffness measurements of the tissue components of the tissue sample comprises determining Pearson or Spearman correlation and statistical significance for each of the tissue components in the digital volume of the tissue sample.

Embodiment 30 is the method of any one of embodiments 1 through 29, wherein the stiffness measurements correspond to at least one of (i) resistances of the tissue components of the tissue sample to deformation, (ii) elastic modulus, and (iii) Young's modulus.

Embodiment 31 is a system comprising one or more computers and one or more storage devices storing instructions that are operable, when executed by the one or more computers, to cause the one or more computers to perform the method of any one of embodiments 1 to 30.

Embodiment 32 is a computer storage medium encoded with a computer program, the program comprising instructions that are operable, when executed by data processing apparatus, to cause the data processing apparatus to perform the method of any one of embodiments 1 to 30.

Particular embodiments described herein include systems and methods for generating a digital reconstruction of tissue. The method can include receiving, at a computing system, image data of a tissue sample, wherein one or more sections of the tissue sample are stained with hematoxylin and eosin (H&E), registering, by the computing system, the image data to generate registered image data, identifying, by the computing system, tissue subtypes based on application of a machine learning model to the registered image data, annotating, by the computing system, the identified tissue subtypes to generate annotated image data, and determining, by the computing system, a digital volume of the tissue sample in three dimensional (3D) space based on the annotated image data.

In some implementations, the method can optionally include one or more of the following features. For example, the tissue sample can be a pancreatic tissue sample. The method can also include determining, by the computing system, 3D radial density of each identified tissue subtype and each cell in the digital volume of the tissue sample. The image data can be between 1× and 40× magnification, where lateral x and y resolution can be between 0.2 μm and 10 μm and axial z resolution can be between 0.5 μm and 40 μm.

As another example, registering, by the computing system, the image data to generate registered image data can include identifying, as a point of reference, a center image of the image data, and calculating global registration for each of the image data based on the point of reference. Moreover, calculating global registration further can include iteratively calculating registration angle and translation for each of the image data. The method can also include calculating elastic registration for each of the image data based on calculating rigid registration of cropped image tiles of each of the globally registered image data at intervals that range between 0.1 mm and 5 mm.

As yet another example, the tissue sample can include at least one of normal human tissue, precancerous human tissue, and cancerous human tissue. Registering, by the computing system, the image data to generate registered image data can include mapping independent serial images of the image data to a common coordinate system using non-linear image registration. The method can also include normalizing, by the computing system, the registered image data to generate normalized image data based on correcting two dimensional (2D) serial cell counts based on in-situ measured nuclear diameter of cells in the tissue sample, locating nuclei in each histological section of the registered image data based on color deconvolution, for each located nuclei, measuring in-situ diameters of each cell type, mapping the nuclei in a serial 2D z plane, and extrapolating true cell counts from the serial 2D z plane.

As another example, the method can also include normalizing, by the computing system, the registered image data to generate normalized image data based on extracting, using color deconvolution, a hemotoxylin channel from each of the image data depicting the one or more sections of the tissue samples stained with H&E, and for each of the image data depicting the one or more sections of the tissue samples stained with H&E, identifying a tissue region in the image data based on detecting regions of the image data with low green channel intensity and high red-green-blue (rbg) standard deviation, converting rgb channels in the image data to optical density, identifying clusters, based on kmeans clustering, to represent one or more optical densities of the image data, and deconvolving the image data, based on the one or more optical densities, into hemotoxylin, eosin, and background channel images. The method can also include smoothing, for each of the image data, the hemotoxylin channel image, and identifying, for each of the image data, a nuclei in the smoothed hemotoxylin channel image. Moreover, the one or more optical densities can include a most common blue-favored optical density to represent the hemotoxylin channel image, a most common red-favored optical density to represent the eosin channel, and a background optical density as an inverse of an average of the hemotoxylin and eosin optical densities to represent the background channel image.

As another example, the machine learning model can be trained, by the computing system, with manual annotations of one or more tissue subtypes in a plurality of training tissue image data. The machine learning model can be at least one of a deep learning semantic segmentation model, a convolutional neural network (CNN), and a U-net structure. The method can also include training, by the computing system, the machine learning model based on randomly overlaying extracted annotated regions of one or more tissue samples on a training image and cutting the training image into the plurality of training tissue image data. Training the machine learning model can also include identifying, by the computing system, bounding boxes around each annotated region of the one or more tissue samples, and randomly overlaying each identified bounding box containing a least represented tissue subtype on a blank image tile until the tile is at least 65% full of annotated regions of the one or more tissue samples. The image tile can be an rgb image composed of overlaid manual annotations, and the image tile can be cut, by the computing system, into a plurality of image tiles for use with the machine learning model.

As yet another example, the machine learning model can be trained, by the computing system, to identify at least one of inflammation, cancer cells, and extracellular matrix (ECM) in the image data. The tissue subtypes can include at least one of normal ductal epithelium, pancreatic intraepithelial neoplasia, intraductal papillary mucinous neoplasm, PDAC, smooth muscle and nerves, acini, fat, ECM, and islets of Langerhans. Determining, by the computing system, the digital volume of the tissue sample in 3D space based on the annotated image data can include consolidating multi-labeled image data into a 3D matrix based on registering (i) the annotated image data and (ii) cell coordinates counted on unregistered histological sections of the annotated image data. The 3D matrix can also be subsampled, by the computing system, using nearest neighbor interpolation from original voxel dimensions of 2×2×12 μm3/voxel to an isotropic 12×12×12 μm3/voxel.

The method can also include normalizing, by the computing system, the registered image data to generate normalized image data based on normalizing color of the one or more sections of the tissue samples stained with H&E across the image data. The method can include classifying, by the computing system, the image data based on pixel resolution, annotation tissue classes, color definitions for labeling of tissue classes, and names of tissue subtypes corresponding to labels associated with each class of tissue subtypes.

The method can include constructing, by the computing system, z-projections of each tissue subtype using the digital volume of the tissue sample. The method can also include, for each tissue subtype, summing, by the computing system, pixels of the tissue sample in a z dimension, generating, by the computing system, a projection of a volume of the tissue sample on an xy axis, normalizing, by the computing system, the projection based on the projection's maximum, and visualizing, by the computing system, the projection using a same color scheme created for visualization of the tissue sample in the 3D space.

The method can include calculating, by the computing system, cell density of each tissue subtype in the tissue sample using the digital volume of the tissue sample. The method can include measuring, by the computing system, tissue connectivity in the tissue sample using the digital volume of the tissue sample. The method can also include calculating, by the computing system, collagen fiber alignment in the tissue sample using the digital volume of the tissue sample. The method can even include calculating, by the computing system, a fibroblast aspect ratio of the tissue sample based on measuring a length of major and minor axis of nuclei in a ductal submucosa in the digital volume of the tissue sample. Moreover, sometimes the method can include generating, by the computing system, immune cell heatmaps of pancreatic cancer precursor legions based on the digital volume of the tissue sample. The method can even include generating, by the computing system, the immune cell heatmaps using at least one of H&E, immunocytochemistry (HC), immunofluorescence (IF), imaging mass cytometry (IMC), and spatial transcriptomics.

The devices, system, and techniques described herein may provide one or more of the following advantages. For example, the disclosed technology can provide for modeling dense tissue structures in 3D space. This can be advantageous to researchers and other relevant users because it can be used to analyze potential cancerous cells, tumors, or other conditions that may exist in a human or animal. Thus, the disclosed technology can be used to measure and analyze tissue morphology and cancer metasis in 3D space.

As another example, the disclosed technology can be used to reconstruct tissues of potentially unlimited size. Use of deep learning models and algorithms can provide for incorporating additional digital markers into tissue samples to expand datasets and reconstruct tissues of potentially unlimited size.

Moreover, the disclosed technology can be integrated with additional modalities, such as H&E, IHC, IF, IMC, and spatial transcriptomics/proteomics. Such integration can provide for more robust analysis of tissue samples. This integration can provide for detecting immune cells of pancreatic cancer precursor legions. As a result, the disclosed technology can provide for greater insight into cancer analysis.

Furthermore, the disclosed technology can be applied in a variety of settings in order to improve and advance medical research, diagnosis, and/or treatment. For example, the disclosed technology can be used for mapping biological architecture at tissue and cellular resolution(s). The disclosed technology can be used to create 3D maps of tissue architecture at both the structural and cellular level. Structures can be labelled using deep learning techniques on H&E or detection of stains from IHC, IF, IMC, or single cell transcriptomics, and cells can then be detected using a nucleus channel of cellular stains. The disclosed technology can also be integrated with other tissue section technologies. The disclosed technology may be used to identify regions of interest in serially sectioned samples. By staining some sections for reconstruction and holding out unstained sections, the disclosed technology can be used to identify coordinates of interesting regions in samples (e.g., such as vascular invasion in cancer). The unstained tissue section nearest to these coordinates may then be used for additional staining, such as single cell transcriptomics or imaging mass cytometry.

As another example, the disclosed technology can be used to compare 3D samples of different organs and/or diseases (e.g., normal vs. abnormal pancreas, human kidney vs. human liver, etc.) and/or for inter-system comparison (e.g., human vs. mouse skin analysis). The disclosed technology can also be used for tissue and cellular analysis of 2D tissue sections. As an illustrative example, hundreds of individual 2D H&E sections of human pancreas can be analyzed to compare pre-cancer and cancer status to patient obesity in a large cohort. The disclosed technology can also be used for predicting drug responsiveness. The disclosed technology may be used to analyze, in 3D, human, animal, and/or engineered tissue via serial sectioning for comparison of pre- and post-treatment conditions. The disclosed technology can therefore determine structural and molecular markers of treatment response.

Moreover, the disclosed technology can be used to determine disease states. The disclosed technology may be used to compare normal and diseased tissue for identification of structural and molecular changes undergone by tissue at large (e.g., mm³ or cm³) and small (e.g., um³ and subcellular) scales, such as cancer cell invasion mechanisms, inflammatory heterogeneity, cellular atrophy patterns, and collagen alignment in normal and abnormal tissue.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram of a process for reconstructing tissue from image data in 3D space.

FIG. 1B illustrates applicability of the disclosed technology to various use cases.

FIG. 2 is a flowchart of a process for reconstructing tissue from image data in 3D space.

FIGS. 3A-B are system diagrams of one or more components that can be used to perform the techniques described herein.

FIG. 4 depicts a process for 3D reconstruction of cancerous human pancreas tissue.

FIGS. 5A-B depict inter-patient pancreas analysis from cm-scale to single cell resolution.

FIG. 6 depicts 3D rendering of pancreatic ducts.

FIG. 7 depicts analysis of the relationship of cancer to blood cells.

FIG. 8 depicts a process for histological image registration.

FIG. 9 depicts validation of cell count and 2D to 3D cell count extrapolation.

FIG. 10 depicts a process of semantic segmentation.

FIGS. 11A-B depicts deep learning accuracy for different tissue cases.

FIG. 12A depicts integration of the disclosed technology with one or more additional imaging modalities.

FIG. 12B depicts integration of the disclosed technology with IHC, IMC, and spatial transcriptomics.

FIG. 13 depicts a process to reconstruct 3D tumors at single-cell resolution.

FIG. 14 depicts 3D reconstruction of normal pancreatic tissue using the disclosed techniques.

FIG. 15 depicts 3D analysis of pancreatic cancer precursor lesions using the disclosed techniques.

FIG. 16 depicts integration of the disclosed technology with IHC.

FIG. 17 depicts registration of H&E and IHC using the disclosed techniques.

FIG. 18 depicts identification of immune cells from serial IHC sections.

FIG. 19 depicts 2D and 3D radial immune cell density around a pancreatic precursor lesion.

FIG. 20 depicts 3D reconstruction of immune cell heatmaps.

FIG. 21 depicts visualization of immune cell infiltration within PDAC by IMC.

FIG. 22 depicts registration of serial H&E and spatial transcriptomic sections using the techniques described herein.

FIG. 23 is an overview diagram of a process for deep learning composition analysis of breast tissue.

FIG. 24 is a flowchart of a process for determining breast stiffness measurements using the techniques described herein.

FIG. 25A is a diagram of a convolutional neural network (CNN) used to reconstruct a tissue sample in n-dimensional space and identify tissue and cell classes.

FIG. 25B depicts a comparison of hematoxylin and eosin (H&E) tissue features with CNN classified image data of a tissue sample.

FIG. 26 is a flowchart of a process for training a model to determine stiffness measurements of a tissue sample.

FIG. 27 depicts global stiffness characterization and composition analysis of breast tissue.

FIG. 28 depicts an example tissue analysis with microindentation mapping, characterization, and composition analysis.

FIG. 29 depicts analysis of relationships between breast density and tissue composition.

FIG. 30 depicts analysis of relationships between tissue composition and global stiffness.

FIG. 31 is a table of example sample patient data used with the techniques described herein.

FIG. 32 is a system diagram depicting one or more components used to perform the techniques of FIGS. 23-31.

FIG. 33 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to systems, methods, processes, and techniques to reconstruct tissue in 3D space using image data of the tissue. More particularly, the disclosed technology can be used for 3D reconstruction and labeling of serial histological sections of tissues. The disclosed techniques can be used to assess cancer metasis and invasion into tissues of human and/or animal bodies.

The disclosed technology can be used to build multi-labeled 3D reconstruction of human pancreas samples that provide highly-detailed structural insight of pancreatic cancer tumorogenesis. The disclosed technology provides for well-quantified study of in situ cancer progression at cm-scale with μm and single-cell resolution. Disconnected PDAC precursor lesions can develop within cm-scale regions of a tissue sample, and neoplastic ρ_{local} can be independent of precursor volume or 3D structural phenotype. In an illustrative single sample example use of the disclosed technology at a leading edge of PDAC, cancer can be found to extend furthest from the central tumor along existing, well-aligned ECM structures, such as those surrounding pancreatic ducts. 3D insight in digital pathology research can be advantageous as a powerful alternative to tissue clearing for study of 3D tissue microarchitecture.

Tissue clearing is a means for studying 3D tissues, wherein intact samples can be rendered semi-transparent, stained, and imaged using confocal or light-sheet microscopy. Tissue clearing techniques can be used to conduct landmark scientific research, such as the imaging of all cells in a whole mouse brain, and to assess tumor and tumor-associated macrophage heterogeneity in samples containing lung carcinoma. Clearing techniques can be suitable for analyses requiring few labels, as imaging of cleared tissues can be constrained to 1-5 markers per sample, with more markers feasible in μm-scale samples and fewer markers feasible in mm-scale or whole organ samples. Clearing techniques can also be used for experiments where qualitative analyses are sufficient, as inconsistent clearing and antibody penetration (especially in stiff, stromal tissues such as cancer samples, or in samples of mm or cm scale) can make quantification of imaged tissues difficult. For these reasons, μm-scale samples and qualitative analyses can be common.

Current serial sectioning methods can bypass some of the shortcomings of tissue clearing methods, albeit through introduction of new challenges. Serial sectioning methods can overcome the size limitations and inconsistent staining of tissue clearing by cutting tissue samples into thin (4-5 μm) slices that are individually stained and scanned. However, the act of cutting tissue into many thin sections introduces discontinuity to the samples, as sections can warp and fold in unpredictable ways, requiring introduction of sophisticated image registration techniques. Additionally, many serial sectioning methods rely on additional techniques for tissue labelling, including IHC staining, mass spectrometry, and manual annotation. These techniques contribute to the complexity and expense of serial sectioning methods. While quantification of stains is simpler in current serial sectioning methods than it is in tissue clearing methods, the acquiring of tissue labels through expensive labelling methods and the necessity of sophisticated image registration techniques have hindered general adoption of serial sectioning methods for the study of 3D tissue microarchitecture.

The disclosed technology, on the other hand, incorporates nonlinear image registration and deep learning techniques to create multi-labelled tissue volumes using H&E images alone, avoiding the need for additional stains for tissue labelling. Here, the disclosed techniques can be used for detection of pancreatic tissue subtypes using H&E images. By making registered tissue dataset publically available, additional labels can be added to the samples analyzed using the techniques described herein. This knowledge transfer may not be possible in cleared tissue samples where unlabelled tissues cannot be visualized. The disclosed techniques can also be used to derive quality 3D reconstructions while skipping at least two intervening sections. Therefore, future addition of IHC labeling, gene mutation, and gene expression imaging to the intervening sections can increase the number of labels beyond what is currently discernable in H&E—the number of tissue and molecular phenotypes that the disclosed technology can label is not possible through tissue clearing or current serial sectioning approaches. A “multi-omic” 3D map may be possible using the disclosed techniques.

Use of the disclosed techniques and technology demonstrates that analysis of cm-scale pancreas samples emphasize the potential for 3D assessment to improve understanding tumorogenesis. The disclosed technology can outperform tissue clearing methods in its ability to create easily quantifiable tissue volumes, allowing quantification of deceptively simple concepts such as 3D cell count and density, vascular connectivity, tumor branching and morphology, and cm-scale tissue heterogeneity. While analogous metrics can be used for quantification of cell density, spatial correlation, and tumor infiltration in 2D, not only are these measures different when measured in 3D, often 2D correlates can be flawed. For example, it can be challening to accurately assess connectivity of branching ductal structures such as PanIN and IPMN (which are distinguished by size in 2D), since complex glandular lumina can present as distinct objects separated by centimeters of tissue on single histological sections. The disclosed technology therefore can provide for ease-of-quantifiability of 3D concepts.

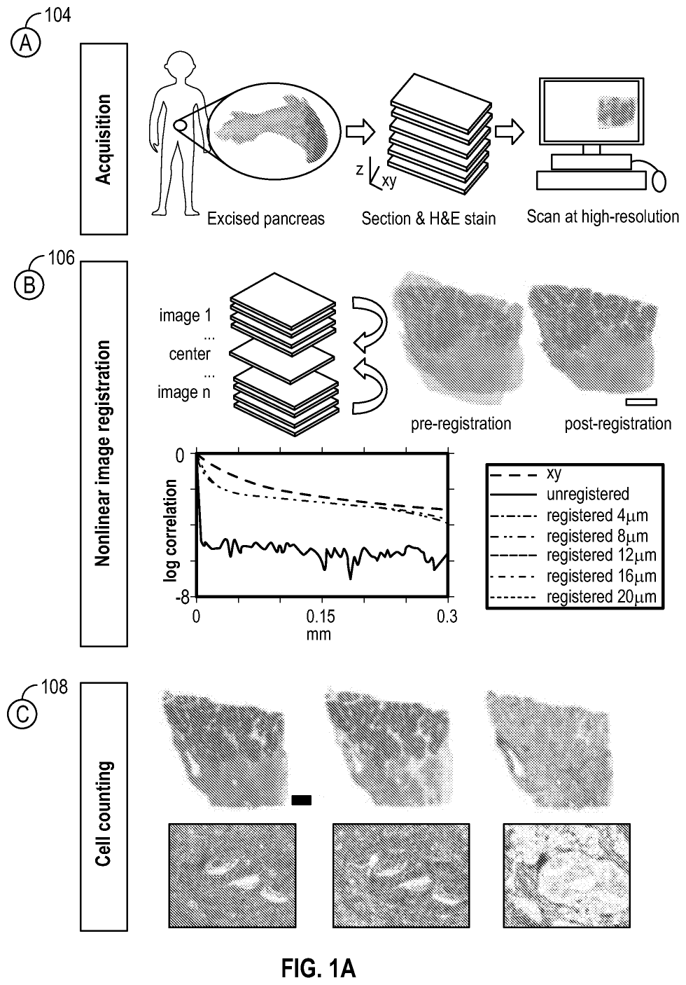

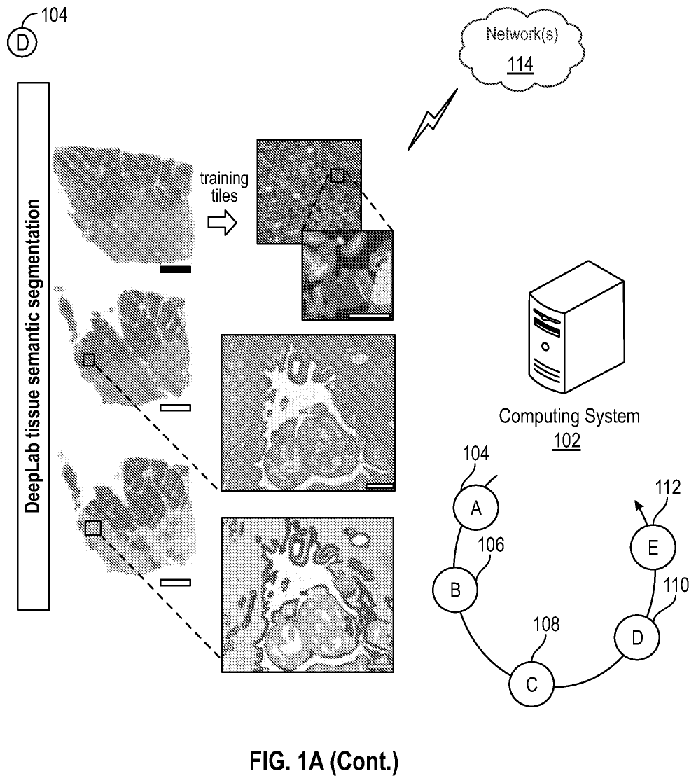

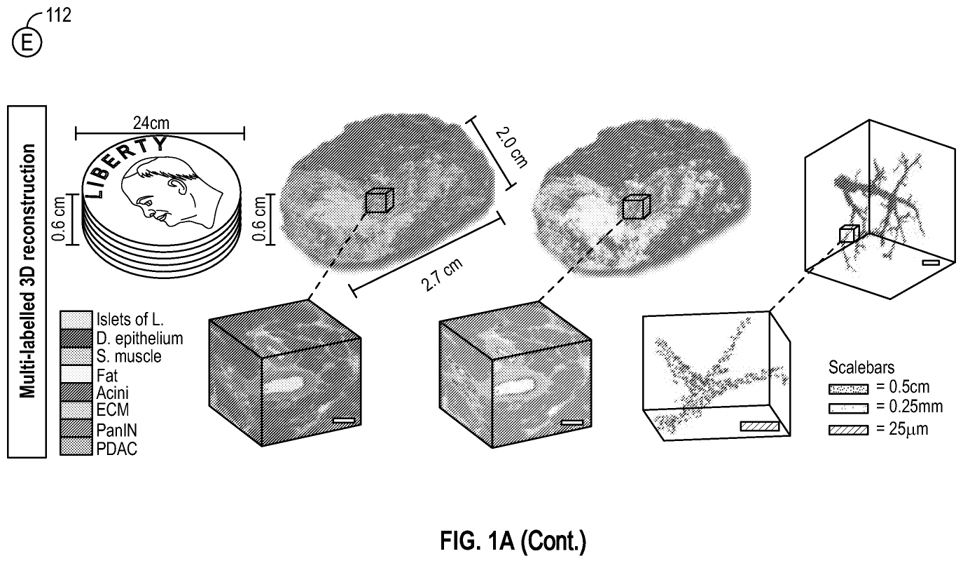

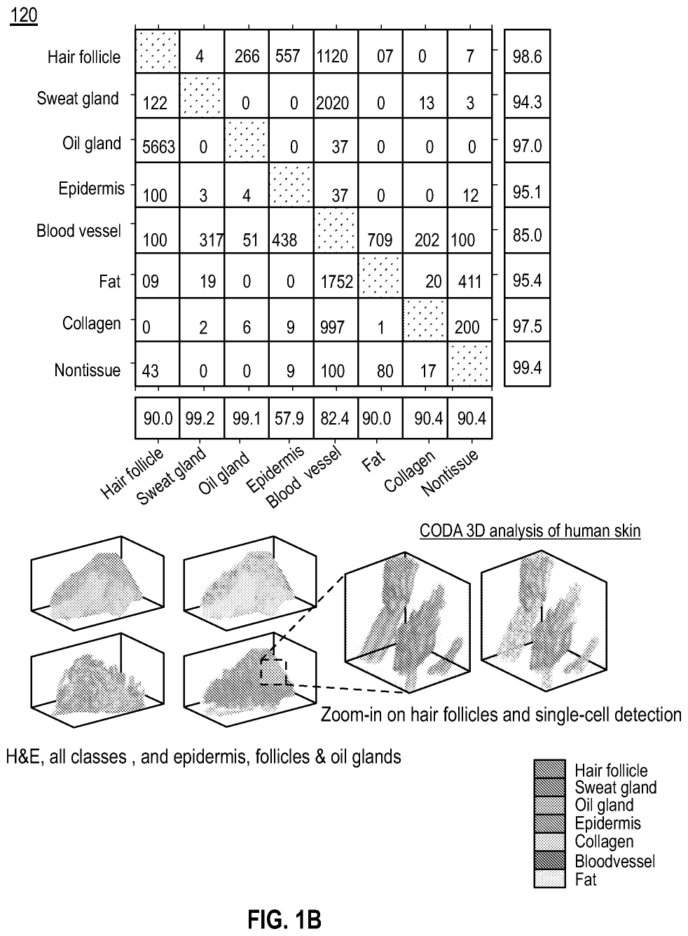

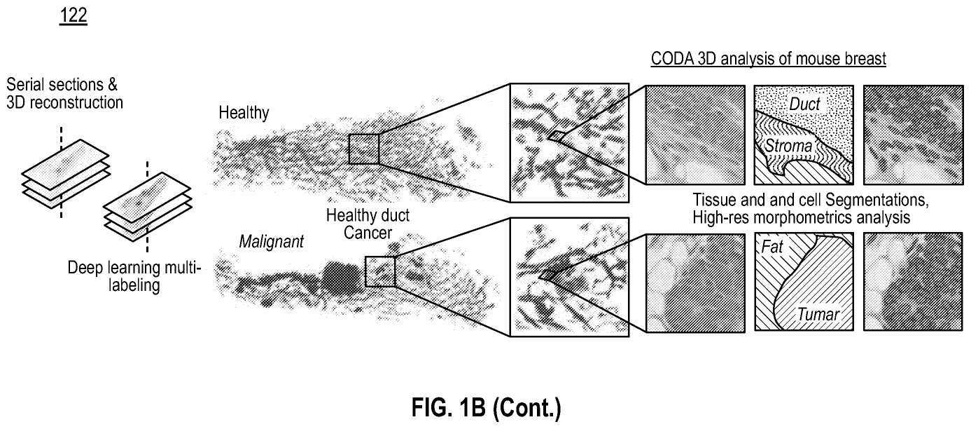

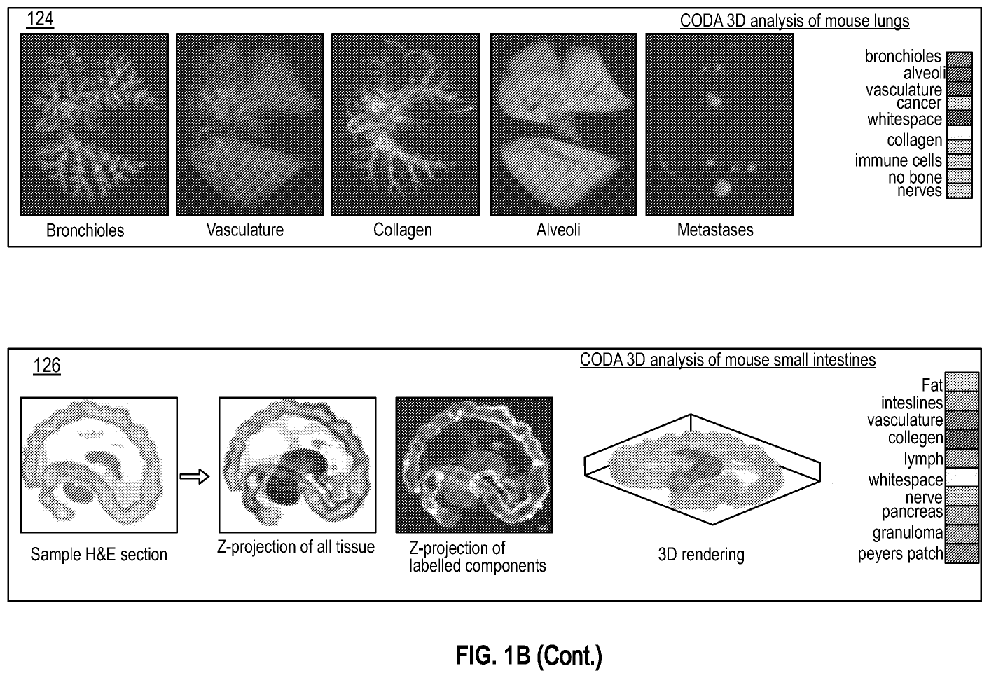

Referring to the figures, FIG. 1A is a conceptual diagram of a process for reconstructing tissue from image data in 3D space. The process can be performed by a computing system 102. The computing system 102 can be any one or more of a computer, laptop, tablet, mobile device, smartphone, network of computers, network of servers, and/or cloud computing system. The computing system 102 can also communicate with one or more other devices, computers, systems, and/or servers via network 114.

To study pancreatic cancer invasion, a human pancreas sample (e.g., S04-PDAC) containing poorly differentiated infiltrating ductal adenocarcinoma immediately adjacent to a large region of grossly normal pancreas can be identified (step A, 104) (e.g., refer to Table 1). As an illustrative example, formalin-fixed, paraffin-embedded samples can be sectioned every 4 μm. Every third tissue section can be stained using H&E, with two sections every three held out. All tissues of a single sample can be scanned for validation that skipping two sections maintains registration and reconstruction accuracy. Tissues can be scanned at ×20, which corresponds to approximately 0.5 μm/pixel, using a Hammamatsu Nanozoomer, as an example.

Thus, the computing system 102 can receive high resolution images of human pancreatic tissue Sections can be stained with H&E and digitized at 20× magnification using the computing system 102, thereby providing x and y (lateral) resolution of 0.5 μm and z (axial) resolution of 4 μm (step A, 104). Sections can also be stained and digitized at a magnification that ranges between 1× and 40×. Moreover, the lateral and axial resolutions can be dependent on the magnification and other parameters of a tissue scanner that is used with the disclosed technology. For example, the lateral resolution can range between 0.2-10 μm per pixel. As another example, the axial resolution can range between 0.5 microns and 40 μm. The images can be saved in reduced sizes corresponding to 8 μm/pixel using nearest neighbor interpolation. For each sample, a center image can be identified as a point of reference (e.g., imageₙ), and global and elastic registration can be calculated for all other images in the sample, as described below.

TABLE 1
Patient Case Information, information about pancreas tissue samples analyzed, and tissues
analyzed as adjacent normal, precancerous, or cancerous regions of human pancreas.

| | # Sections | | | | | | Final |
|---|---|---|---|---|---|---|---|
| | (⅓ | | Age at | | | Size | Diagnosis of |
| Case | analyzed) | Sex | Surgery | Race | Location | (cm) | Patient |
| S01-Normal | 1383 | F | 40 | Caucasian | Tail | 1.5 | Serous |
| | | | | | | | crystagenoma |
| S02-PanIN | 1239 | M | 67 | Caucasian | Tail | 2.5 | Intermediate |
| | | | | | | | grade IPMN |
| S03-IPMN | 1491 | M | 77 | Caucasian | Head | 1 | Moderately |
| | | | | | | | differentiated |
| | | | | | | | adenocarcinoma |
| S04-PDAC | 5196 | M | 60 | Caucasian | Head | 3.5 | Poorly |
| | | | | | | | differentiated |
| | | | | | | | adenocarcinoma |
| S05-PDAC | 381 | F | 68 | Caucasian | Head | 3.4 | Poorly |
| | | | | | | | differentiated |
| | | | | | | | adenocarcinoma |

The computing system 102 can then map independent serial images to a common coordinate system using non-linear image registration (Step B, 106). Registering the tissue images can create a digital volume. Correlation of tissue image intensity in xy dimension of single tissue sections can be used as a reference for registration quality. Correlation of intensity in a z dimension in unregistered image stacks, and registered image stacks with different z-resolutions can show a 99% registration quality with a z resolution of 12 μm.

As an illustrative example, images can be coarsely aligned using whole field rigid-body registration, followed by an elastic registration approach to account for local tissue warping. To limit accumulation of error due to imperfect tissue sectioning, the disclosed technology can be designed to discard registration to badly deformed tissues (containing large regions of splitting or folding, see details in supplementary materials). Accordingly, the disclosed technology can limit accumulation of error across large samples and maintains higher pixel correlation between images than other techniques.

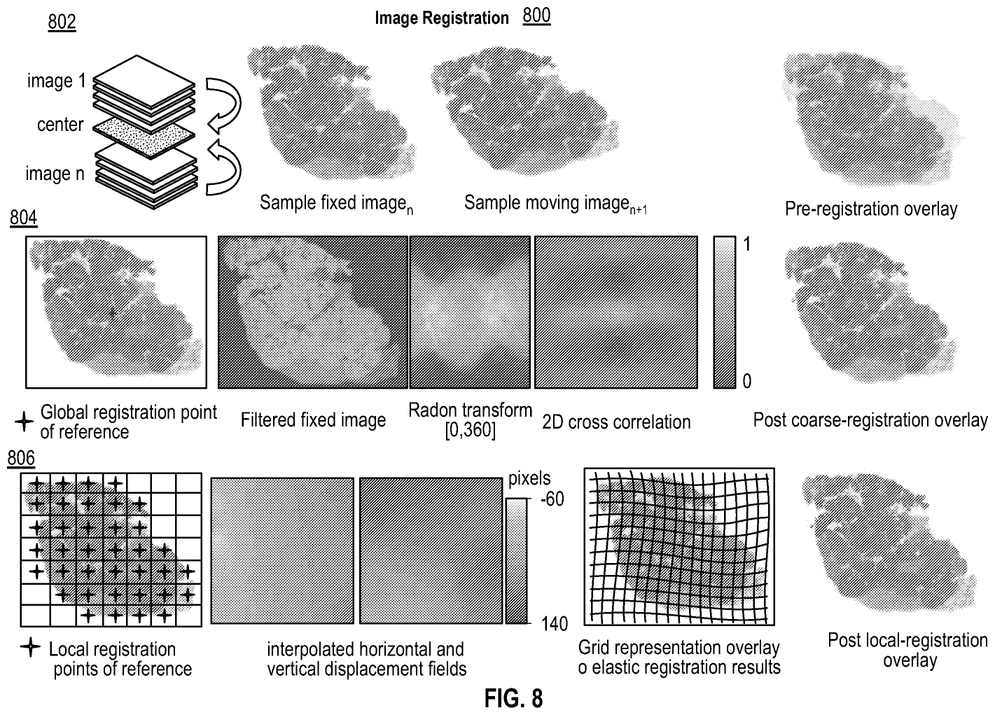

Still referring to step B (106), tissue sections can be coarsely aligned using whole field affine registration. Since reconstruction of serial histological sections can be complicated by malleability of tissue, which unpredictably stretches, folds, and splits to produce non-uniform deformation between z-planes, the computing system 102 can apply an elastic registration approach to account for local tissue warping. Elastic registration approaches can compute nonlinear transformations and can be used to register histological images. The computing system 102 can optimize for registration of pancreas tissue sections and incorporate downsampling to increase speed of processing (step B, 106). Accordingly, the registration process can perform similarly between consecutive tissue sections and/or tissue sections up to five z-planes apart (e.g., refer to FIG. 8). As a result, the computing system 102 can improve throughput by processing one in three serial images. Overall, registration in step B (106) can serially align the S04-PDAC tissue sample containing 1,499 serial histological sections in 3 h.

Registration can be performed on greyscale, Gaussian-filtered, down sampled (80 μm/pixel resolution) versions of the high-resolution histological sections. Global registration transformations for a pair of preprocessed tissue images can be found through iterative calculation of registration angle and translation via maximization of cross-correlation. Radon transforms of the images taken at discrete angles between 0 and 359 degrees can be calculated. A maximum of a cross correlation of radon transforms of the images yielded registration angle, and the maximum of the cross correlation of the rotated tissue images yields translation. Elastic registration can be obtained by calculating rigid registration of cropped image tiles at 1.5-mm intervals across the globally registered images at 8 μm/pixel resolution. The resulting local, rigid registration fields can be interpolated and smoothed to produce a nonlinear, elastic registration transformation.

Rigid global registration can also be performed to sequentially register each image_{n+/-m} to the three next closest images to center, image_{n+/-(m+1)} image_{n+/-(m+2)}, and image_{n+/-(m+3)}. Quality of each of the three global registrations can be assessed by comparing pixel-to-pixel correlation between the moving image and each reference image. The registration with the best result can be kept and the other two can be discarded. Following global registration, elastic registration can be employed between the moving image and chosen reference image to create a nonlinear displacement map. This process can be repeated for all images in a sample such that all images can be elastically registered to the coordinate system of the center imageₙ. Global registration may be required in some implementations while elastic registration may only optionally be used with the disclosed technology.

As an illustrative example, quality of image registration within the images can be calculated using pixel-wise Spearman correlation. ‘True’ biological pixel variation can, for example, be calculated by correlating pixel intensity along the x and y dimensions of single images (longitudinal correlation). ‘Perfect’ registration can be assumed to result in a similar z-direction (down the image stack) correlation to the xy correlation, as the xy correlation may represent the variation in pixel intensity in intact tissue. Axial pixel correlation can be calculated by correlating pixel intensity along the z dimension of serial images. Unregistered z-correlation can then be compared to post-global registration correlation and post-elastic registration correlation to determine improvements to intensity continuity following registration, and post-elastic registration can be compared to longitudinal correlation to determine how closely registration results may emulate true intensity variation between connected tissue. For each correlation calculation (along the xy direction, unregistered z-dimension, global registered z-dimension, and elastic registered z-dimension) Spearman correlation can also be calculated for pixels at 4 μm intervals starting at 0 micron apart. Correlation of pixels 0 micron apart can be correlation of each pixel to itself (equal to 1). Correlation of pixels 4 μm can also correspond to two pixels 4 μm apart in a single image (for the xy calculation) or one image apart (for the z calculation). This process can be repeated for distances up to 0.3 mm. One or more other distances may also be used. Additionally, this process can be repeated for registration of all images in a particular sample (or a subset of images in the particular sample), and registration of one in two, one in three, one in four, and one in five images in the particular sample (or other predetermine ratios or ranges) to prove >95% correlation when sampling one in every three images per tissue sample.

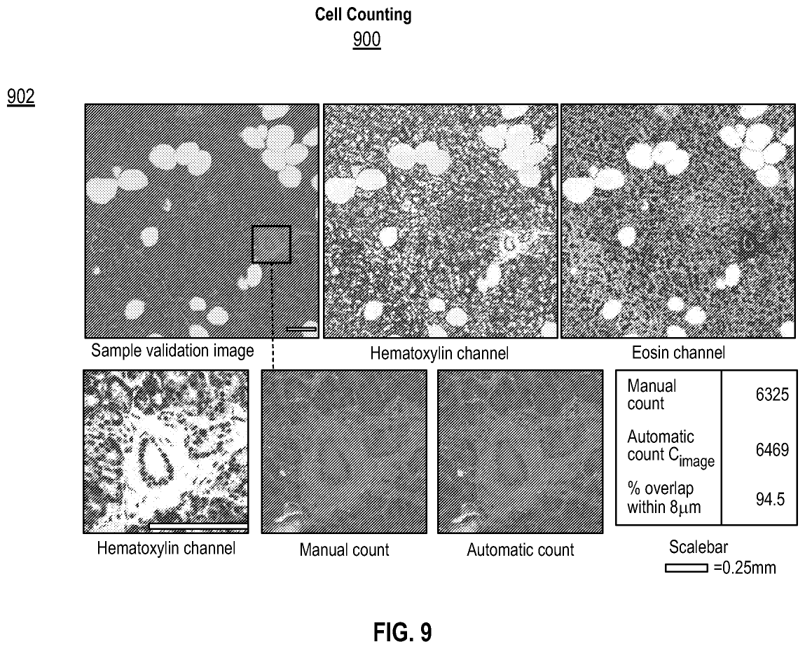

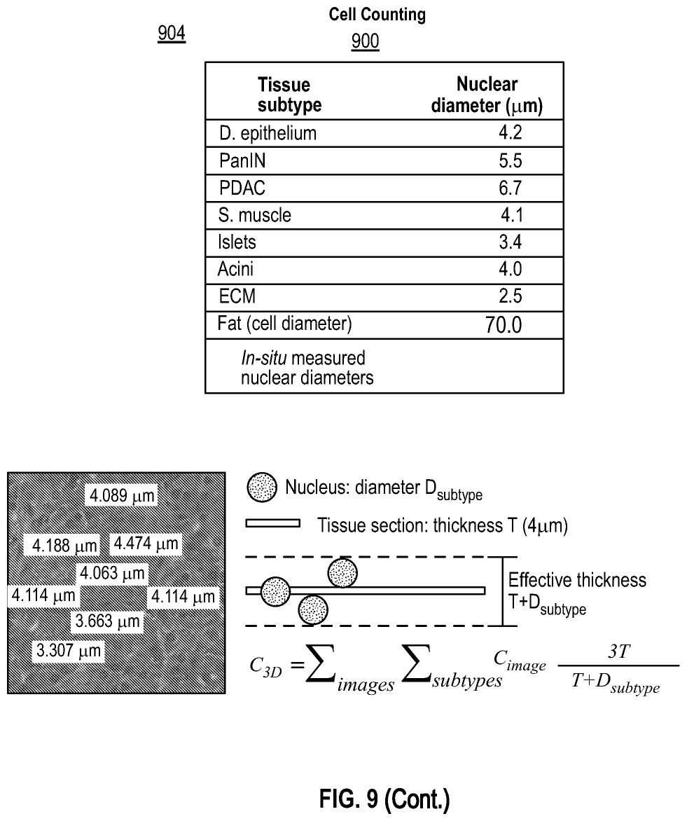

The computing system 102 can then identify cells using a hematoxylin channel of color deconvolved images (step C, 108). 2D serial cell counts can be corrected using in-situ measured nuclear diameter of cells in different tissue bodies. All nuclei in each histological section can be located based on color deconvolution (e.g., refer to FIG. 9, 902). In situ diameters of each cell type can be measured and incorporated to extrapolate true cell counts from cell counts on serial 2D z-planes (e.g., refer to FIG. 9, 904).

For example, the hemotoxylin channel of all H&E images can be extracted using color deconvolution. Reduced size copies of all tissue images can be saved, corresponding to 2 μm/pixel using nearest neighbor interpolation. For each image, the tissue region of the image can be identified by finding regions of the image with low green channel intensity and high red-green-blue (rgb) standard deviation. Next, rgb channels can be converted to optical density. Using kmeans clustering analysis, 100 clusters can be identified to represent optical densities of the image. The most common blue-favored optical density can be chosen to represent the hemotoxylin channel, and the most common red-favored optical density can be chosen to represent the eosin channel. The background optical density can be fixed as the inverse of the average of the hemotoxylin and eosin optical densities. These three optical densities can be used to deconvolve the rgb image in to hemotoxylin, eosin, and background channel images. Moreover, the hemotoxylin channel images can be smoothed, and 2D intensity minima of a designated size and distance from each other can be identified as nuclei.

A total of 3 2 mm×2 mm regions (e.g., a total of 5 1.5 mm² regions, or any other predetermined measurement) can be extracted from each case for validation. For each region, cells can be located using an annotation function. For example, a manually identified cell can be equivalent to an automatically detected cell if the coordinates are within 4 μm of each other (corresponding to 3 pixels in the 2 μm/pixel downsampled images used for cell detection). This validation can show a 94% consistency between manually and automatically detected cell coordinates.

As another example, in step C (108), the computing system 102 can perform a high throughput H&E cell detection workflow based on color deconvolution and normalization and particle tracking intended for rapid cell detection in large serially sectioned samples without the need for training or manual annotations. As a result, the disclosed technology can perform cell detection techniques in lower processing time per whole slide image (e.g., approximately 90 seconds per whole slide image). To validate detection accuracy, randomly selected 1.5 mm² image tiles can be manually annotated by humans. Manual annotations can be compared to the disclosed technology's cell detection to demonstrate improved accurate, precision, recall, and for assessment of samples containing many serial samples. Moreover, the disclosed technology can perform cell detection techniques approximately 3 or more times faster than other techniques. In some implementations, in situ diameters of each cell type can be measured and incorporated to extrapolate 3D cell counts from cell counts on serial 2D images.

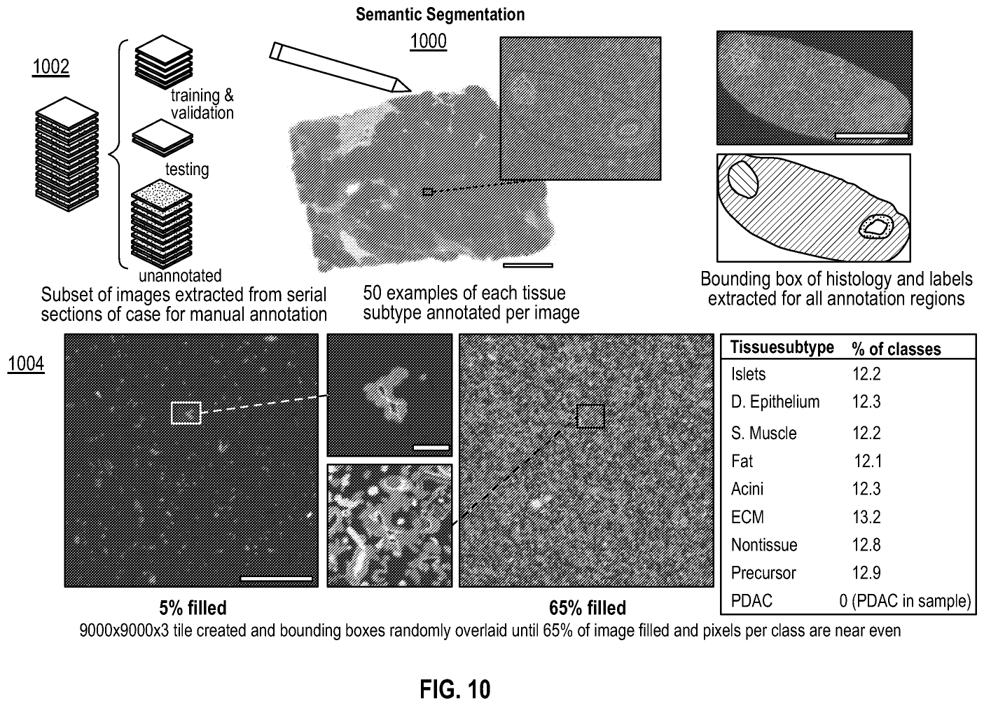

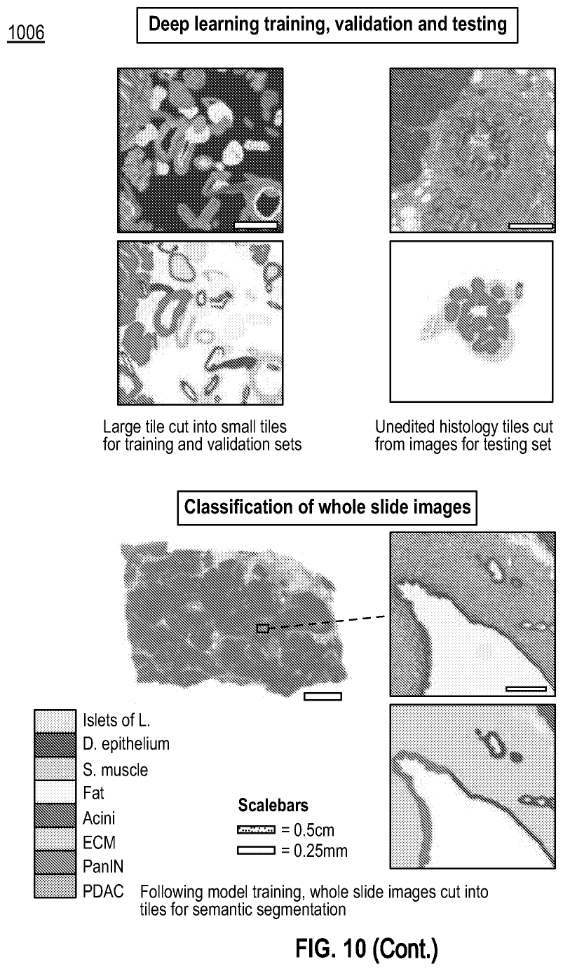

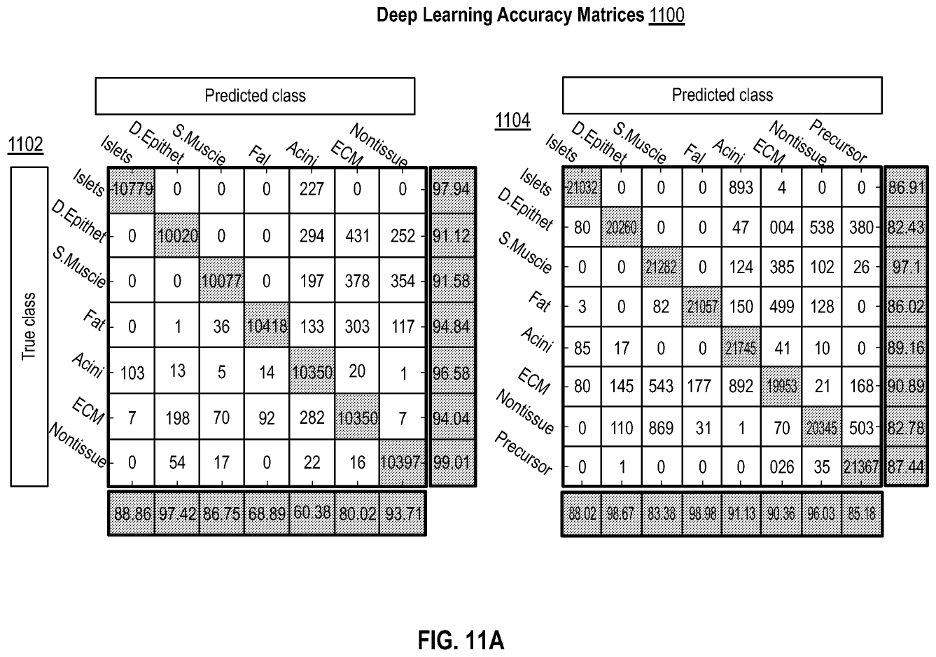

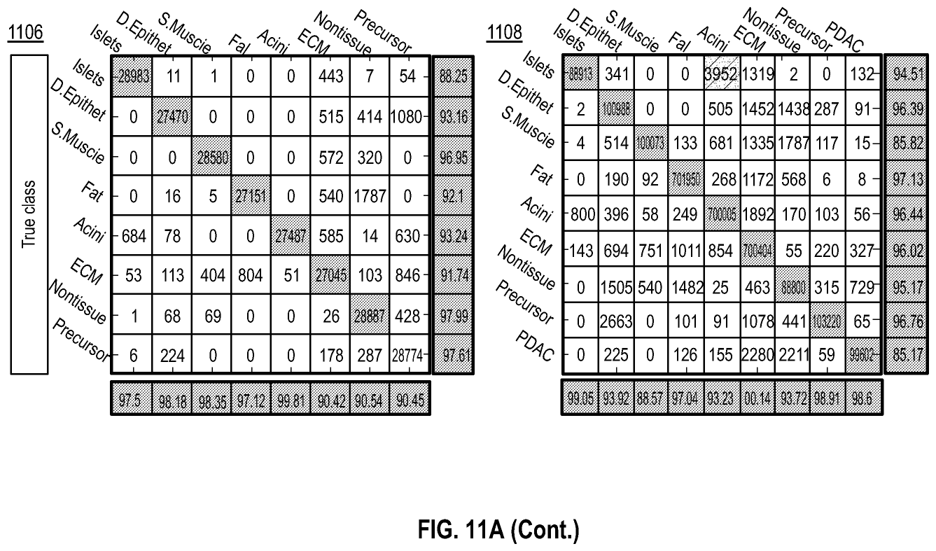

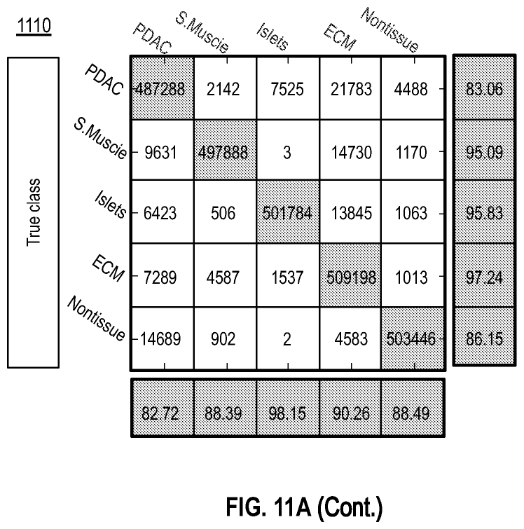

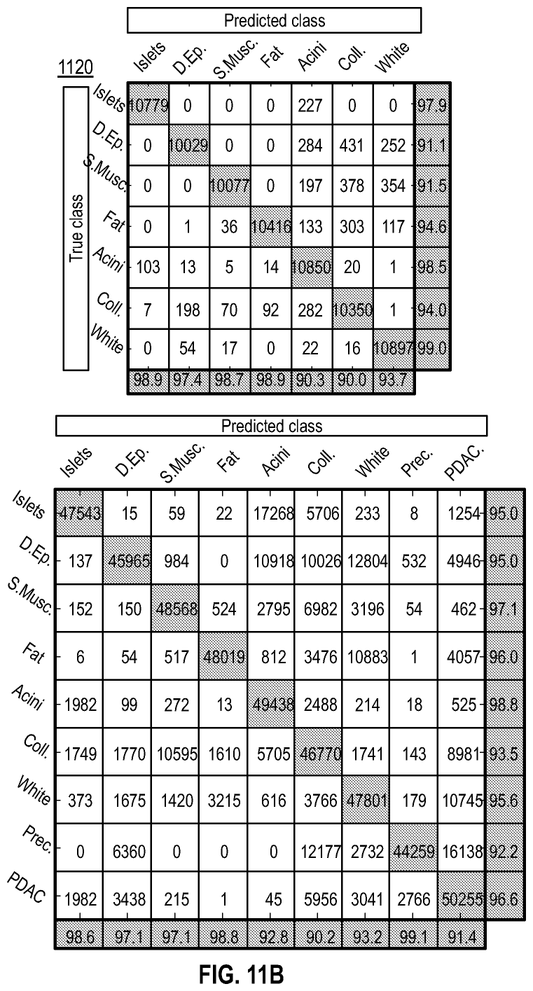

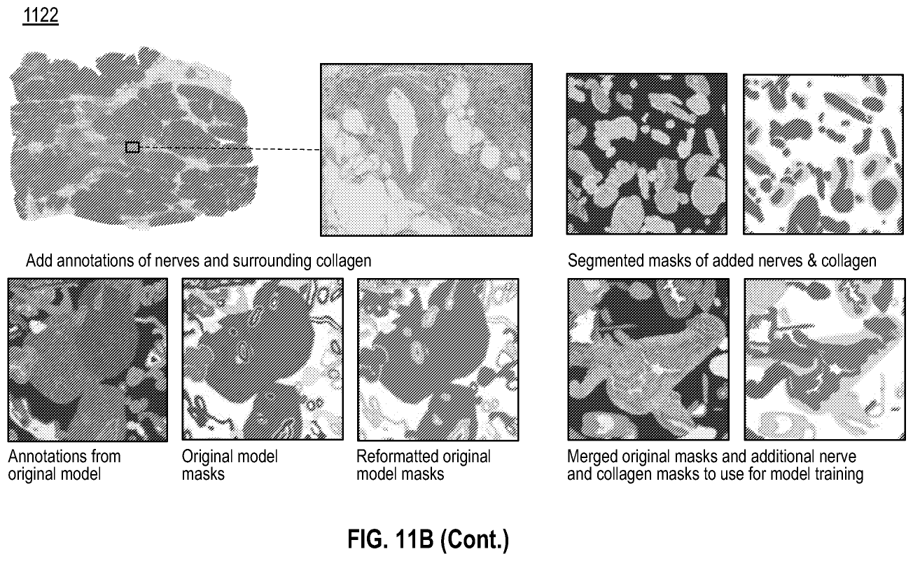

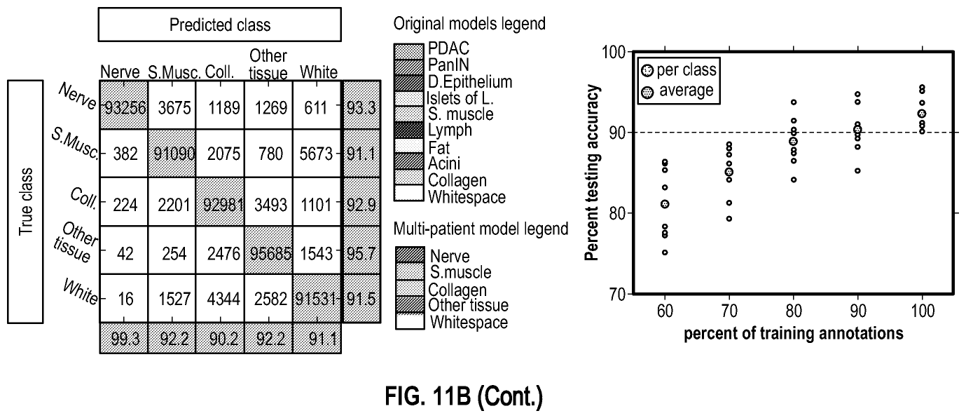

The computing system 102 can perform deep learning semantic segmentation with manual annotations of tissue types (step D, 110). One or more other machine learning models and techniques can be used in step D (110). For example, a convolutional neural network or U-net structure can also be used for labelling of distinct structures on tissue image data. The annotations can be randomly overlaid on large black tiles for training. Tissue images can then be labeled to a resolution of 2 μm. To visualize and quantify an architecture of the pancreas, labeling distinct tissue subtypes in the volume can be used. Deep learning methods can identify many structures in H&E images, such as inflammation, cancer cells, and extracellular matrix (ECM). The computing system can use semantic segmentation and a pretrained ResNet50 network (e.g., refer to FIG. 10, 1002) to label eight pancreas tissue subtypes recognizable by trained pathologists in H&E images without additional molecular probes. A total of eight tissue subtypes can be identified: normal ductal epithelium, precursors (pancreatic intraepithelial neoplasia [PanIN] or intraductal papillary mucinous neoplasm [IPMN]), PDAC, smooth muscle & nerves, acini, fat, ECM, and islets of Langerhans. To increase model accuracy, one or more training datasets can be created by semi-randomly overlaying extracted annotated regions on a large image, then cutting this large image into many training and validation images. As a result, the computing system 102 can control heterogeneity of class appearance in the dataset (e.g., refer to FIG. 10, 1004). The trained deep learning model can achieve precision and recall of >90% for each class in S04-PDAC on independent testing images (e.g., refer to FIGS. 11A-B) and labeled serial sections at a resolution of 2 μm/pixel in 36 h. The disclosed technology allows for efficient and quick segmentation of tissue samples and is amenable to rapid (approximately 1 day or less) generation of functional models.

Moreover, a deep learning semantic segmentation model can be trained using randomly overlaid annotations of tissue types. The images can be labelled to a resolution of 2 μm. A deep learning model can also be created for each case using manual tissue annotations of that sample. As an illustrative example, 7 tissue images equally spaced within each sample can be extracted. For each of the 7 images, 50 examples of each identified tissue subtype can be manually or automatically annotated. The annotation coordinates can be downsampled to correctly overlay on the 2 μm/pixel tissue images. In order to reduce the heterogeneity of the H&E images, the H&E stain of all tissue images in each case can be normalized. Using the hemotoxylin and eosin channel images created for the cell counting analysis and the optical density calculated for a reference H&E image from the same case, rgb images can be reconstructed of each tissue type to the same optical density. Incorporation of image color normalization can provide for avoiding catastrophic failure of the semantic segmentation on unannotated images with different staining patterns.

Bounding boxes of all annotations can be identified and each annotated rgb image region can be extracted and saved as a separate image file. A matrix can be used to keep track of which bounding box images contain which annotation tissue types. Training images can be built through creation of a 9000×9000×3, zero-value rgb image tile. Annotation bounding boxes containing the least represented deep learning class can be randomly overlaid on a blank image tile until the tile is >65% full of annotations and such that a number of pixels of each deep learning class can be approximately even. As an illustrative example, annotation bounding boxes can be randomly augmented via rotation, scaling by a random factor between 0.8-1.2, and hue augmentation by a factor of 0.8-1.2 in each rgb color channel. The 9000×9000×3 image tile can then be cut into 324 500×500×3 images. 20 such large images can be built, half with augmentation, to create 6480 training images, and 5 additional images can be built to create 1620 validation images. 324 testing images can be created using manual annotations from an image not used for training or validation. Following dataset creation, a resnet50 network can be adapted and trained to a validation patience of 5. If 90% tissue subtype precision and recall is not obtained, additional manual annotations can be added to the training images and the process can be repeated until desired accuracy is reached. Once a satisfactory deep learning model is trained, all tissue images in the sample can be semantically segmented to create labelled tissue images with a pixel resolution of 2 μm/pixel.

As an illustrative example, the deep learning model described above can be utilized to add nerves to previously labelled histological images. For example, 50 nerve annotations per image can be collected on the images used for training. Next, collagen, blood vessel, and whitespace annotations from all previous annotation datasets can be pooled. All other tissue components (islets, normal ductal epithelium, acini, precancers, cancer, and lymph node) can be pooled to a fifth class termed ‘other tissue’. Collagen and blood vessel annotations can be kept as separate classes as the eosin-rich staining on these structures closely resembles the staining pattern on nerves. Through training of a tri-class model (nerves, whitespace, other tissue only) it can be found that nerves may often be confused with collagen and vascular structures. The five annotation classes can be pooled into training tiles as described above and a semantic segmentation network with >90% precision and recall per class can be trained across all samples. It can be calculated that >97% of pixels replaced by the nerve label had been previously classified (using the semantic segmentation network that did not contain nerves as a label) as either collagen or vasculature. As this network classified both nerves and ‘other tissue components’, the nerve classification in this trained model can be assumed to supersede the previous classification (thus all pixels labelled as nerves replaced the label for that pixel generated by the previous, 10-class model).

Registration of detected cell coordinates and labeled images can allow the computing system 102 to create cm-scale multi-labeled tissue volumes with μm and single cell resolution, which can be easily visualized and analyzed quantitatively. Thus, the computing system 102 can perform 3D reconstruction of over 1,000 serially sectioned pancreas tissue (step E, 112). 3D renderings can be created at cm, mm, and μm scale at both tissue and single cell level.

Multi-labelled images can be consolidated into a 3D matrix using the H&E image registration results. Similarly, cellular coordinates counted on the unregistered histological sections can be consolidated into a 3D cell matrix using the H&E image registration results. 3D renderings of the labelled tissue regions can be visualized using patch and isosurface commands and using a color scheme with a unique rgb triplet for each tissue subtype. Dimensions of rendered tissues can be calculated in xy using the pixel resolution of the original ×20 scanned histological sections (approximately 0.5 μm/pixel) and using the tissue section spacing (4 μm) in z. The resolution of the 3D renderings can be 2 μm/pixel in xy, the resolution used for image semantic segmentation, and 12 μm/pixel in z, as only one in three tissue sections may be used in the illustrative example analysis. Single cells can be visualized within the 3D renderings. For all calculations performed on the 3D labelled matrices of the tissues, the 3D matrix can be subsampled using nearest neighbor interpolation from original voxel dimensions of 2×2×12 μm³/voxel to an isotropic 12×12×12 μm³/voxel.

Although the steps A-E are described in reference to pancreatic tissue samples, the disclosed techniques can be used to assess a variety of other types of tissues in the human and/or animal bodies. For example, the disclosed technology can be used to assess and reconstruct tissue volume of breasts to assess breast cancer development. Moreover, the steps A-E are merely described in relation to an illustrative example. One or more of the values described in reference to steps A-E can be different based on the application of the disclosed technology.

FIG. 1B illustrates applicability of the disclosed technology to various use cases. For example, the disclosed technology can be used to generate 3D renderings or reconstruction of human skin (120). The disclosed technology can also be used to generate 3D reconstruction of mouse breast (122). The disclosed technology may be used to generate 3D reconstruction of mouse lungs (124). The disclosed technology may be used to generate 3D reconstruction of mouse small intestines (126). The disclosed technology can also be applied to many other use cases, including but not limited to the 3D reconstruction of different types of human organs and/or tissues, and/or other animal tissues and/or organs.

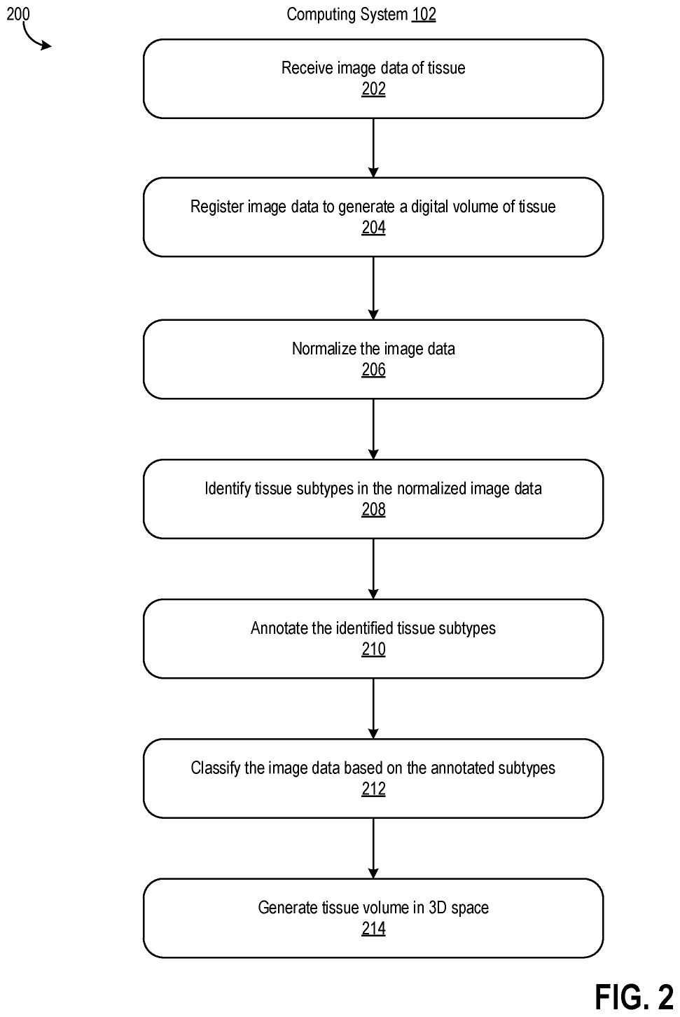

FIG. 2 is a flowchart of a process 200 for reconstructing tissue from image data in 3D space. The process 200 can be performed by the computing system 102 described herein. In some implementations, the process 200 can also be performed by one or more other computing systems, servers, and/or devices.

Referring to the process 200, the computing system 102 can receive image data of tissue samples in 202. As described herein, the tissue depicted in the image data can be serially sectioned, stained, and scanned. In some implementations, each of the image data can be named based on its position in a block. Formalin-fixed, paraffin-embedded tissue samples can be sectioned every 4 μm. In some implementations, frozen tissue samples can also be used. Tissue samples that have been prepared in a variety of other ways for sectioning and staining can also be used. Every third tissue section can be stained using H&E, with two sections every three held out. All tissues of a single sample can be scanned and received by the computing system 102 for validation that skipping two sections can still maintain registration and reconstruction accuracy. Tissues can be scanned at ×20 using a Hammamatsu Nanozoomer, as an illustrative example.

The computing system 102 can register the image data to generate a digital volume of the tissue in 204. For example, the computing system 102 can register serially sectioned images, which can create registered H&E images and/or registration displacement fields. Cases can contain series of tissue image data scanned at 20×, corresponding to approximately 0.5 μm/pixel. The image data can be saved in smaller sizes, corresponding to 8 μm/pixel using nearest neighbor interpolation. For each sample, a center image can be identified as a point of reference (imageₙ), and global and elastic registration can be calculated for all other images in the sample.

Moreover, the computing system 102 can perform registration on greyscale, Gaussian-filtered, down sampled (80 μm/pixel resolution) versions of high-resolution histological sections of the tissue sample(s). Global registration transformations for a pair of preprocessed tissue images can be found through iterative calculation of registration angle and translation via maximization of cross-correlation. Radon transforms of the images taken at discrete angles between 0 and 359 degrees can also be calculated by the computing system 102. A maximum of a cross correlation of radon transforms of the image data can yield a registration angle, and the maximum of a cross correlation of the rotated tissue image data can yield translation. Elastic registration can be obtained by calculating, by the computing system 102, rigid registration of cropped image tiles at 1.5 mm intervals across the globally registered image data at 8 μm/pixel resolution. Sometimes, the intervals can be anywhere between 0.1 mm and 5 mm. Resulting local, rigid registration fields can be interpolated and smoothed to produce a nonlinear, elastic registration transformation.

Rigid global registration can also be performed by the computing system 102 to sequentially register each image_{n+/-m} to three next closest images to center, image_{n+/-(m+1)} image_{n+/-(m+2)}, and image_{n+/-(m+3)}. Quality of each of the three global registrations can be assessed by comparing pixel-to-pixel correlation between a moving image and each reference image. The registration with the best result can be kept and the other two can be discarded. Following global registration, elastic registration can be employed between the moving image and chosen reference image to create a nonlinear displacement map. The process described in reference to block 204 can be repeated for all image data in a tissue sample such that all the image data can be elastically registered to the coordinate system of the center imageₙ.

Next, the computing system 102 can normalize the image data in 206. Normalizing the image data can include normalizing color of the H&E stain across the image data. As a result, the computing system 102 can generate color normalized images and identified cell coordinates. First, a hemotoxylin channel of all H&E image data can be extracted using color deconvolution. For each image, the tissue region of the image can be identified by finding regions of the image with low green channel intensity and high rgb standard deviation. Next, rgb channels can be converted to optical density. Using kmeans clustering analysis, 100 clusters can be identified to represent optical densities of the image. A common blue-favored optical density can be chosen to represent the hemotoxylin channel, and a common red-favored optical density can be chosen to represent an eosin channel. The background optical density can be fixed as an inverse of an average of the hemotoxylin and eosin optical densities. These three optical densities can then be used to deconvolve the rgb image into hemotoxylin, eosin, and background channel images. Accordingly, the hemotoxylin channel images can be smoothed, and 2D intensity minima of a designated size and distance from each other can be identified as nuclei. Sometimes, the image data may not be normalized—normalizing the image data can be optionally performed by the computing system 102.

As an illustrative example, a total of 3 2 mm×2 mm regions can be extracted from each case for validation. For each region, cells can be manually located using an annotation function. A manually identified cell can be considered to be equivalent to an automatically detected cell if the coordinates were within 4 μm of each other (corresponding to 3 pixels in the 2 μm/pixel downsampled images used for cell detection). This validation can demonstrate a 94% consistency between manually and automatically detected cell coordinates.

The computing system 102 can then identify tissue subtypes in the normalized image data in 208. The computing system 102 can also annotate the identified tissue subtypes in 210. In some implementations, the annotated images can be used for deep learning training. A deep learning model can be generated for each case using manual tissue annotations of that sample. As an illustrative example, seven tissue images equally spaced within each sample can be extracted. For each of the seven images, 50 examples of each identified tissue subtype can be annotated. In some implementations, the annotations can be automatically made by the computing system 102 instead of and/or in combination with a user's annotations. Annotation coordinates can then be downsampled to overlay on the 2 μm/pixel tissue image data.

The computing system 102 can also classify the image data based on the annotated subtypes in 212. The image data can be classified based on pixel resolution, a number of combine annotation tissue classes, color definitions for labeling of tissue classes, and names of tissue types corresponding to each class label. The classified images can also be aligned using registration displacement fields that were determined by the computing system 102 in block 204.

In some implementations and as an illustrative example, bounding boxes of all annotations can be identified and each annotated rgb image region can be extracted and saved as a separate image file. A matrix can be used to keep track of which bounding box images contained which annotation tissue types. Training images can also be built through creation of a 9000×9000×3, zero-value rgb image tile. Annotation bounding boxes containing least represented deep learning class can be randomly overlaid on a blank image tile until the image tile is >65% full of annotations and such that a number of pixels of each deep learning class can be approximately even. Annotation bounding boxes can be randomly augmented via rotation, scaling by a random factor between 0.8-1.2, and hue augmentation by a factor of 0.8-1.2 in each rgb color channel. The 9000×9000×3 image tile can then be cut into 324 500×500×3 images. 20 such large images can be built, half with augmentation, to create 6480 training images, and 5 additional images can be built to create 1620 validation images. 324 testing images can be created using manual annotations from an image not used for training or validation.

Moreover, following dataset creation, a resnet50 network can be adapted for semantic segmentation and trained to a validation patience of 5. If 90% tissue subtype precision and recall are not obtained, additional annotations can be added to the training image data and the process described above can be repeated until desired accuracy can be reached. Once a satisfactory deep learning model is trained, all tissue image data in the sample can be semantically segmented to create labelled tissue image data with a pixel resolution of 2 μm/pixel.

The computing system 102 can generate the annotated and classified tissue volume in 3D space (214). The generation can be based on inputs including pixel resolution of classified images in micron/pixel and distance between serial sections. One or more additional functions can be used to analyze the classified tissue volume. To reduce heterogeneity of the H&E image data, the H&E stain of all tissue image data in each case can be normalized, as described above. Using the hemotoxylin and eosin channel images created for the cell counting analysis and the optical density calculated for a reference H&E image from the same case, the computing system 102 can reconstruct rgb images of each tissue type to the same optical density. Incorporation of image color normalization can be advantageous to avoid failure of semantic segmentation on unannotated images with different staining patterns.

As described herein, multi-labelled images can be consolidated, by the computing system 102, into a 3D matrix using the H&E image registration results. Similarly, cellular coordinates counted on the unregistered histological sections can be consolidated into a 3D cell matrix using the H&E image registration results. 3D renderings of the labelled tissue regions can be visualized using patch and isosurface functions and/or using a color scheme with a unique rgb triplet for each tissue subtype. Dimensions of rendered tissues can be calculated in xy using a pixel resolution of the original ×20 scanned histological sections (approximately 0.5 μm/pixel) and using the tissue section spacing (4 μm) in z. Resolution of the 3D renderings can be 2 μm/pixel in xy, the resolution used for image semantic segmentation, and 12 μm/pixel in z, as only one in three tissue sections may be used in the analysis, as described in this illustrative example. Single cells can also be visualized within the 3D renderings. For calculations performed on the 3D labelled matrices of the tissues, the 3D matrix can be subsampled using nearest neighbor interpolation from original voxel dimensions of 2×2×12 μm³/voxel to an isotropic 12×12×12 μm³/voxel.

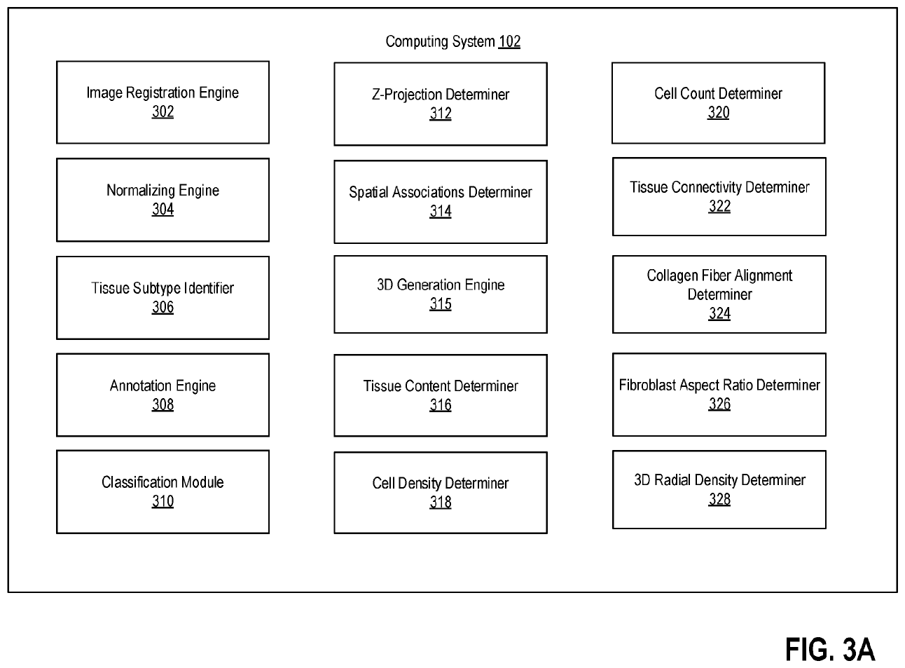

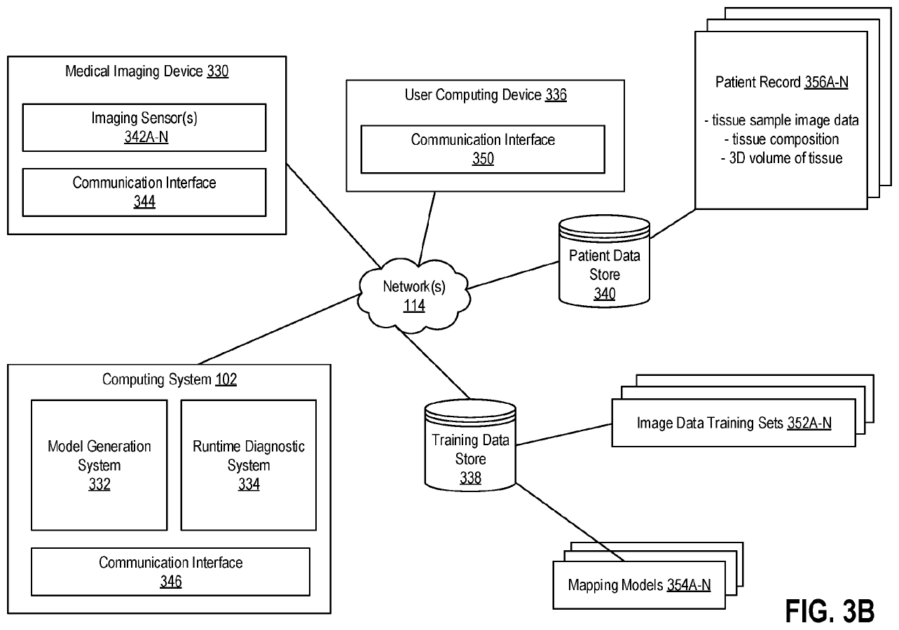

FIGS. 3A-B are system diagram of one or more components that can be used to perform the techniques described herein. Referring to FIG. 3A, one or more of the components described herein can be included in one device, such as the computing system 102, and/or in separate or different computers, systems, servers, cloud servers, and/or devices that are in communication via the network 114 (e.g., refer to FIG. 1). For example, one or more of the components can be part of a software package that can be downloaded and/or accessed by a user device, such as a smartphone, computer, laptop, or tablet. One or more of the components can also be stored in the cloud and accessible via devices such as a user device and/or the computing system 102. For illustrative purposes, the one or more components are described in reference to being incorporated or part of the computing system 102.

The computing system 102 can include an image registration engine 302, normalizing engine 304, tissue subtype identifier 306, annotation engine 308, classification engine 310, z-projection determiner 312, spatial associations determiner 314, 3D generation engine 315, tissue content determiner 316, cell density determiner 318, cell count determiner 320, tissue connectivity determiner 322, collagen fiber alignment determiner 324, fibroblast aspect ratio determiner 326, and a 3D radial density determiner 328. In some implementations, the computing system 102 can include additional or fewer components to perform the techniques described herein.

The image registration engine 302 can be configured to register image data to generate a digital volume of tissue. Refer to step B (106) in FIG. 1A and block 204 in FIG. 2.

The normalizing engine 304 can be configured to normalize the image data once it has been registered. Refer to block 206 in FIG. 2.

The tissue subtype identifier 306 can be configured to identify tissue subtypes from the registered and normalized image data. Refer to block 208 in FIG. 2.

The annotation engine 308 can be configured to annotate the identified tissue subtypes. Refer to step D (110) in FIG. 1A and block 210 in FIG. 2. The annotation engine 308 can automatically annotate the image data. In some implementations, the annotation engine 308 can receive user input indicating manual annotations of the tissue subtypes. In some implementations, the annotation engine 308 can also be configured to generate training datasets that can be used to train and/or improve one or more machine learning models described herein.

The classification module 310 can be configured to classify the image data based on the annotated tissue subtypes. Refer to block 212 in FIG. 2.

The z-projection determiner 312 can be configured to construct z-projections of each tissue subtype using 3D labeled matrices of each case. For each tissue subtype, pixels of the 3D matrix corresponding to that subtype can be summed in a z-dimension, creating a projection of a volume on an xy axis. The projections can be normalized by their maximum and visualized using a same color scheme created for visualization of the 3D tissue. As an illustrative example, 3D labelled matrices of each patient case can be used to construct z-projections of each tissue subtype. For each tissue subtype, pixels of the 3D matrix corresponding to that subtype can be summed in the z-dimension, creating a projection of the volume on the xy axis. The projections can be normalized by their maximum and visualized using the same color scheme created for visualization of the 3D tissue.

The spatial associations determiner 314 can be configured to calculate spatial associations of different tissue subtypes using the 3D matrices described above and herein. For example, a 3D matrix containing the tissue subtype of interest can be isolated. Next, regions containing that tissue subtype can be dilated to a distance of 48 μm. Spatial association of that tissue subtype to other tissues in the case can be calculated as a percentage of each tissue subtype present in the dilated region divided by a total volume of the dilated region (not including any portion of the dilation that extended outside the tissue volume). As another example, the determiner 314 can isolate labels for normal ductal epithelium, pancreatic precancer, or pancreatic cancer in a matrix. The determiner 314 can also identify pixels within 180 μm of the tissues. Collagen, vascular, and neural content within 180 μm of ducts, precursor, and cancer can be determined by calculating the number of collagen (or blood vessel or nerve) labelled voxels within this region, normalized by the total number of tissue-labelled voxels in the region.

The 3D generation engine 315 can be configured to map the annotated and classified image data into 3D space. Refer to step E (112) in FIG. 1A and block 214 in FIG. 2.

The tissue content determiner 316 can be configured to measure tissue content. The determiner 316 can count a total number of voxels in the isotropic 3D matrix corresponding to each tissue subtype and divide the total number by a total number of voxels in the tissue region of the 3D matrix.

The cell density determiner 318 can be configured to determine cell density. The cell density of each tissue subtype can be calculated by combining tissue subtype data in the multi-labelled 3D matrix with cell coordinate data in the cell 3D matrix.

The cell count determiner 320 can be configured to determine a quantity of cells in each tissue subtype. For example, cells at each voxel in the cell 3D matrix can correspond to the tissue subtype label in the multi labelled 3D matrix (e.g., a cell can be labelled an epithelial cell if a nuclear coordinate is identified in a region labelled as epithelium using one or more machine learning models described herein). Measurements of nuclear diameter can be used to estimate true 3D cell counts from 2D cell coordinates. As an illustrative example, 100 nuclei of each tissue subtype can be measured for each case. The estimated 3D cell count (C3D) of cells counted on serial histological sections analyzed every 3 sections can be calculated using formula:

$${C}_{3 D} = {\sum }_{images} {\sum }_{subtypes} {C}_{image} \frac{3 T}{T + {D}_{subtype}}$$

where C_{image} can be cell count for a given tissue image, T can be thickness of a histological section, and D_{subtype} can be measured diameter of a nucleus for a tissue subtype. For each tissue subtype, bulk 3D cell density can be calculated by dividing a 3D extrapolated cell count of a particular subtype divided by a total volume of the tissue. Local 3D cell density can be calculated by dividing the 3D extrapolated cell count of a particular subtype by the volume of that particular tissue subtype.

The tissue connectivity determiner 322 can be configured to measure tissue connectivity using the 3D multi-labeled matrices. As an illustrative example, following classification, objects labelled as pancreatic precancers lesions or pancreatic cancer can be visually verified to be precancers by inspection of the corresponding histology. Independent precursors (e.g., spatially distinct objects in matrices) can be identified in the 3D multi labelled matrix. Connectivity can be calculated on both the precancers and the precancers plus a normal ductal epithelium. Distinct precancers and cancers that are identified can then be quantitatively analyzed or 3D rendered independently from other precancers.

As an illustrative example, independent precursor coordinates can be used to automatically annotate connected lesions on H&E images of 2 μm/pixel resolution. Each precursor can be assigned a distinct RGB color. For each registered H&E image in the serial sections, a number of distinct precursors appearing on that section can be determined. For each independent precursor on the section, voxels defining the precursor in the volume matrix can be located. The pixels can be dilated and the outline can be kept, then rescaled to match the 2 μm/pixel H&E images such that the annotated precursor mask can be reformatted to appear as a thick outline overlaid on the precursor region of the H&E section. The outline can be overlaid on H&E and the pixels in the H&E image corresponding to the outline can be recolored to match the color defining that independent precancer. This can be repeated for all precancers in the sample. The same coloring scheme for each precancer can then be used in a 3D reconstruction of the sample, allowing relevant users to match precancer histology to a correct 3D reconstructed precancer.

Moreover, a number of precursors present in each sample can be calculated. A number of lesions present on each 2D section (not considering 3D connectivity) can be determined. Next, a true number of precursors present on each section when considering 3D connectivity can be determined. For each section in which at least one precursor is present, the number of (distinct in 2D space) precursor-classified objects can be normalized by the number of (distinct in 3D space) precursor-classified objects present on the section. The average and standard deviation of this ratio for each sample can be calculated, and in some implementations, also plotted. Metrics may also be performed on each independent precancer to determine 3D morphology. Using the 3D reconstructions and serial bounding boxes of each precancer, 3D phenotype can be determined using the disclosed technology by assessing 3D presentation as well as location of the precancer in pancreatic ducts and/or pancreatic acinar lobules. Cell count can then be determined by counting the number of cells located in the same voxel coordinates as each defined precursor lesions and corrected using the 3D cell conversion equation described above. Precursor volume can be calculated by summing the number of voxels defining each precancer and converting from voxel to mm³ units (e.g., 1 voxel=12*12*12*10⁻⁹ mm³). Precursor cell density can also be calculated by dividing cell number per precursor by precursor volume. Precursor primary axis length may also be determined using one or more techniques described throughout this disclosure.

The collagen fiber alignment determiner 324 can be configured to calculate collagen fiber alignment. As an illustrative example, using the 3D renderings of the pancreatic ductal epithelium, six regions can be identified comprising three axially and three longitudinally sectioned regions of the ducts in three cases. The 2D histological sections can be located using 3D coordinates of the identified regions. The region of interest can be cropped from corresponding 20× H&E images. Color deconvolution as described above can be applied to the cropped 20× H&E image to separate the hematoxylin and eosin channels. An alignment index of the eosin channel can be compared to a degree of collagen alignment in axially and longitudinally sectioned regions of the ducts. An alignment index can therefore be measured using the techniques described above. The alignment index of 1 can represent completely aligned matrix of fibers. An alignment index of 0 can represent an isotropic matrix of fibers.

The fibroblast aspect ratio determiner 326 can be in communication with the collagen fiber alignment determiner 324. The determiner 326 can be configured to determine the fibroblast aspect ratio. For example, the determiner 326 can measure a length of major and minor axis of nuclei in a ductal submucosa to calculate aspect ratios using image data. Violin plots can be used to determine the aspect ratio.

The 3D radial density determiner 328 can be configured to determine 3D radial density of tissue subtypes and cells. For example, the determiner 328 can calculate 3D radial density of tissue subtypes and cells using the multi-labeled and cell coordinate 3D matrices. A region of interest can be identified in the 3D multi-labeled matrix. A logical 3D matrix can be created containing only this identified region. Next, dilations of a predefined step size (such as 12 μm) can be performed. For each dilation, a number of cells and percent of each tissue subtype present in the dilation can be calculated and normalized by a total volume of the dilation. Output can include a scatter plot with normalized tissue subtype or cell density on the y axis and distance from the region of interest on the x axis.

Referring to FIG. 3B, computer system 102, medical imaging device 330, user computing device 336, training data store 338, and patient data store 340 can be in communication via the network(s) 114 to perform the techniques described herein. In some implementations, one of more of 102, 330, 336, 338, and 340 can be combined into one or more computing systems, servers, and/or devices. Moreover, in some implementations, one or more techniques performed by any one or more of 102, 330, and 336 can be performed by one or more other computing systems, servers, and/or devices.

The medical imaging device 330 can be configured to generate image data of a patient's body. For example, the medical imaging device 330 can include a mammogram, ultrasound, MRI, tomosynthesis, or other type of imaging device that may be used in medical settings. The medical imaging device 330 can include one or more imaging sensors 342A-N and a communication interface 344. The imaging sensors 342A-N can be configured to capture images the patient's body, such as a patient's pancreas, breast(s), and other internal parts of the body.

The computing system 102 can include one or more components, as described throughout this disclosure and in reference to FIG. 3A. Moreover, the computer system 102 can include a model generation system 332, a runtime diagnostic system 334, and a communication interface 346. One or more of the components described in reference to FIG. 3A can be included or otherwise part of the model generation system 332 and/or the runtime diagnostic system 334.

Referring to the components of the computing system 102 depicted in FIG. 3B, the model generation system 332 can be configured to generate one or more machine learning models used to perform the techniques described herein. For example, the model generation system 332 can generate models that map image data of a tissue sample into multi-dimensional space, such as 3D space, as described throughout this disclosure. The models can be generated using image data training sets 352A-N, which can be retrieved from the training data store 338. The generated models can be stored in the training data store 338 as mapping models 354A-N.

Still referring to the computing system 102, the runtime diagnostic system 334 can be configured to use the mapping models 354A-N during runtime in order to assess and diagnose conditions of patients based on their tissue samples. The runtime diagnostic system 334 can include one or more of the components described in reference to FIG. 3A. As an illustrative example, the runtime diagnostic system 334 can receive image data of a patient's tissue from the imaging sensors 342A-N of the medical imaging device 330. The runtime diagnostic system 334 can also retrieve the mapping models 354A-N from the training data store 338. The runtime diagnostic system 334 can apply the mapping models 354A-N to the image data in order to generate a 3D volume of the patient's tissue. Components depicted in FIG. 3A, such as the image registration engine 302 and the normalizing engine 304 can be configured, as part of the runtime diagnostic system 334, to register and normalize the received image data before the image data is used to generate the 3D volume. The tissue subtype identifier 306 in FIG. 3A can identify one or more tissue types, compositions, and/or classes in the registered and normalized image data. The 3D generation engine 315 in FIG. 3A can generate the patient's tissue into a 3D volume using the image data and the mapping models 354A-N. One or more additional components depicted in FIG. 3A can perform operations on the 3D generated volume of the patient's tissue during runtime at the runtime diagnostic system 334. The one or more additional components can include the tissue content determiner 316, the cell density determiner 318, the cell count determiner 320, the tissue connectivity determiner 322, and the collagen fiber alignment determiner 324.

The runtime diagnostic system 334 can be part of or separate from the medical imaging device 330 and/or the user computing device 336. The runtime diagnostic system 334 can also be part of or separate from a radiology system. Moreover, in some implementations, the runtime diagnostic system 334 and the model generation system 332 can be part of separate computing systems.

Determinations made and analysis performed by the runtime diagnostic system 334 can be stored in the patient data store 340. Each patient can have a patient record 356A-N. Each patient record 356A-N can include tissue sample image data, tissue composition, and 3D volume of tissue. One or more additional or fewer information can be stored and associated with the patient records 356A-N. For example, a diagnosis made by the computing system 102 and/or a practitioner/clinician at the user computing device 336 can also be stored in the patient records 356A-N. The runtime diagnostic system 334 can store the generated 3D volume of the tissue sample in the corresponding patient record 356A-N. The generated 3D volume of the tissue sample can then be used for analysis and diagnosis of the patient's condition at a later time.

The user computing device 336 can be used by a relevant user, such as a clinician, scientist, or other professional. Via the user computing device 336, the relevant user can annotate image data of the tissue samples. For example, the image data can be transmitted from the medical imaging device 330 to the user computing device 336. The relevant user can manually annotate the image data with tissue classes, types, subtypes, and/or measurements. This annotated image data can then be transmitted from the user computing device 336 to the model generation system 332, where the annotated image data can be used to train one or more of the models described herein. The annotated image data can also be transmitted from the user computing device 336 to the training data store 338 to be stored as image data training sets 352A-N.

During runtime, the user computing device 336 can be used by the relevant user to view information about the imaged tissue sample. For example, the 3D volume of the tissue sample can be transmitted by the runtime diagnostic system 334 to the user computing device 336 for display. Similarly, any determinations made by the components described in reference to FIG. 3A can be transmitted by the runtime diagnostic system 334 and/or the computing system 102 to the user computing device 336 for display. The relevant user can view and analyze the displayed information to assess the condition of the patient. For example, the relevant user can determine whether the patient has cancer, what stage of cancer the patient is at, and one or more other diagnostics, treatments, and/or predictions. Determinations made by the relevant user can be stored in the corresponding patient record 356A-N in the patient data store 340.

Finally, communication interfaces 334 of the medical imaging device 330, 346 of the computing system 102, and 350 of the user computing device 336 can provide for the components described herein to communicate (e.g., wired and/or wirelessly) with each other and/or via the network(s) 114.

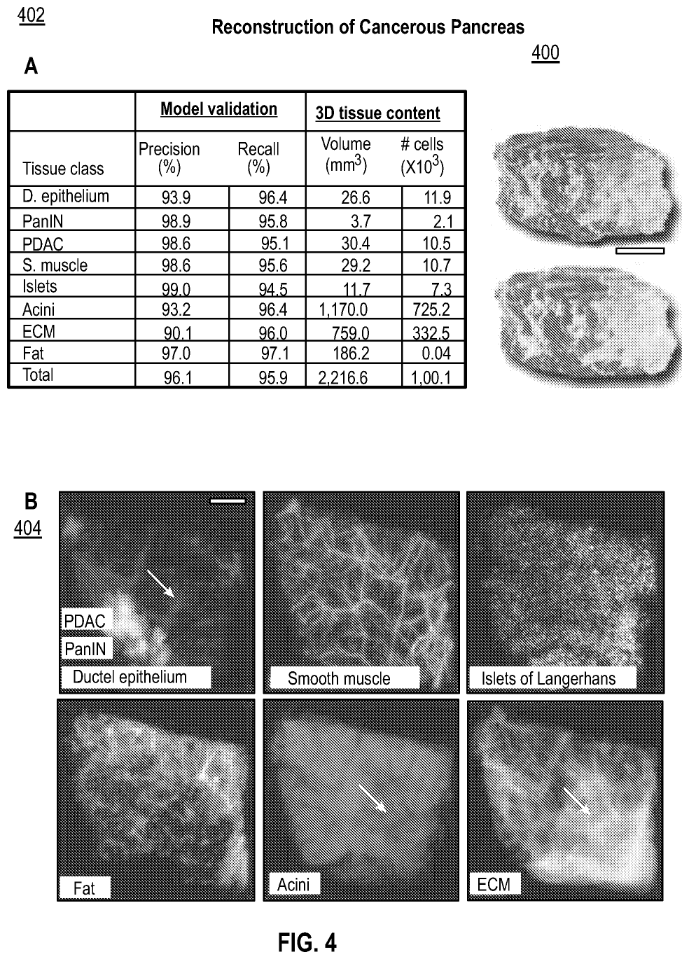

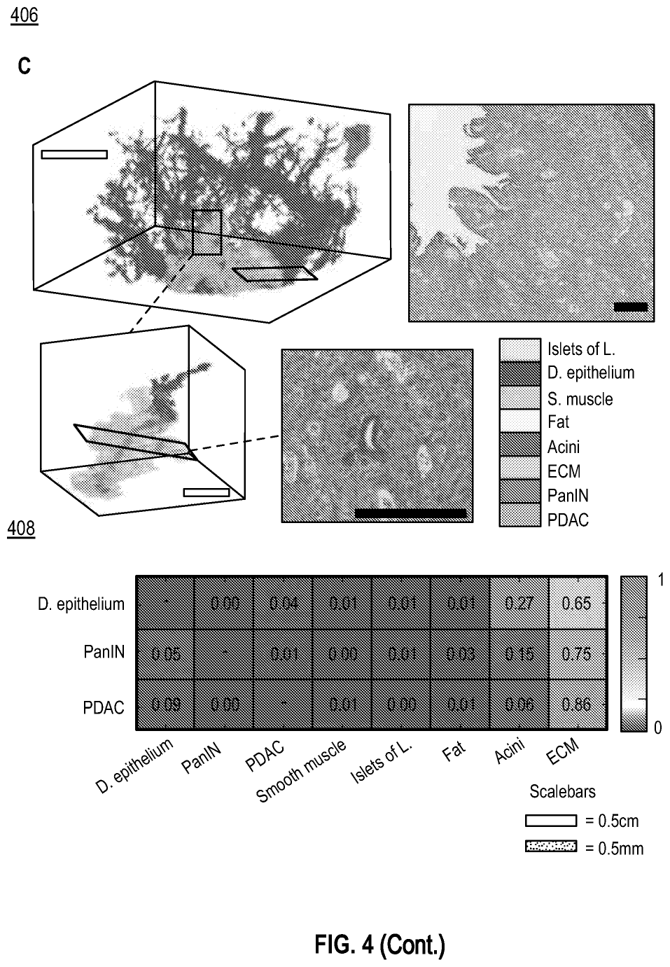

FIG. 4 depicts a process 400 for 3D reconstruction of cancerous human pancreas tissue. As described throughout this disclosure, the process 400 can be performed by the computing system 102. The process 400 can also be performed by one or more other computing systems, servers, and/or devices, as described herein. For illustrative purposes, the process 400 is described from the perspective of a computing system.

Referring to the process 400, the process 400 can be used for quantitation of cancerization of large ducts in the human pancreas. In 402, deep learning training accuracy can be assessed using annotations of tissue subtypes. The annotations can be manual. In some implementations, the annotations can also be automated. A deep learning model can be iteratively trained until subtype precision and recall of >=90% can be obtained. Bulk tissue subtype volume and cell counts can also be calculated by the computing system. Fully labeled reconstructed volume and detected cells can be used by the computing system to assess dimensions of the tissue sample, composition of tissue subtypes, and number of cells in each subtype quantitatively. The S04-PDAC sample described herein, for example, had estimated dimensions of 2.7 cm×2.0 cm×0.6 cm with a total volume of ˜2.2 cm³. The sample contained ˜1.1 billion cells. Of these, 2.1 million cells (˜0.2%) were identified by the computing system as cancer precursor and ˜10.5 million cells (˜1%) were identified as invasive cancer.

In 404, the computing system can generate z-projections of classified regions, which can demonstrate a normal pancreatic duct extending from a large cancer mass to an area of acinar atrophy, as depicted by arrows in 404. Moreover, as depicted in 404 in FIG. 4, a smaller, non-neoplastic duct fed into a portion of the duct colonized by the invasive cancer, and this upstream pancreatic parenchyma was atrophic with acinar drop-out and increased content of ECM and prominent islets of Langerhans. In 404, the computing system can visualize a landscape of cancer invasion at a leading edge of the cancer and adjacent normal tissue via z-projections and 3D renderings. The z-projections of the normal duct and benign spindle shaped cells (vasculature and nerves) can show well-connected tubular morphology.

In 406, the computing system can generate a 3D reconstruction and sample histology. This can demonstrate cancerization of a large duct and a cancer protrusion growing along a smaller duct. The z-projections from 404 can show a large mass of adenocarcinoma located at one side of the tissue sample that had a strong spatial association with a large normal pancreatic duct. The 3D rendering of PDAC, precursor lesions, and normal ductal epithelium can reveal that this spatial association can be in part because the invasive cancer infiltrated the ductal epithelium, a process known as cancerization of the ducts. The cancer and atrophic region identified using deep learning 3D reconstruction can be confirmed with review (e.g., automated and/or manual) of the histology, thereby validating 3D reconstruction and labeling capabilities of the disclosed technology.

Moreover, in 406, three small projections of the invasive cancer can be found extending from a large tumor into surrounding normal pancreatic tissue, appearing to colocalize smaller pancreatic ducts. Examination of the 3D rendering can reveal that the largest of these projections surrounded and extended parallel to a pancreatic duct for a distance of >3 mm without invading the epithelial layer.

Quantification of tissues present in 50 μm surrounding ducts, precancers, and cancer can be performed by the computing system in 408. Doing so can result in depicting ECM surrounding all three tissue subtypes and increases in quantity with progression from normal duct to precancer to cancer. Visualization of a leading edge of cancer in a large 3D pancreas sample can indicate that invasive cancers can track in the periductal stroma parallel to pre-existing ducts in the pancreas, as is demonstrated in 408 in FIG. 4.

The disclosed technology, as shown in FIG. 4, can be used to explore 3D morphology of a tumor. A mass, for example, can consist of a bulk region of invasive carcinoma with three prominent protrusions extending into surrounding normal pancreatic tissue. The first of these protrusions can be invasive cancer extending within the lumen of a vein for a distance of at least 4 mm. Examination of second of two protrusions of invasive cancer can reveal a region in which the cancer extends along periductal stroma for >3 mm without invading the epithelial layer. The third protrusion of invasive cancer beyond the bulk tumor can be a focus of perineural invasion of >1 mm in length. The disclosed technology can also be used to study these invasion patterns across all samples. To explore tumor heterogeneity, variation in tumor volume can be quantified as well as number of cancer clusters, and average volume of cancer clusters per histological section. This can reveal, in an illustrative example, a range of 0-600 individual cancer clusters per slide, an average cancer cluster size of 0-6000 μm³ per slide, and a range of 0-0.3 mm³ in total volume of cancer per slide. Among eight samples containing invasive cancer, all contained regions of venous invasion, seven (87%) contained perineural or neural invasion, and five (63%) contained regions of invasion along periductal, perivascular, or perilobular stroma. As the disclosed technology allows confirmation of 3D findings in high-resolution H&E images, all foci of invasion can be validated via examination of the histology. Using the disclosed technology, high resolution 3D renderings of pancreatic cancer perineural invasion can be obtained and then further analyzed to identify that cancer can extend for mm's along nerve fibers, following nerve branching and curving. Previously unknown structural effects to the nerve brought on by cancer involvement can also be identified with the disclosed technology, including: a ‘twisting’ of cancer around the length of the nerve as well as a ‘narrowing’ of the nerve by cancer at the moment of invasion.

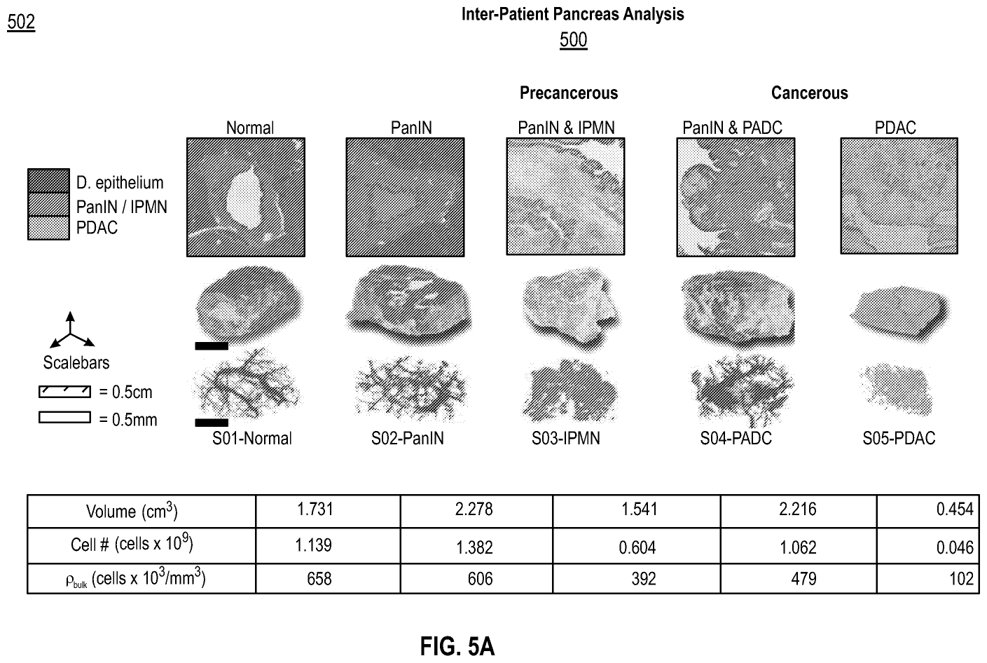

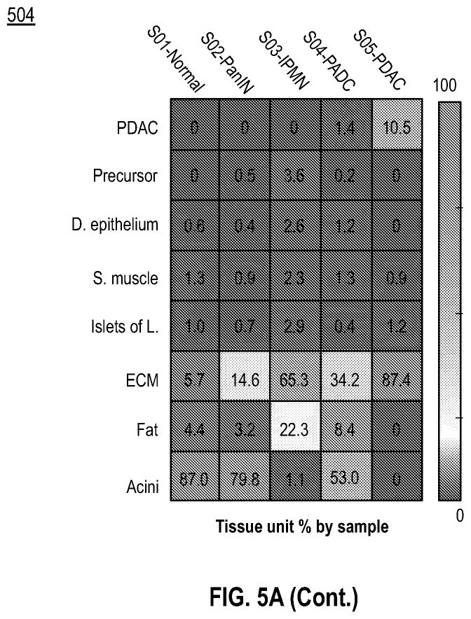

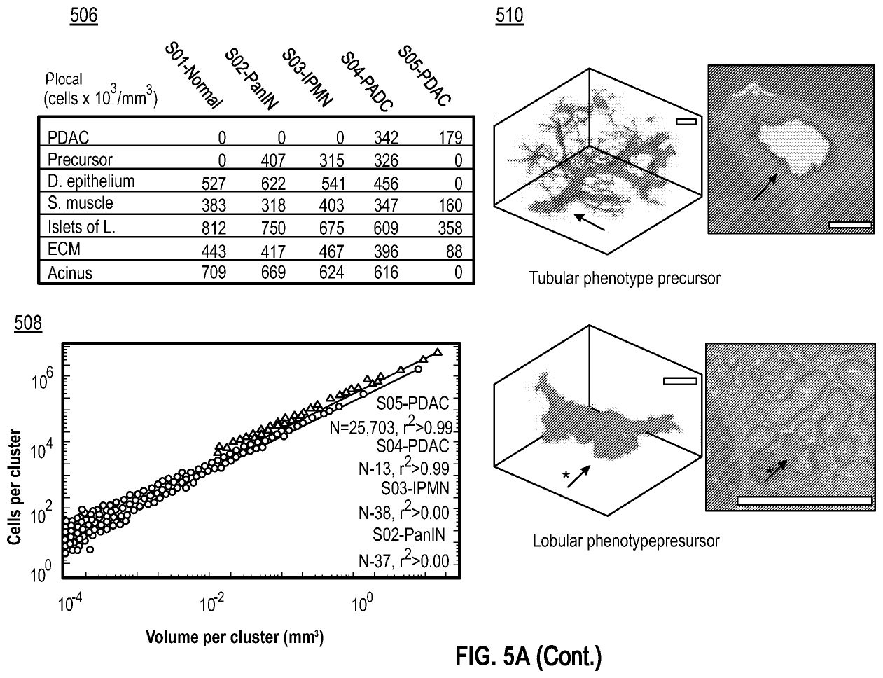

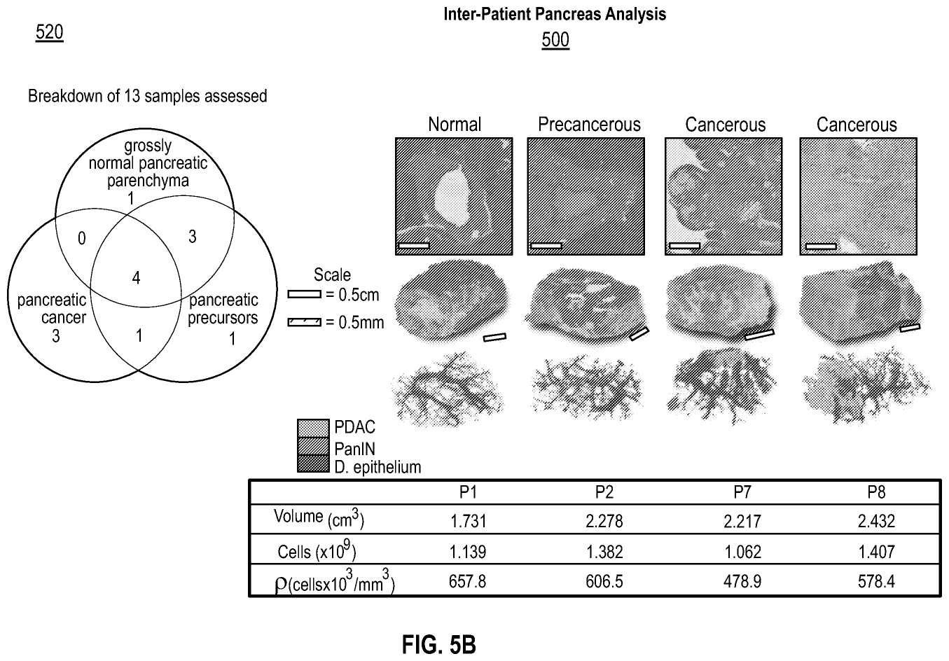

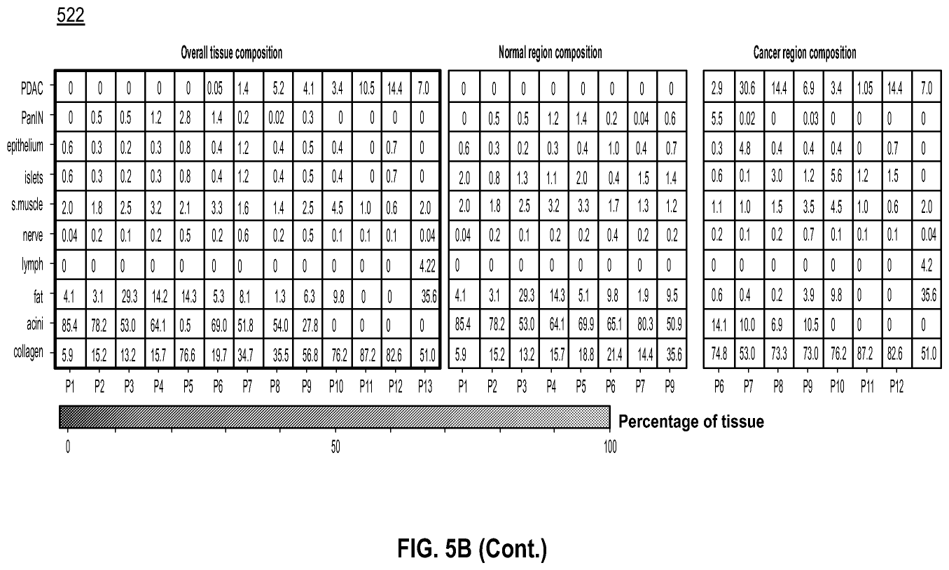

FIGS. 5A-B depict inter-patient pancreas analysis 500 from cm-scale to single cell resolution. Referring to FIG. 5A, to further investigate 3D patterns in pancreatic cancer tumorigenisis, changes in tissue architecture can be characterized in four additional tissue samples for a total of five samples spanning S01-Normal: normal pancreas; S02-PanIN and 503-IPMN: pancreas containing precursor lesions PanIN or IPMN; S04-PDAC: pancreas containing invasive poorly differentiated pancreatic ductal adenocarcinoma with adjacent grossly normal tissue; and S05-PDAC: pancreas containing invasive poorly-differentiated pancreatic ductal adenocarcinoma with no adjacent normal tissue (e.g., refer to Table 1). Using the disclosed techniques, multi-labeled 3D maps of these tissue samples can be generated, as shown in FIG. 5A. Individual deep learning models can be trained for each sample with performance of >90% class precision and recall compared to manual and/or automated annotations (e.g., refer to FIGS. 11A-B).

502 depicts bulk tissue volumes, cell counts, and cell densities for samples containing normal pancreas, precancerous lesions, and pancreatic ductal adenocarcinoma. The disclosed techniques can provide direct 3D visualization of normal pancreas, pancreatic cancer precursors (PanIN and IPMN), and PDAC at cm-scale with μm and single-cell resolution.

504 depicts a heatmap showing tissue subtype percentages of tissue samples. Through quantification of tissue volume and cell count, the computing system described herein can compare overall cell densities between samples. With progression from normal pancreas to cancer precursor to cancer, bulk cell density (ρbulk, total number of cells normalized by total tissue volume) can decrease. Comparison of ρbulk with tissue subtype percentages can reveal that tissues containing precursors and invasive cancers, which had the lowest ρbulk, can contain a highest percentage of ECM and lowest percentage of acini. Markedly, acinar content can drop from normal (87.0%) in the S04-PDAC case (53.0%), which contains cancer and adjacent grossly normal tissue, and can be nearly absent in both S03-IPMN (1.1%), and S05-PDAC (0%), as the normal pancreatic parenchyma in these samples can be entirely atrophic. ECM content can be highest (87.4%) in the case of extensive infiltrating PDAC (S05-PDAC) compared to S01-Normal pancreas (5.7%). Therefore, although growth of precancerous and invasive cancer cells can imply an increase in cellular content, cocurrent acinar atrophy and the laying down of desmoplastic stroma and connective tissue can result in an overall decrease in bulk in situ cell density with development of pancreatic cancer.

506 depicts a table showing local tissue subtype cell densities. In addition to bulk cell density, local cell density (ρ_{local}) can be used by the computing system for deeper exploration of these structural changes. ρ_{local} can be defined as the cell density of a tissue subtype within the detected volume of that subtype—while calculation of bulk cell density can show a number of cells in the total tissue volume, ρ_{local} allows exploration of the closeness or sparseness of tissue subtypes at a local level. ρ_{local} can decrease in the acini, islets of Langerhans, ECM, normal ductal epithelium, and precursor subtypes with progression from normal pancreas to PDAC, suggesting that these cells can be larger or more sparse in cancer precursor and cancerous samples than they are in the normal sample. Direct visualization of the histologic slides by a pancreatic pathologist can further confirm that normal ductal epithelial cells can appear larger in the S04-PDAC sample than in the normal and precancerous cases, and that normal acinar cells can pack more tightly than atrophic acinar cells. Using the disclosed techniques, cocurrent growth of less-inflamed ECM can be found as extracellular fibrous connective tissue replace atrophied acini, and desmoplastic stroma can develop around the cancer to result in a decrease in ECM cell density with tumorigenesis.

508 depicts a plot of volume per cluster versus cells per cluster for independent precursor and cancerous cell clusters across four tissue samples. Lines of best fit demonstrate that precancer and cancer clusters maintain similar cell density independent of cluster volume. In addition to bulk measurements, the computing system can use the disclosed techniques for enumeration of architectural patterns in tissue samples. Pancreatic intraepithelial neoplasia by definition can involve complex branching of the pancreatic duct system. In 2D, it can be challenging to discern if a user is observing two separate PanIN lesions or one PanIN that has branched, or whether a PanIN occupies a small region of a pancreatic duct or extends for many mm within the ductal architecture. Using the techniques described herein, in 3D, precursors can present in a range of volumes, can be architecturally simple or highly branched, and many spatially distinct precursors can develop within cm-scale regions. As an illustrative example, 37 PanIN lesions can be identified in sample S02-PanIN, 38 precursors in S03-IPMN, and 13 PanIN lesions in S04-PDAC, varying in size from 0.013-9.7 mm³ and containing a range of 4,000-3,728,000 cells. Precursor ρ_{local} can be relatively constant and independent of volume, with mean precursor cell density of 404,000±1,000 standard error cells/mm³ in sample S02-PanIN. Similarly, cancer ρ_{local} can be independent of tumor volume, with mean cancer cell density of 189,000±300 standard error cells/mm³ in S05-PDAC, for cancer cell clusters containing a range of 1-1,500,000 cells. This suggests that pancreatic cancer precursor and cancerous cells can occupy the same amount of space whether they present in-situ as single cells or within very large tumors.

510 depicts 3D renderings and sample histology to show two 3D phenotypes of PanIN. Tubular PanIN can preserve normal pancreatic ductal morphology, while a lobular PanIN can resemble clusters of acinar lobules. While assessing 3D connectivity of cancer precursors, two 3D structural phenotypes of PanIN can be identified and termed as tubular and lobular. Tubular PanIN lesions can appear as elongated, ductal, branching structures, while lobular PanIN lesions can appear as clumped, “bunches of grape-like,” near-solid masses. Review of the corresponding H&E sections by a pancreatic pathologist and/or the computing system can reveal that tubular PanINs reside within more proximal pancreatic ducts, while lobular PanIN lesions reside at terminal junctions between ducts and acinar lobules. The lobules in these cases can represent areas of acinar to ductal metaplasia. Moreover, nearly a third of PanINs can exhibit both phenotypes, with regions of growth within both more proximal pancreatic ducts and more distally as the ducts merged with acini. Accordingly, structural appearance of PanIN can mirror appearance of the tissue it develops within. Tubular PanINs can resemble the shape of pancreatic ducts, while lobular PanINs take on the architecture of acinar lobules. While it is known that PanIN can extend from the ductal epithelium to foci of acinar to ductal metaplasia, using the disclosed techniques, it can be suggested that this involvement of the acinar tissue affects the 3D organization of the precursor.

The analysis 500 emphasizes that dramatic, volumetric changes to an organization of pancreas tissue can be brought on by development of precancers and invasive cancers that are large. When analyzing changes with development of pancreatic cancer, decreases can occur to overall cell density, decreases can occur to ρlocal for many tissue subtypes, increases can occur in regions of acinar atrophy and ECM deposition, and complex 3D morphological phenomena can occur on cm-scale.

Referring to the illustrative example of the process 500 in FIG. 5B, thirteen samples of up to multi cm-scale containing normal, precancerous, and cancerous human pancreas can be reconstructed (520). Tissue volumes, cell counts, and cell densities can be calculated. For example, 4,114 total tissue sections can be analyzed to create multi-labeled 3D maps of thirteen resected pancreas tissue samples of volumes up to 3.5 cm³ and containing up to 1.6 billion cells. Eight of the samples assessed contained regions of grossly normal pancreatic parenchyma (sample P1-P4, P6-P9), nine contained pancreatic precursor lesions (sample P2-P10), and eight contained regions of invasive pancreatic cancer (sample P6-P13). Multi-scale renderings of the samples can be created to demonstrate the complex, curved architecture of the normal pancreatic ducts and periductal collagen, the surrounding acinar lobules, islets of Langerhans, fat, and blood vessels.

Heatmaps can be generated that represent volume percent of tissue subtypes per sample (left), normal regions of samples (center), and cancerous regions of samples (right) (522). Through quantification of tissue volume and cell count, compositional changes to the pancreas during tumorigenesis can be investigated. Volume and cell composition of tissue components in the samples can be compared, determining bulk composition as well as composition of the normal and invasive cancer regions (as samples P6-P9 contain both invasive cancer and normal adjacent tissue). Comparing to grossly normal pancreas regions, there may be substantial increases in collagen and decreases in acinar cells in precancerous and invasive cancer samples.

As shown in 524, bulk cell density can decrease >3-fold in cancerous human pancreas relative to grossly normal human pancreas.

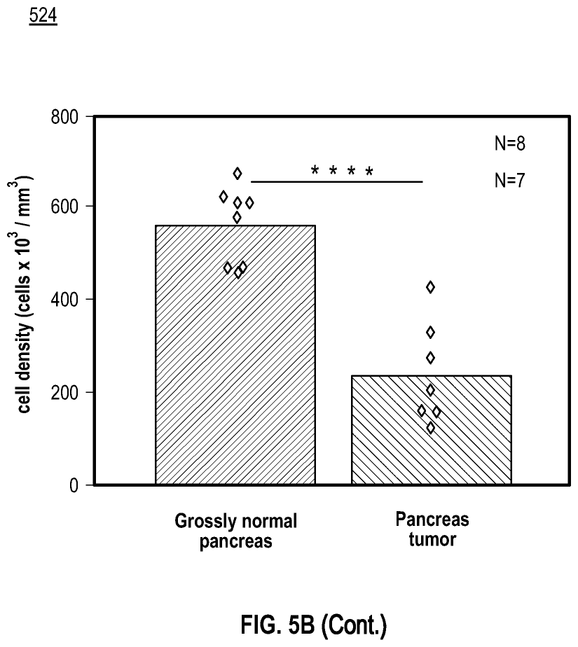

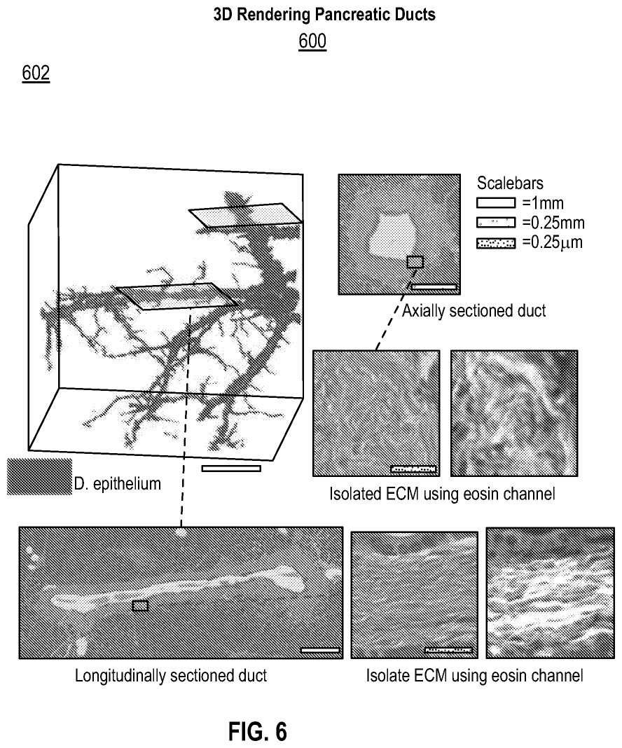

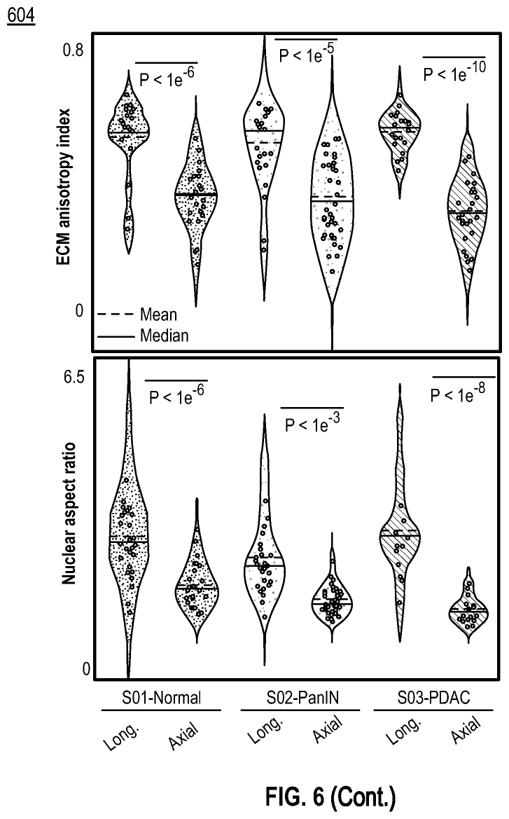

FIG. 6 depicts 3D rendering of pancreatic ducts 600. A layer of ECM that surrounds normal pancreatic ducts is called the ductal submucosa and can be clearly observed in 3D renderings of pancreatic ductal structure in the S01-Normal sample, using the techniques described herein (e.g., refer to 602). Analysis of the tissue composition of the immediate surroundings (within 50 μm) of the cancer of sample S04-PDAC can show that 85% of the surrounding tissue was ECM compared to 75% around PanIN and 65% around normal ductal epithelium (e.g., refer to 408 in FIG. 4). This calculation, along with identification of a 3 mm growth of cancer along the outside of a normal duct (e.g., refer to 406 in FIG. 4) can show that progression and invasion of PDAC is associated with the ECM.

Using the disclosed techniques, having observed growth of invasive pancreatic cancer parallel to non-neoplastic pancreatic ducts, apparent ECM alignment on histological sections in the ductal submucosa as a function of the orientation of the pancreatic duct in 3D can also be examined. By navigating the 3D renderings of the ductal epithelium in three samples (S01-Normal, S02-PanIN, and S04-PDAC), coordinates can be identified where the ductal submucosa was cut at two extremes: perpendicular to the long axis of the duct (axially-sectioned), or parallel to the long axis of the duct (longitudinally-sectioned). The identified 3D coordinates can be located on the original, serially-sectioned histology images, thereby collecting samples of a total of 18 ducts sectioned axially or longitudinally.

602 depicts 3D reconstruction of serially sectioned pancreatic ducts, which can allow for quantitative analysis of nuclear morphology and collagen alignment in context of the 3D organ. As an illustrative example, 18 histological sections, which intersect pancreatic ducts axially or longitudinally, can be located. These sections can consist of 9 axial ducts and 9 longitudinal ducts from 3 patient tissue samples. Nuclei and collagen fibers can be isolated using color deconvolution, as described throughout this disclosure.

Periductal fibroblasts in ducts sectioned longitudinally can be highly elongated in appearance compared to their round shape in axially-sectioned ducts, as shown in 602. Moreover, collagen fibers can be visibly more aligned and elongated in longitudinal cross-sections than in axial cross-sections.

604 depicts comparison of axially and longitudinally sectioned ducts to assess collagen alignment. ECM anisotrophy index, representing alignment of local collagen fibers, can be significantly higher in longitudinal ducts in all three patient tissue samples in FIG. 6. This can suggest that collagen is measurably straighter in longitudinally sectioned ducts. Nuclear aspect ratio can also be significantly higher in longitudinal ducts in all three patient samples, suggesting that stromal cells can be more elongated in longitudinally sectioned ducts.

Quantification of collagen fiber alignment and calculation of nuclear aspect ratio further can demonstrate a significant increase in ECM alignment and nuclear aspect ratio in longitudinally sectioned ducts (e.g., refer to 604). This finding was consistent across three tissue samples. Together, these results can demonstrate that the ductal submucosa is highly aligned, like layers of an onion, along the duct's axial direction. Additionally, the results can offer an explanation for the observed pattern of cancer growing parallel to pancreatic ducts. These results highlight importance of 3D analysis, as described herein.

Using the techniques disclosed in FIG. 6, 3D structural properties at regions of PDAC venous invasion, neural/perineural invasion, and invasion within the stroma can be analyzed to determine common patterns. Changes to collagen, nerve, and vasculature content between regions of normal and neoplastic tissue can be analyzed. In the normal pancreas, a sheath of collagen surrounds ducts. In precursor lesions, a thickening of this sheath can be observed. Similarly, increases in nerve content can be correlated with pancreatic precursor and cancer development and growth of microvasculature can be correlated to tumor growth and prognostic factors. Tissue composition can be calculated, as an illustrative example, in 180 μm surrounding normal epithelium, precancers, and invasive cancer cells to understand relative changes to collagen, nerve, and vascular content with tumorigenesis. Using the Wilcoxon rank sum test, the disclosed technology reveals significant increases in collagen and nerve content around precancers and invasive cancers relative to normal ductal epithelium, and slight but nonsignificant increases in vascular content.

Collagen comprises a majority of desmoplastic stroma in PDACs, and the alignment of collagen fibers in histological samples of PDAC can be negatively correlated with prognosis. As such, investigation into the role of collagen fiber alignment within the human pancreas is critical to understanding the mechanisms of cancer invasion. The disclosed technology can therefore be used to measure collagen alignment around normal ductal, vascular, and neural structures. 3D reconstructions can be used to assess alignment of collagen around normal ducts, blood vessels, and nerves and to assess the alignment of nerve fibers. 2D samples may not account for the angle of sectioning of the ducts. Therefore, using 3D renderings from the disclosed technology can readily and accurately lead to identification of coordinates where the ducts, blood vessels, and nerves may be cut at two extremes: perpendicular to the long axis of the structure (axially sectioned), and parallel to the long axis of the structure (longitudinally sectioned). Such regions can be isolated in H&E. Accordingly, measurements of periductal, perivascular, and perineural collagen alignment and neural fiber alignment can account for the varying appearance of fibers relative to their orientation to the sectioning blade, allowing more accurate calculation of fiber alignment than can be computed from the random plane in a 2D histological section.

For isolated regions around ducts, vasculature, and nerves, fiber alignment and nuclear aspect ratio can be calculated using the disclosed technology. Quantification can reveal significantly higher (using the Wilcoxon rank sum test) collagen and nerve fiber alignment and nuclear aspect ratio in longitudinally compared to axially sectioned structures. As an illustrative example, using 3D renderings from the disclosed technology, three coordinates of axial sectioning and three coordinates of longitudinal sectioning around pancreatic ductal epithelium, blood vessels, and nerves for seven samples containing large regions of normal pancreatic parenchyma can be identified (e.g., for 42 total images of ducts, nerves, and blood vessels each). 2D histological sections can be located using 3D coordinates of the identified regions. The disclosed technology can also provide for cropping the region of interest from the corresponding ×20 H&E images. Color deconvolution methods described herein can be applied to the cropped 20× H&E image to separate hematoxylin and eosin channels. Fiber alignment can be calculated within selected 2500 μm² windows in the eosin channel images using techniques described herein. By measuring fiber alignment within collagen or nerve regions in images of axial or longitudinal sectioning, the disclosed technology provides ways to compare the degree of collagen and nerve fiber alignment in axially and longitudinally sectioned regions of the ducts, blood vessels, and nerves. An alignment index of one, for example, represents completely aligned matrix of fibers and an alignment index of zero represents an isotropic matrix of fibers. The alignment index at two locations (or other threshold quantity of locations) of each cropped image can be calculated. Nuclear aspect ratio of cells within the peri-ductal/vascular/neural space can also be measured.

For nuclear aspect ratio, a 2.1-, 2.3- and 2.5-fold change can be measured between longitudinally and axially sectioned images for periductal, perivascular, and perineural collagen, respectively (all p values<10⁻⁵). For fiber alignment, a 2.5-, 2.4-, 2.2-, and 2.2-fold change can be measured between longitudinally and axially sectioned images for periductal collagen, perivascular collagen, perineural collagen, and nerve fibers, respectively (all p values<10⁻⁵). Contrary to 2D techniques, results from the disclosed technology suggest that collagen fibers are highly aligned along the longitudinal direction of ducts, blood vessels, and nerves. Combined with using the disclosed technology for identification of cancer extension along nerves, periductal and perivascular collagen, it can be identified that fiber alignment may play a key role in cancer invasion, allowing tendrils of cancer to protrude between parallel fibers far from the margins of the tumor.

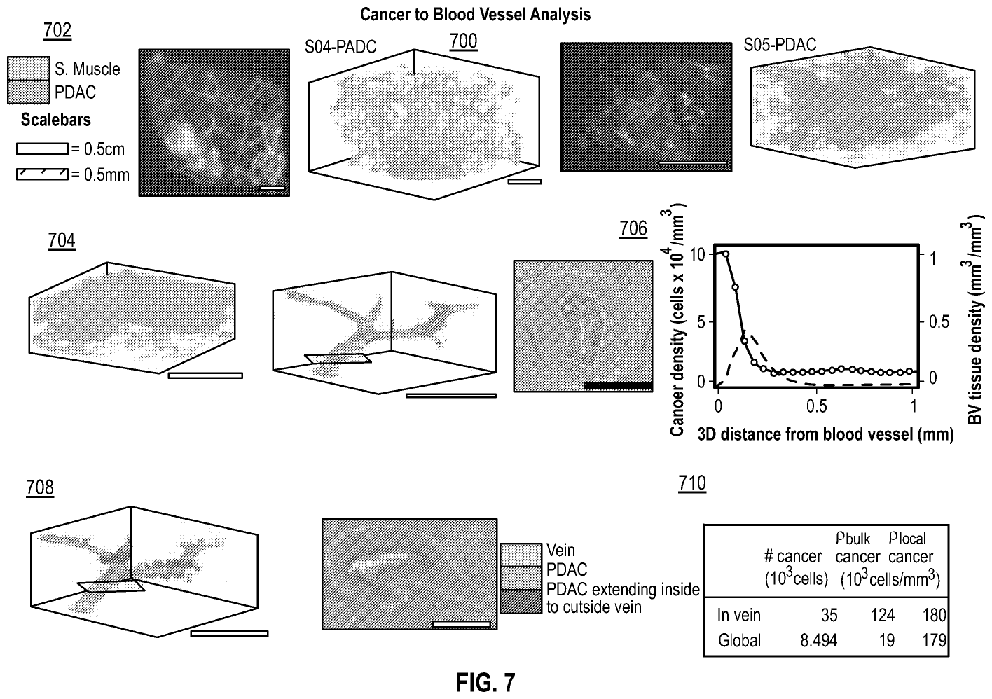

FIG. 7 depicts cancer to blood vessel analysis 700. The analysis 700, using the techniques described herein, can reveal inter-patient heterogeneity. A relationship between PDAC and smooth muscle can be compared between the S04-PDAC and S05-PDAC tissue samples in the illustrative example of FIG. 7. Cancer intravasation is a critical step in metastasis. A classical structural view of cancer intravasation is that cancer invades through basement membrane and ECM into vasculature. However, models of the mechanism and extent of pancreatic cancer intravasation can be hindered by their lack of quantification of large, 3D, in situ environments. The disclosed technology, on the other hand, provides for visualizing and quantifying cancer intravasation at the cm and single-cell scale in situ.

Using the disclosed techniques, PDAC can be analyzed in relation to vasculature. As an illustrative example depicted in FIG. 7, PDAC is associated with vasculature in two large samples comprising a leading edge of poorly differentiated pancreatic cancer (S04-PDAC) and a bulk tumor region of poorly differentiated pancreatic cancer (S05-PDAC) in situ (e.g., refer to 702). As shown in 702, z-projections and 3D reconstruction overlays of cancer and smooth muscle can be created using the disclosed techniques. Analysis of blood vessels in the S04-PDAC sample can show little spatial association with cancer, while a large region of venous invasion can be found in S05-PDAC.

In S04-PDAC, no clear patterns of cancer involvement can be detected with the vasculature, instead observing a large cancer mass with small blood vessels running throughout it, as shown in 704. Cancer intravisation may not be observed, and, due to the cancer's high density in the area around the blood vessels, apparent correlations between cancer growth and blood vessel orientation may not be observed. Thus, in 704, small blood vessels can be observed within the cancerous region of S04-PDAC, but no obvious alignment or invasion can be observed.

Conversely, in the example S05-PDAC sample, review of 2D sections by an expert pancreatic pathologist can reveal an area of venous invasion (e.g., refer to 706). In 706, venous invasion in sample S05-PDAC can be isolated, reconstructed, and quantified using the techniques described herein. Cancer bulk cell density can be high inside the lumen of the vein and can steeply drop off at the vessel wall and within the tissue outside the vessel. Reconstruction of this region in 3D can show that the PDAC both surrounds and fully occludes the vein for a length of over 1.5 mm, extending out of view off both z-boundaries of the tissue sample. Density of cancer cells can be quantified as a function of distance from a center of the vein. Accordingly, cancer ρ_{bulk} within the lumen of the vessel can be 6.5× the average global cancer cell density. High-resolution H&E images can show small clusters of PDAC cells distributed homogeneously within the tunica media of the vessel.

In 708, separate instances of PDAC can be found breaching the wall of the vein, thereby suggesting that intravasation and extravasation may not be single-instance events. Cancer can be detected to be breaching the vein in the volume and verified at 9 instances on histological sections.

In 710, bulk and local cancer cell density ca be quantified within the vein and within the entire tissue. Bulk cell density can be cancer cell count normalized by an entire volume of the vein lumen, while local cell density can be cancer cell count normalized by cancer cell volume within the lumen. Bulk cell density can be found to be 6.5× greater inside the vessel than the global tissue, while local cell densities inside and outside the vessel can be similar. This can suggest that cancer cells are in closer proximity to one another inside the vessel, but that they occupy a similar volume inside and outside the vessel. As shown in 710, 35,000 cancer cells can grow within the 1.5 mm long region of the vein. While cancer ρ_{bulk} inside the vein can be much higher than cancer ρ_{bulk} averaged over the entire tissue, cancer cell ρ_{local} can remain constant—here, cell density can be number of cancer cells normalized by total tissue volume. Cancer ρ_{local} can be number of cancer cells normalized by cancer cell volume. Therefore, even though cancer cells can be in closer proximity to each other inside the vein than they are in the bulk of the tissue (cell density), the cells can individually take up the same amount of volume both inside and outside the vein (cell ρ_{local}). For example, the higher density of cancer cells inside the blood vessel does not force them to pack more tightly than they would outside the blood vessel. This finding highlights the importance of investigating vascular invasion in 3D, as only by comparing bulk cancer cell density to local cancer cell density over large volumes can be used to note changes to cancer cell organization in the tissue region.

FIG. 8 depicts a process 800 for histological image registration. As described throughout this disclosure, the process 800 can be performed by the computing system 102. The process 800 can also be performed by one or more other computing systems, servers, and/or devices, as described herein. For illustrative purposes, the process 800 is described from the perspective of a computing system.

Referring to the process 800, tissue cases can be registered with reference at a center z-height of sample in 802. Example fixed and reference images are depicted and overlaid. Next, in 804, global registration can be performed with rotational reference at a center of the fixed image. Fixed and reference images can be smoothed by conversion to greyscale, removal of non-tissue objects in the image, intensity complementing, and Gaussian filtering to reduce pixel-level noise in images. Radon transforms can also calculate filtered fixed and moving for discreet degrees 0-360. A maximum of 2D cross correlation of radon transforms can yield a registration angle. A maximum of 2D cross correlation of filtered images can yield a registration translation. 804 depicts an example global registered overlay.

In 806, the computing system can perform local registration at discrete interviews across the fixed image. For each reference point, tiles can be cropped from fixed and moving images and coarse registration can be performed on the tiles. Results from all the tiles can be interpolated on 2D grids to create nonlinear whole image displacement fields. Overlay of fixed image and displacement grid can exemplify nonlinear registration results. 806 depicts an example local registered overlay.

FIG. 9 depicts validation of cell count and 2D to 3D cell count extrapolation 900. 902 depicts a sample histological section and corresponding color deconvolved outputs that represent hematoxylin and eosin channels of an image. For 4 mm² tiles, cells can be manually and automatically counted for validation of cell counting techniques described herein. 94% overlap can be achieved between manual and automatic 2D cell counts.

904 depicts cell diameters of each tissue subtype that can be measured. 2D cell counts can be extrapolated to 3D using a formula depicted in 904. Cells can be detected by the disclosed formula if any part of a nucleus touches a tissue section. Therefore, effective tissue section thickness can equal true tissue section thickness plus diameter of the cell. 3D cell counts can be estimated by multiplying 2D cell counts by the true thickness of the tissue section, multiplied by 3 since 2 sections were skipped during scanning, divided by effective thickness of the section.

FIG. 10 depicts a process of semantic segmentation 1000. As described throughout this disclosure, the process 1000 can be performed by the computing system 102. The process 1000 can also be performed by one or more other computing systems, servers, and/or devices, as described herein. For illustrative purposes, the process 1000 is described from the perspective of a computing system.

In an illustrative example, for each patient case, a minimum of 7 images can be extracted for manual annotation (1002). For each extracted image, a minimum of 50 examples of each tissue type can be annotated, and the annotations cropped from a larger image.

To construct training and validation sets, cropped annotations can be overlaid on a large image until the image is >65% full and such that the number of annotations of each type can be roughly equal (1004).

These large tiles can then be cut into smaller tiles for training and validation (1006). Additional tiles can be created for a testing set where the annotation may not be cropped from the image. Testing accuracy can be assessed as the percentage of the annotated area of the tile classified correctly. Following model training, serial images can be cropped into tiles and semantically segmented, as described throughout this disclosure (e.g., refer to FIG. 1A).

For example, all tissues that were annotated from a histological image can be selected. In some implementations, only some instances of each tissue subtype can be annotated in the histological image rather than annotating all instances of each tissue subtype. This technique can reduce an amount of time, labor, and/or computational resources needed for annotation because the disclosed technique can avoid complex manual annotation processes in which many samples of each tissue subtype is annotated. A color model mask can be applied to the selected tissues to show the annotations. The annotations can then be extracted from the histological image and concatenated into a second image until the second image is a full picture of the tissues in the histological image. Tiles depicting the annotations can be fed into a model, which can be trained to receive the tiles and use those tiles to generate the second image. Therefore, the model can be trained to identify the tissue samples annotated in each of the tiles across many different tissue samples. The tiles depicting the annotations can continue to be added to the second image until an equal amount of each tissue subtype is represented in the second image. As an illustrative example, the different tiles can continue to be added to the second image until the second image has approximately 12% of each of the following tissue subtypes: Islet, D. Epithelium, S. Muscle, Fat, Acini, ECM, Nontissue, and Precursor.

FIGS. 11A-B depict deep learning accuracy matrices for different tissue cases described throughout this disclosure. Referring to FIG. 11A, confusion matrices 1100 as depicted herein can display predicted versus true outcomes for all deep learning classes. Precision per class can be depicted in a row beneath matrices and recall per class can be depicted in a column to the right of each matrix, both in units of percentage. Thus, in FIG. 11A, matrix 1102 depicts results for S01-Normal tissue cases. Matrix 1104 depicts results for S02-PanIN tissue cases. Matrix 1106 depicts results for S03-IPMN tissue cases. Matrix 1108 depicts results for 504-PDAC tissue cases. Matrix 1110 depicts results for S05-PDAC tissue cases.

Referring to FIG. 11B, 1120 depicts sample predicted versus true outcomes for deep learning models for a sample P1 (left matrix) and P8 (right matrix). 1122 illustrates a workflow for creation of multi-patient semantic segmentation of nerves. In this example, nerve annotations are collected from thirteen pancreas samples. Original tissue annotations can be reformatted to: 1. smooth muscle, 2. collagen, 3. other tissue (islets, normal ducts, acini, precursor, lymph, PDAC), 4. white (whitespace, fat). Nerve annotations can also be combined with original annotations to create a dataset for nerve recognition in H&E images. 1124 shows predicted versus true outcomes for a multi-patient nerve detection model. 1126 shows an average for a particular sample and per class testing accuracy as a function of percent of training annotations used.

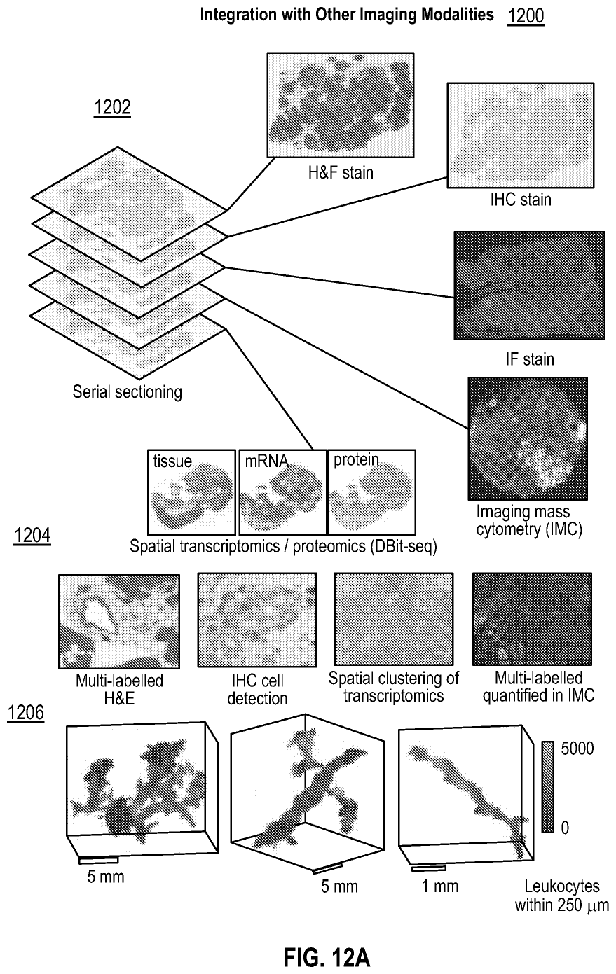

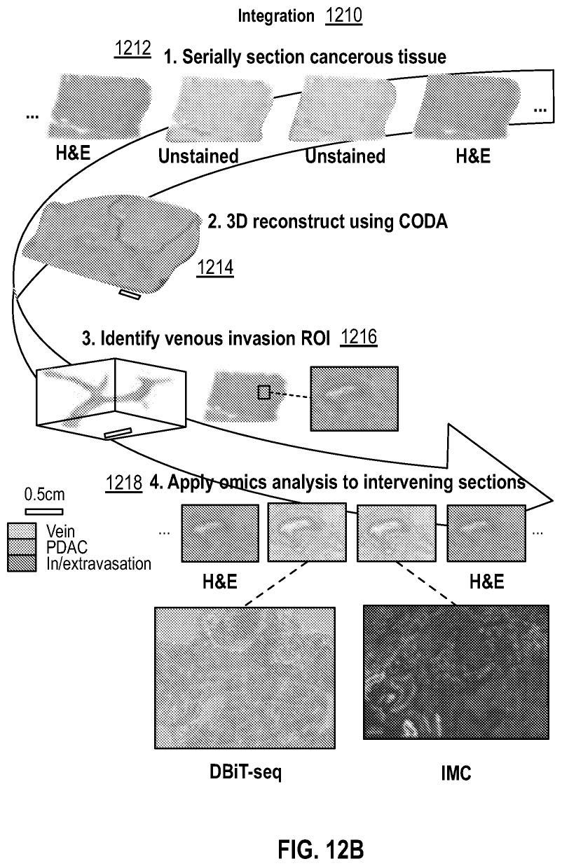

FIG. 12A depicts integration of the disclosed technology with one or more additional imaging modalities 1200. 1202 depicts serially sectioned images that can be reconstructed using the disclosed techniques with integration of (1) H&E, (2) immunocytochemistry (HC), (3) immunofluorescence (IF), (4) imaging mass cytometry (IMC), and spatial transcriptomics/proteomics. Thus, in addition to creating cm³ quantifiable volumes of serially sectioned tissue using H&E stained sections, the disclosed technology allows integration of IHC stained sections, IF stained sections, IMC, and spatial transcriptomics. 1204 depicts 3D reconstruction of ducts at single-cell registration, and a sample H&E whole slide image. 1206 depicts Multi-modal 3D reconstructions, such as immune cell heatmaps of pancreatic cancer precursor lesions. Multi-modal 3D reconstructions can be achieved by integrating the disclosed technology with these imaging techniques.

FIG. 12B depicts integration 1210 of the disclosed technology with IHC, IMC, and spatial transcriptomics. The disclosed technology and integration provides for discovery through integration of quantifiable tissue architecture and cell, genetic, and protein bodies. Such features may not be distinguishable by the trained eye through H&E, but can be labelled and visualized through IHC, IMC, and/or spatial transcriptomics. During the integration 1210 process, serial sectioned PDAC tissue can be stained H&E every third slide (1212). The tissue can then be reconstructed using the techniques described herein (1214). A region of interest (ROI) containing venous invasion can be isolated and tracked on all serial sections in 1216. Unstained intervening sections can be utilized for spatial transcriptomics/proteomics and IMC in 1218. For example, omics analysis can be applied to intervening sections. In some implementations, the disclosed technology can also be integrated with DBiT-seq for a more complete 3D reconstruction of cancer venous invasion events.

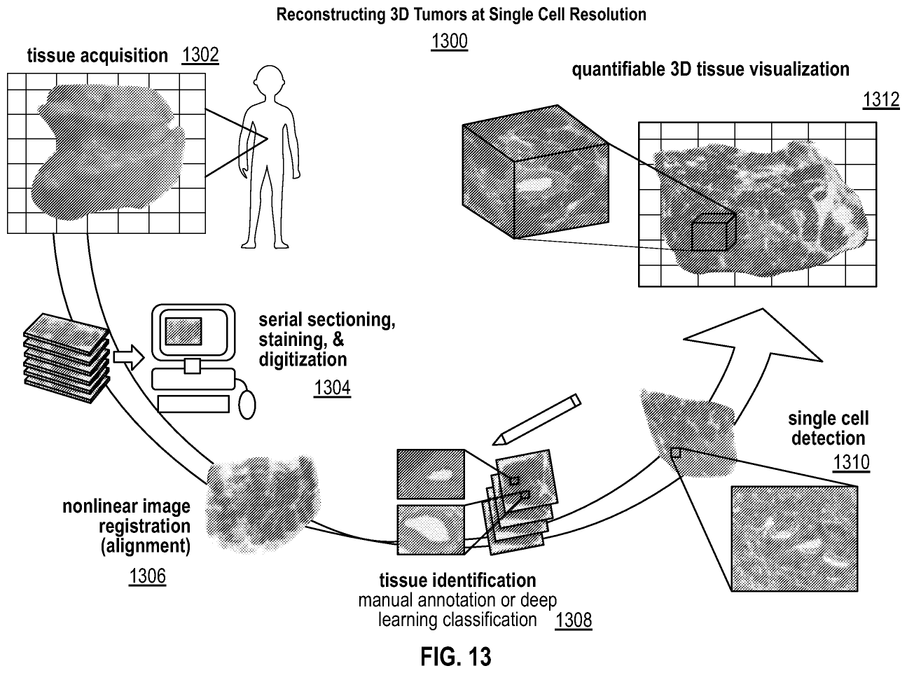

FIG. 13 depicts a process 1300 to reconstruct 3D tumors at single-cell resolution. Briefly, tissue is sectioned, formalin-fixed and paraffin-embedded (FFPE), stained H&E, digitized, and serial images are registered to create a digital tissue volume. Cells can then be detected using the hematoxylin channel of the images, and deep learning can be applied to label distinct tissue structures using H&E staining alone. As described throughout this disclosure, the process 1300 can be performed by the computing system 102. The process 1300 can also be performed by one or more other computing systems, servers, and/or devices, as described herein. For illustrative purposes, the process 1300 is described from the perspective of a computing system.

Referring to the process 1300, the disclosed techniques use computational techniques to reconstruct digital tissues using serially sectioned tissue. A multi cm³ sample of a human pancreatic or breast tumor can be serially cut in 1302. The resulting sections can be fixed, stained using H&E, and scanned (1304). High-resolution images of H&E slides can be globally and iteratively locally registered in 1306. As described throughout, nonlinear image registration can be performed for alignment purposes. A trained deep learning (DL) semantic segmentation model can be used to automatically annotate hundreds to thousands of sections in 1308. In 1308, the computing system can perform tissue identification. Annotations can be manual and/or deep learning classification. Nuclei of individual cells can also be detected via deconvolution of the H and E channels in 1310. A 3D digital volume of the original tumor can thus be reconstructed for further analysis (1312).

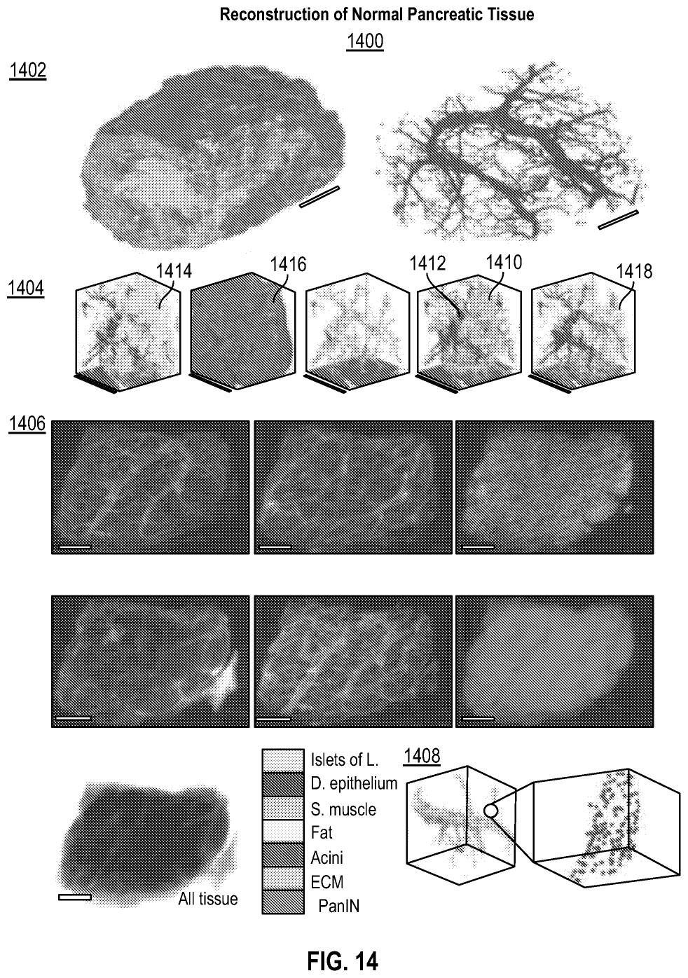

FIG. 14 depicts 3D reconstruction 1400 of normal pancreatic tissue using the disclosed techniques. Using the disclosed techniques, tissue can be reconstructed with digital, labelled tissue volumes of cm³ scale and single cell resolution. The illustrative example of 1400 depicts reconstruction and modelling of 1.7 cm³ volume of normal human pancreas. Tissues can be visualized at gross-sample scale, mm-scale, or at single cell resolution.

In the example 1400, multi-labelled registered H&E serial sections are reconstructed (1402). H&E and all labels can be visualized, as shown in 1402. Subregions 1404 show 3D reconstruction of smooth muscle (1410), normal ductal epithelium (1412), fat (1414), acini (1416), ECM, and islets of Langerhans (1418). Length scales covered by the disclosed technology can range from multi cm scale down to the micron scale. In 1406, z-projections of labelled tissues can reveal pancreatic tissue architecture and scale of samples. 3D reconstruction of ducts at single-cell resolution and zooming in 1408 showing centroids of individual ductal epithelial cells. In this illustrative example 1400, lateral and axial resolutions of this approach is ˜1 and 4 μm, respectively, while the resolution of CT/MR imaging is 500 μm. One or more other resolutions can also be realized and/or utilized.

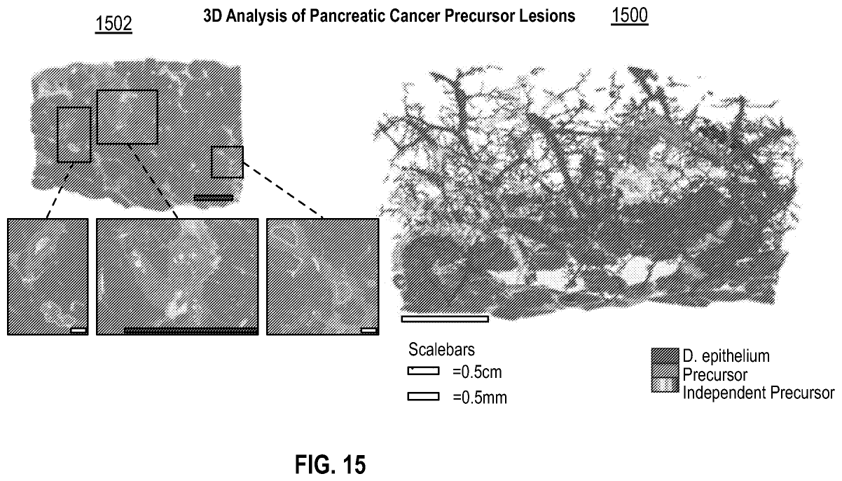

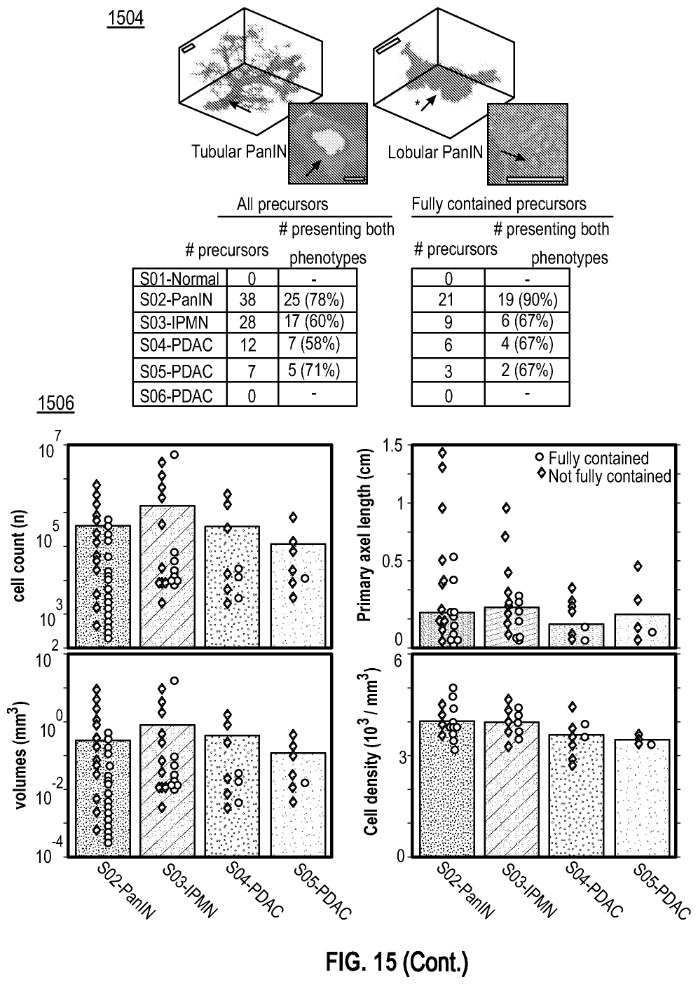

FIG. 15 depicts 3D analysis 1500 of pancreatic cancer precursor lesions using the disclosed techniques. By assessing gross and local changes to pancreas architecture in normal, precancerous, and cancerous volumes, the techniques described herein can be used to model microanatomical human tissue architecture.

In the illustrative analysis 1500, precancer labelling in six large samples containing PanIN can provide for assessment of PanIN architecture, density, and cellularity in human tissue. In an example sample of 2.3 cm³, 38 spatially independent PanIN can be detected within complex pancreatic ductal architecture. Using the disclosed technology, 3D phenotypes of PanIN can be identified, where their development within pancreatic ducts or acinar lobules can dictate their 3D architecture, as depicted in FIG. 15. By assessing PanIN cell count, volume, and cell density, it can be demonstrated that across samples, pancreatic precancers display wide variation in cell number and size, but similar cell densities of ˜40,000 cells/mm³.

Referring to the analysis 1500, 38 spatially independent PanIN in sample S02-PanIN can be color coded and labelled on H&E serial sections and a 3D reconstruction, as shown in 1502. In single 2D histological sections, it can be challenging to discern how long or highly-branched a precursor is, or whether two precursors that appear separate on a 2D section connect in 3D. Precursors can occupy a range of volumes, can be simple or highly branched, and may be densely packed yet unconnected in 3D. As an illustrative example, using the 3D reconstruction techniques described herein of the ductal system of a sample, 43 spatially independent pre-cancers can be identified in a 2.3 cm³ sample. In one section, a large precursor can be identified in multiple ducts separated by nearly 1 cm and surrounded by multiple, smaller precursors exemplifying how connectivity can be difficult to interpret from 2D alone. In nine samples containing precursors, number of distinct precursors per section with and without considering 3D connectivity can be compared to identify that sometimes, 2D lesion numbers may over-count the true 3D tumor number per section by as much as a factor of 40, exemplifying the complex 3D connectivity of pancreatic precancers. This measurement can yield an average 12.3-fold overcounting in 2D versus 3D with a p-value of <10⁵ using a Wilcoxon rank sum test or other similar technique.

In 1504, 3D renderings and sample histology illustrate two 3D phenotypes of PanIN that can be observed in the illustrative example. Tubular PanIN can preserve normal pancreatic ductal morphology, while lobular PanIN can resemble acinar lobules. Precursors in all samples can be identified. In some implementations, additional distinct 3D structural phenotypes can be identified while assessing 3D connectivity of the precursors, such as tubular, lobular, and dilated precancers. Tubular precancers can appear as ductal, branching structures, dilated precancers can appear as large ballooning of the duct connected to ducts of much smaller diameters, and lobular precancers can appear as “bunches of grape-like,” connected locules forming a nodule. Review of the corresponding H&E sections can reveal that tubular PanINs may reside within pancreatic ducts, dilated PanINs may reside within regions of dilated pancreatic ducts, and lobular PanINs may reside at the terminal junctions of ducts and acinar lobules, involving areas of acinar to ductal metaplasia (ADM). These phenotypes can appear similar to pancreatic precancer phenotypes identified in mice. As an illustrative example, 174 of 265 identified precursors (66%) can contain both ductal and lobular morphology, suggesting that extension of precursors between dilated/nondilated pancreatic ducts and acinar lobules can be a relatively common occurrence. Moreover, 3D models that are generated using the disclosed technology can reveal a large region of acinar atrophy in some tissue samples. Using an annotation pipeline, registered, serial H&E images can be rapidly displayed and manually annotated. In each image, the boundaries of the atrophic lobule and a nearby normal lobule can be segmented. These regions can then be 3D reconstructed and tissue compositions can be calculated using the disclosed technology to provide further insight into normal and atrophic pancreatic lobules in different types of tissue samples.

In 1506, cell number, primary axis length, volume, and cell density for each precursor can be determined. For example, the morphology and cellularity can be calculated per precursor. Large variation in cell number, volume, and primary axis length can be identified, but roughly similar cell density of around 40,000 cells/mm³ per precursor may be identified using the disclosed technology. For example, although PanINs may be defined in 2D as <0.5 cm, when viewed in 3D, fifteen PanIN can be found in eight samples containing primary axis lengths greater than 0.5 cm, thereby suggesting that PanIN can grow to extreme lengths along narrow (<0.5 cm) ducts. Of those fifteen, five PanIN found in three samples may contain primary axis lengths>1 cm, placing them technically within a definition of IPMNs. By creating virtual histological sections of one precursor along its narrow and long axes, the disclosed technology demonstrates that these large precursors may be sectioned such as to meet the definition of either IPMN or PanIN, indicating that use of 2D ductal diameter as a clinical criterion to classify precursor lesions may be insufficient.

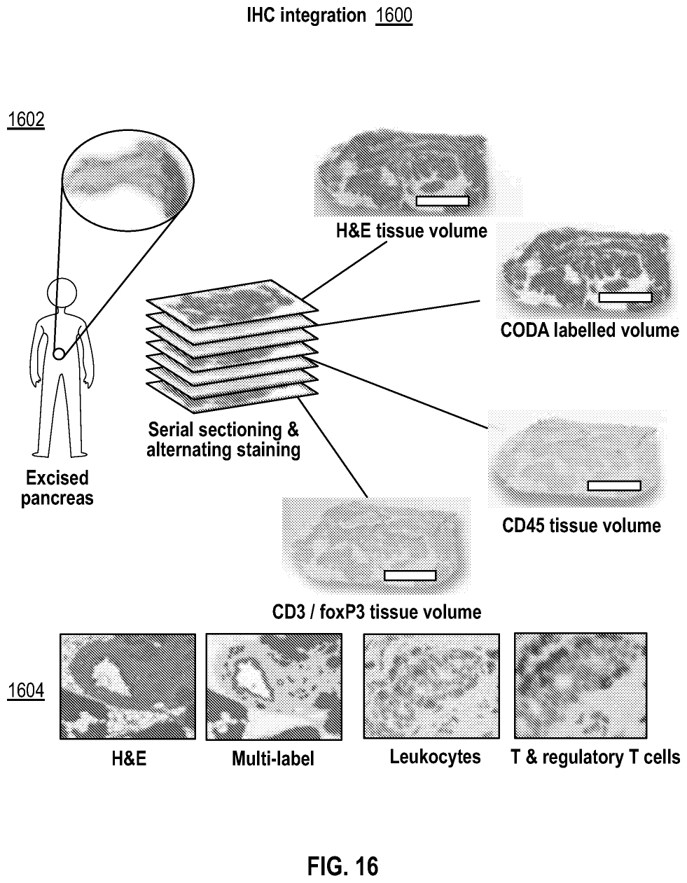

FIG. 16 depicts integration 1600 of the disclosed technology with IHC. As an illustrative example of the integration 1600, a human pancreas sample can be serially sectioned and stained alternately in 1602. The stains can be with H&E, CD45 for leukocytes, and dual-stained CD3 for T-cells and foxP3 for regulatory T-cells (1604) 8 pancreatic tissue types can be labeled using deep learning, as described herein, on the H&E sections. 3 immune cell types can also be labeled by counting positive cells on intervening IHC. In other words, in 1602, human pancreatic tissue can be formalin fixed, paraffin embedded, serially-sectioned, stained, and scanned according to the alternating scheme (1) H&E, (2) CD45, (3) CD3/FoxP3, repeat. Deep learning semantic segmentation can be applied to allow for tissue labelling in H&E tissue (1604). Deep learning semantic segmentation can also be applied such that IHC staining provides for detection of leukocytes, T cells, and regulatory T cells (1604).

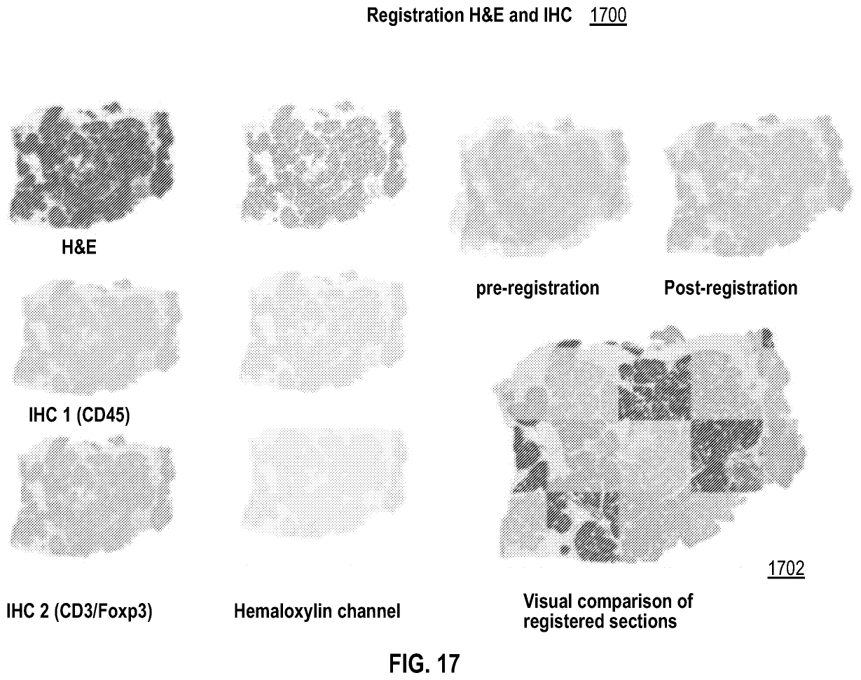

FIG. 17 depicts registration 1700 of H&E and IHC using the disclosed techniques. Registration 1700 can be used as a continuation of the integration 1600 described in reference to FIG. 16. Registering hematoxylin channels can be advantageous to create a digital tissue volume. Distinct H&E and IHC tissue images can be aligned into a registered tissue volume. Due to the varying color appearance between the images, only the hematoxylin channel of the images can be used for registration. As hematoxylin stains basophilic components of tissue such as nuclei, the hematoxylin channel of serial H&E and IHC images can appear similar. The hematoxylin channels can be isolated using color deconvolution, separating hematoxylin from eosin in the H&E and hematoxylin from the antibody channels in IHC.

Thus, the registration 1700 techniques described herein can align serial images in two steps. Global registration can be used to grossly align samples using correlation of filtered image intensity. Local nonlinear registration accounted for tissue splitting and folding by creating a local displacement field defining the warping of samples. Registration deformation maps calculated on the hematoxylin channels can be applied to color images, thereby creating a mosaic image 1702 to visualize the quality of the registration.

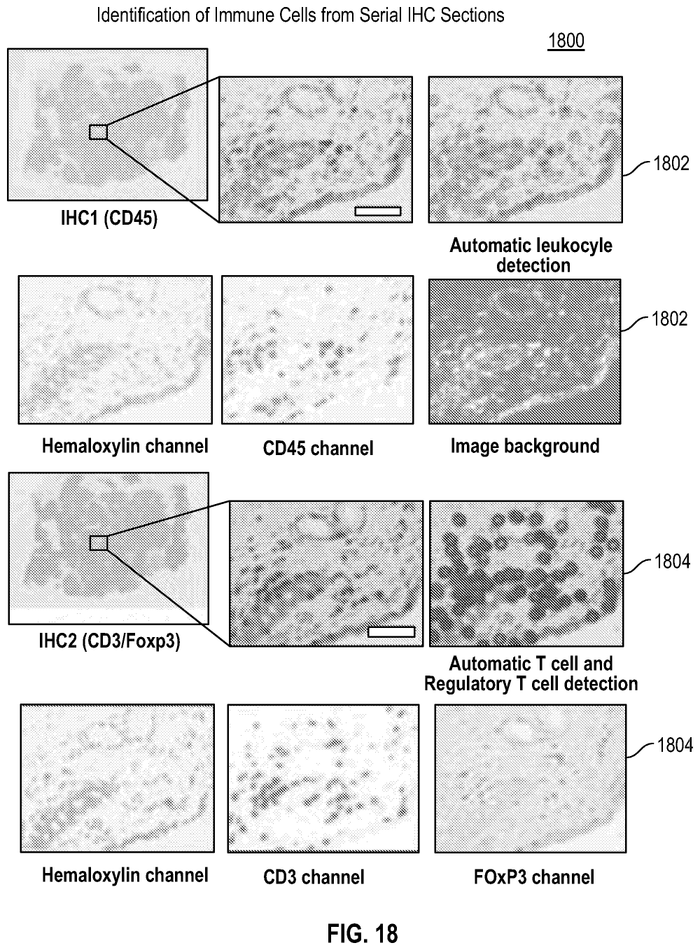

FIG. 18 depicts identification 1800 of immune cells from serial IHC sections. Identification 1800 can be used as a continuation of the integration 1600 and the registration 1700 described in FIGS. 16-17. Following the registration 1700, positive CD45, CD3, and foxP3 cells can be quantified using antibody channels of the IHC images that were isolated during color deconvolution described in reference to FIG. 16. The antibody channels can be smoothed, and coordinates containing both positive antibody stain and positive hematoxylin stain (indicating a cell nucleus) can be tracked. For the dual-stained images, T-cells can be identified as coordinates containing both hematoxylin and CD3 positivity, and regulatory T-cells (a subset of T-cells) can be identified as coordinates containing hematoxylin, CD3, and foxP3 positivity. Thus, leukocytes can be identified in the CD45 stained sections by quantifying hematoxylin and CD45 channel positivity (1802). T-cells can be identified in the CD3/foxP3 stained sections by quantifying hematoxylin and CD3 channel positivity (1804). Regulatory T-cells can be identified as T-cells containing foxP3 positivity.

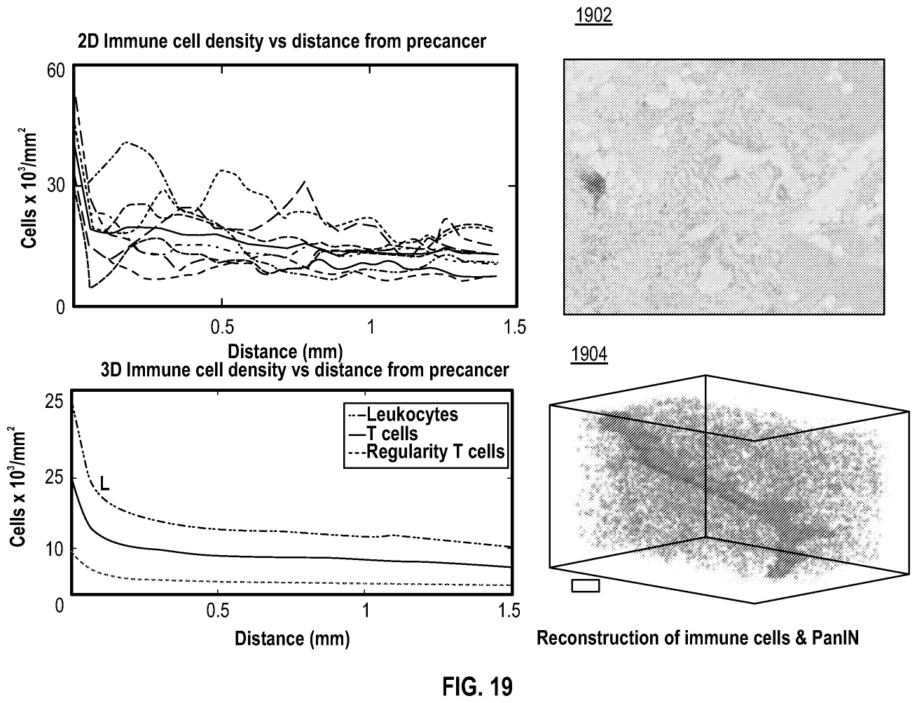

FIG. 19 depicts 2D and 3D radial immune cell density around a pancreatic precursor lesion. Integration of labelled H&E sections using the disclosed technology and immune cell coordinates identified and registered on intervening IHC sections can provide for quantification of the immune environment around pancreas tissue structures in 3D. To emphasize the heterogeneity of inflammation around pancreatic precancerous lesions, 2D radial leukocyte density can be calculated around a PanIN on different sections and 3D radial leukocyte density around the same PanIN. 2D inflammation quantification, as shown in graph 1902, can reveal differing inflammatory profiles around the same tumor on different sections. The 2D immune cell profile around PanIN on eight sections and mean profile emphasizes the heterogeneous inflammation in precancerous lesions. Some sections are highly inflamed and some show less inflammation. 3D inflammation quantification, as shown in graph 1904, can reveal a more homogenous profile that does not capture the varying local inflammation profile in the sample. 3D immune cell profiles around the same precursor lesion can also display homogeneous inflammation that does not capture local inflammatory regions.

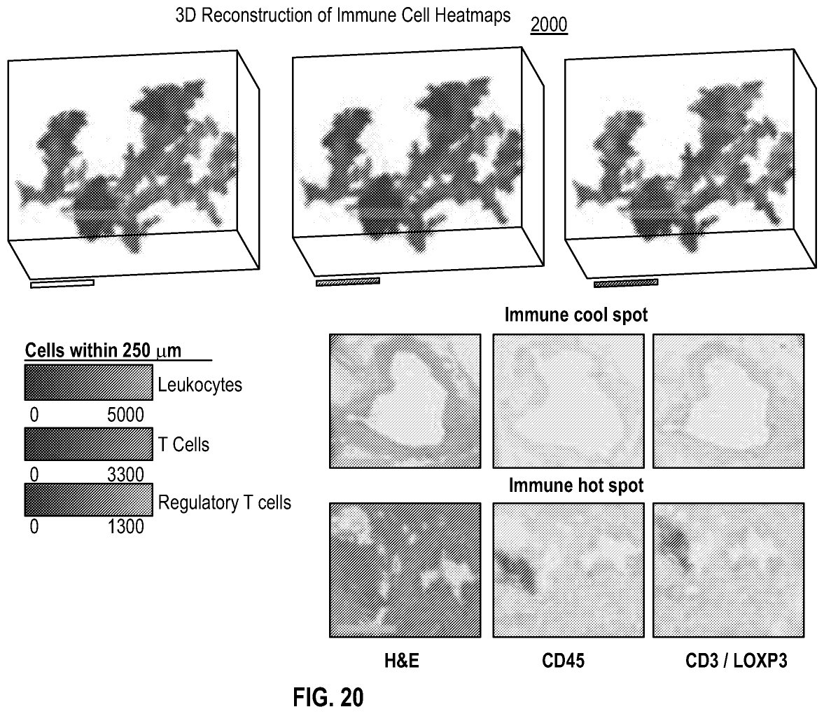

FIG. 20 depicts 3D reconstruction of immune cell heatmaps. To emphasize inflammatory heterogeneity in pancreas precancerous lesions, immune cell heatmaps can be generated, which can reveal spatial relationships between regions of high inflammation and low inflammation in samples of pancreatic tissue. PanIN identified using the disclosed techniques and H&E can be 3D reconstructed, and local inflammation can be calculated as immune cell count within 250 microns of local regions on the surface of the tumors. Analysis of immune heatmaps can display highly varying immune cell profiles of up to 5,000% increased inflammation at different locations on the PanIN. Immune ‘hot spots’ and ‘cool spots’ can also be identified and extracted in corresponding histology. Thus, the disclosed techniques in combination with IHC can provide for quantifiable reconstruction of local regions of leukocyte, T-cell, and regulatory T-cell inflammation on the surface of pancreatic tumors. Local ‘hot spots’ and ‘cool spots’ can be identified on the heatmaps and extracted from the H&E and IHC sections.

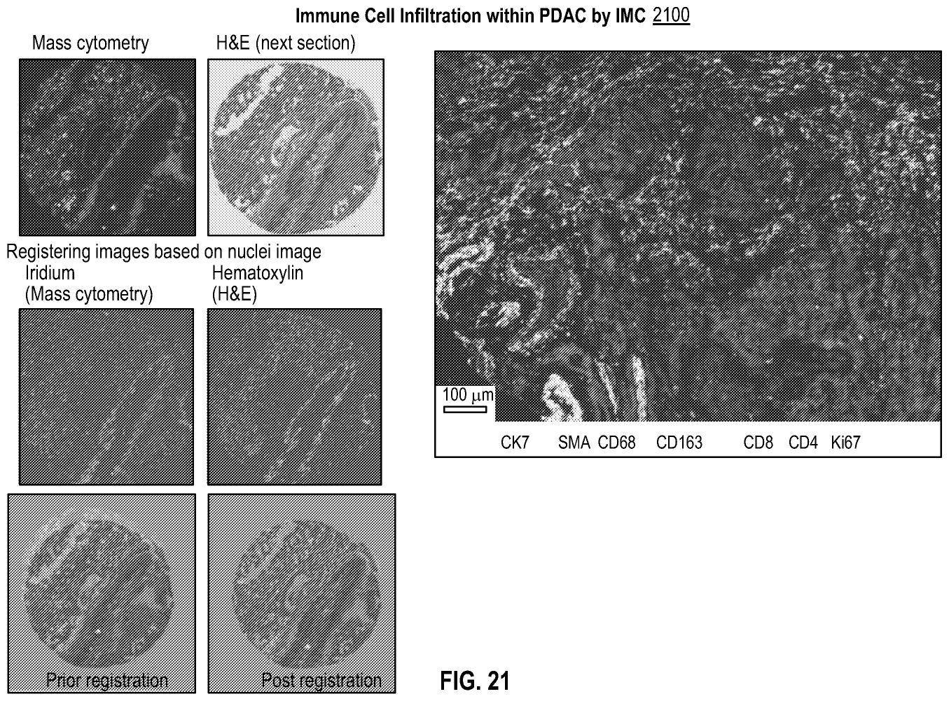

FIG. 21 depicts visualization of immune cell infiltration within PDAC by IMC. In some implementations, the disclosed techniques can be integrated with imaging mass cytometry (IMC). This integration can include using intervening slides to perform multiplexed IMC, which can expand a number of cells identifiable in 3D tissues and tumors. For in-depth spatial analysis of the tumor microenvironment, 30-40 marker data at subcellular resolution (1 μm² per pixel) based on antibodies conjugated to heavy metals can be used.

TABLE 2
Custom IMC antibody panel for PDAC tumor microenvironment
profiling. All markers can be imaged simultaneously.

| Architecture | Myeloid | Lymphoid | Functional |
|---|---|---|---|
| CD45 | CD14 | CD3 | PDL1 |
| PM 1, 2, 3 | CD15 | CD4 | PD1 |
| Pan-CK | CD16 | CD8 | LAG3 |
| Collagen | CD163 | FOXP3 | KI67 |
| SMA | CD68 | CD56 | ARG1 |
| VIM | CD33 | CD45RO | HLADR |
| Podoplanin | CD138 | CD45RA | GZMB |
| Ecadherin | CD21 | CD20 | CL_CASP3 |

As shown in table 3, over 30 markers can be used and selected as key markers that delineate tissue architecture as well as a set of canonical markers for determining major immune cell types and their functional states. IMC technology can detect up to 135 individual channels. This requires both availability of isotopically enriched metals for all channels and appropriate conjugation chemistry for each of the metals. Accordingly, depicted in FIG. 21 is registration of two successive H&E and IMC sections of a PDAC. The pancreatic cancer microenvironment can also be characterized using IMC. In FIG. 21, 7 example immune markers are shown for illustrative purposes: CK7, SMA, CD68, CD163, CD8, CD4, and KI67.

Image acquisition can be performed using Hyperion and segmented into single-cell datasets. For image segmentation, images highlighting the nuclei (based on Ir191 and Ir193) and cytoplasmic boundaries (based on a combination of plasma membrane markers) can be generated and exported. Cell event probability maps based on the nuclei can be created by applying pixel classification onto all of the images. To identify primary and secondary objects, resulting objects can be converted to single-cell masks in uint16 format. Overlaying the single-cell masks onto the cores can allow for extraction of per-cell spatial parameters and signal intensities of the cell markers. To improve the signal-to-noise ratio, all images for every channel can be processed prior to single-cell data extraction. Finally, to remove artifacts related to antibody aggregates, cell events can be gated using a biaxial plot for Histone H3 vs. Ir191 intensities.

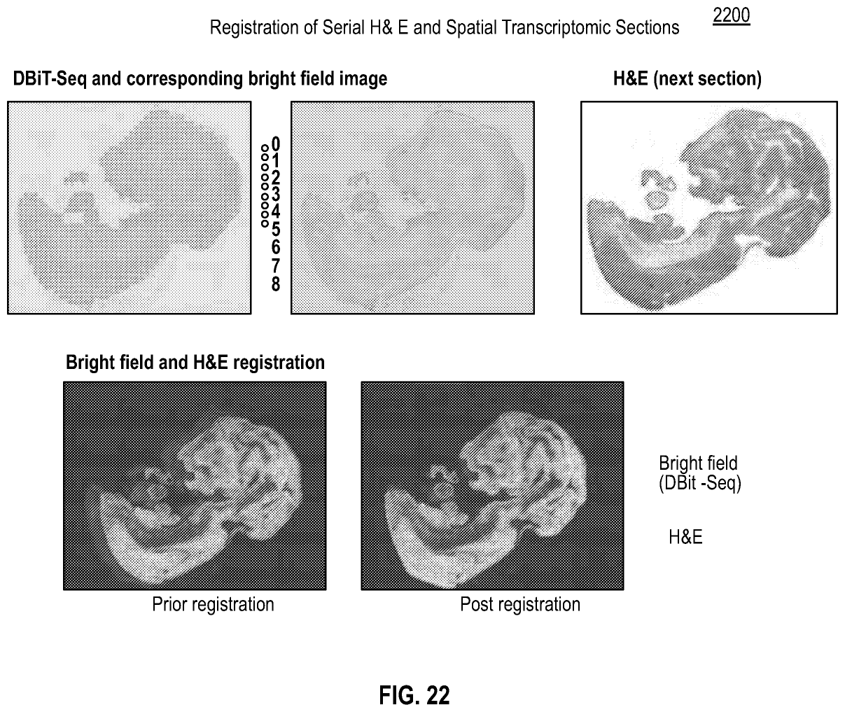

FIG. 22 depicts registration of serial H&E and spatial transcriptomic sections using the techniques described herein. In some implementations, the disclosed techniques can be integrated with spatial transcriptomics. This integration can provide for spatial mapping of large tissue structures that are identifiable in H&E, such as blood vessels, collagen, cancer, and normal epithelial structures. Hence, by examining location cancer in blood vessels, the disclosed technology can be used to identify veins that may have invaded with cancer cells, as well as the points of entry/exit (intravasation/extravasation) along these veins. With the addition of spatial transcriptomics, the disclosed technology can provide for deriving genome-wide transcriptomics profiles with close to single cell resolution (10 mm) along this cancer vascular invasion and intravasation/extravasation events. Furthermore, spatial transcriptomic techniques can simultaneously output expression level of 200+ proteins. FIG. 22 depicts integrated images that are collected using spatial transcriptomics and serial H&E sections. More particularly, FIG. 22 depicts local and global registration of two successive mouse embryo tissue sections, one stained with H&E and one imaged for spatial transcriptomics. The gray scale image converted from H&E can be obtained and used to register H&E and transcriptomic successive sections.

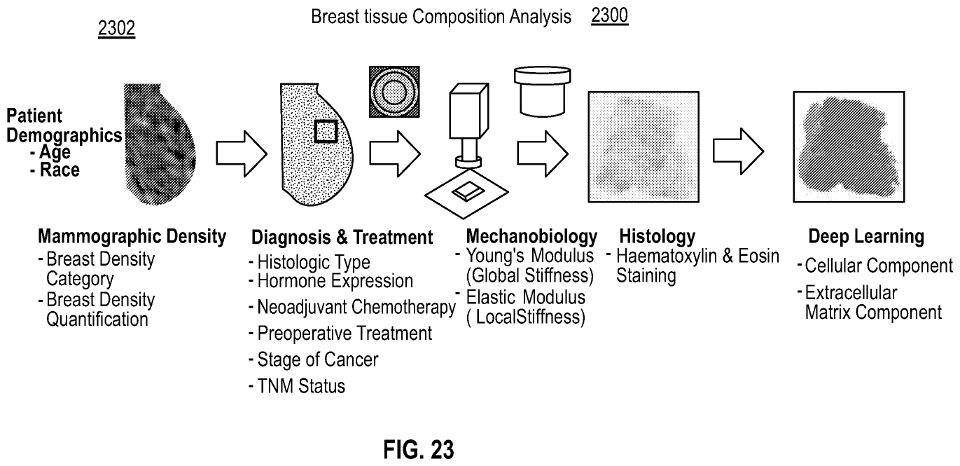

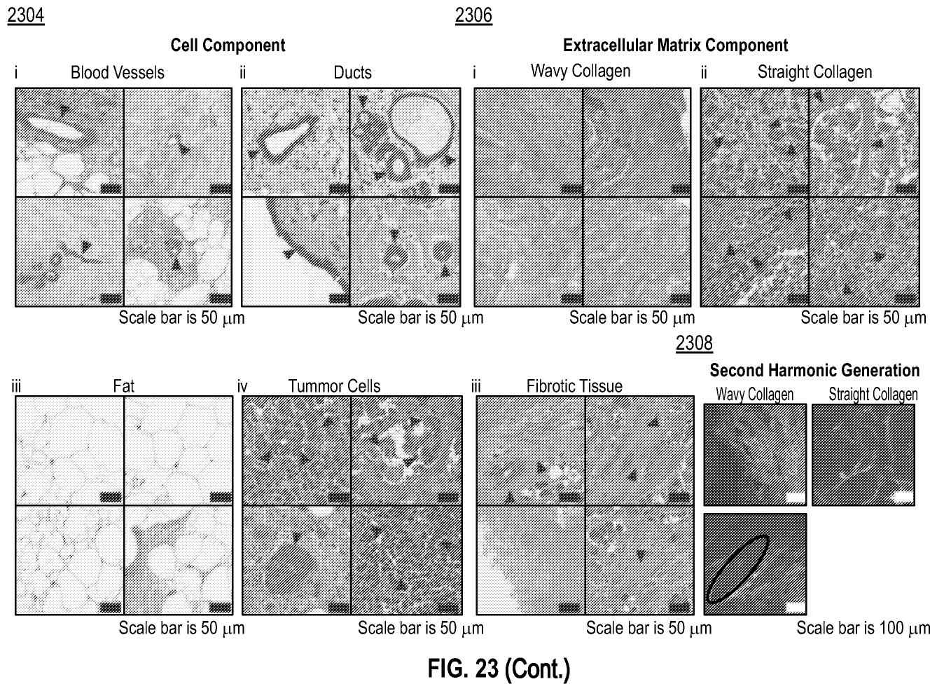

FIG. 23 is an overview diagram of a process 2300 for deep learning composition analysis of breast tissue. The process 2300 can utilize a deep learning model to classify essential cellular and extracellular matrix features. More specifically, the process 2300 provides for determining composition of breast tissue samples based on analysis of breast tissue stiffness. Breast stiffness reflects physical forces generated by interactions between cells themselves and an extracellular matrix. Breast stiffness influences a variety of cell functions including cell growth, survival, motility, and differentiation. Calculating breast stiffness can be advantageously used to assess breast cancer risk and to improve risk prediction.

There is a disconnect between biomechanical and biophysical experiments and clinical methods used to determine effective therapeutics for patients with solid tumors. Women with breast cancer, for example, are typically diagnosed via dedicated breast imaging modalities (e.g., mammogram, ultrasound, MRI, and tomosynthesis). Mammograms are radiological images that can reveal regions of dense, fibrous, and glandular breast tissue, typically depicted in white, against non-dense, fatty tissue, typically depicted in black. As described herein, image analysis techniques can be used to evaluate breast density. These image analysis techniques can include visually binning images into categories (e.g., fatty, scattered, heterogeneous, extremely dense) based on a percentage of white versus black features in the breast image, or quantifying an exact percentage of dense tissue in white (e.g., refer to 2302 in FIG. 23).

Breast cancer is one of the most common cancers among women. Typically, women may be told whether they are at risk for breast cancer based on mammograms. Often, however, a mammogram may miss underlying breast cancers. Moreover, sensitivity of mammography is inversely correlated with breast density, especially with older film-screen analog techniques. Some cancers are mammographically occult and can be detected only by other breast imaging or physical examination. Women may therefore be given inaccurate predictions of risk for breast cancer. Women can be told that they are at high risk of breast cancer based on having dense breast tissue.

Breast density reflects an amount of fibrous and glandular tissue in a woman's breast compared with an amount of fatty tissue in the breast, as seen on a mammogram. Dense breast tissue with higher amounts of fibrous and glandular tissue can appear white on a mammogram. Women with dense breasts can have a higher risk of getting breast cancer, although the reason for this association is unknown. Breast density may promote development of premalignant lesions, such as atypical ductal hyperplasia, elevated growth factors, or increased estrogen production within the breast due to overactive aromatase. Additionally, most cancers may develop in the glandular parenchyma that is more abundant in dense breasts. Breast density does not correlate with physical examination findings (e.g., no palpable difference to identify breast density during self- and clinical-examinations of breast). Breast density is a radiologic finding and cannot be predicted without obtaining a mammogram. Additionally, appearance of dense tissue in a mammogram can hide other cancers. This is because possible tumors also appear white in mammograms, making it difficult to differentiate dense breast tissue on a mammogram from a small tumor indicative of other cancers. Therefore, increased breast density can impair the detection of abnormalities on mammography.

Many women who are screened may be told that they are at increased risk of breast cancer on the basis of their dense breast tissue. Sharing dense breast tissue as an indicator of higher cancer risk can lead many women to believe that they are at high risk, potentially leading to over-treatment (e.g., mastectomy). This type of diagnosis can also mislead women who do not have dense breast tissue to believe they are not at increased risk for breast cancer, potentially leading to under-treatment.

Dense breast tissue can pose some risks for patients. For example, dense breast tissue can impair ability to detect malignant lesions through imaging. As another example, dense breast tissue can be an independent risk factor for breast cancer. Increased breast density can be associated with a worse patient prognosis, poor progression free survival rate, and increased mortality. These denser tissue regions are purported to be more fibrous than surrounding tissue, and can be linked to an increase in amount of collagen and numbers of epithelial and non-epithelial cells. While mammography remains a standard for breast cancer screening, other imaging methods like elastography can be used. Breast ultrasound elastography, a method utilizing sonographic imaging, identifies changes in elastic moduli to detect lesions in the breast. After using multiple imaging modalities, core needle biopsies can still be an essential next step in diagnosis. In a laboratory setting, the application of cell and tissue mechanics can provide insight into tumor development and progression. Tissue stiffening, widely attributed to an increase in collagen deposition and cross-linking, can be a marker of tumor biogenesis. Despite the lack of a direct link, breast tissue density (radiographically defined fibrous and glandular tissue) and breast tissue stiffness (the resistance of tissue to deformation; often broadly referring to the elastic modulus) can be conflated. The disconnect in terminology, between breast density and breast stiffness, and assessed features in the clinic versus the laboratory can hamper generation of new and effective mechanobiology-inspired cancer therapies.

The techniques described in reference to FIGS. 23-32, therefore, provide a bridge between breast density and breast stiffness in such a way that breast stiffness can be used as a biomarker to determine or otherwise diagnose patients with breast cancer. More particularly, patient information, medical imaging, treatment history, and histology to global and local mechanical measurements can be correlated through use of a deep learning, CNN. The CNN can identify tissue components from H&E stained sections of breast cancer tissues (e.g., refer to 2302 in FIG. 23). As an illustrative example, the disclosed technology can be applied to dense breast tissue samples. Global stiffness for the breast tissue samples can be determined using a compression test, which consists of taking one uniaxial measurement per tissue sample to obtain Young's modulus. Local stiffness, obtained through microindentation, can also report the elastic modulus (e.g., tissue stiffness) from multiple, evenly spaced indentation measurements across the same tissue surface. Based on these measurements, the disclosed technology can be used to identify correlations between tissue stiffness, tissue composition, and breast density.

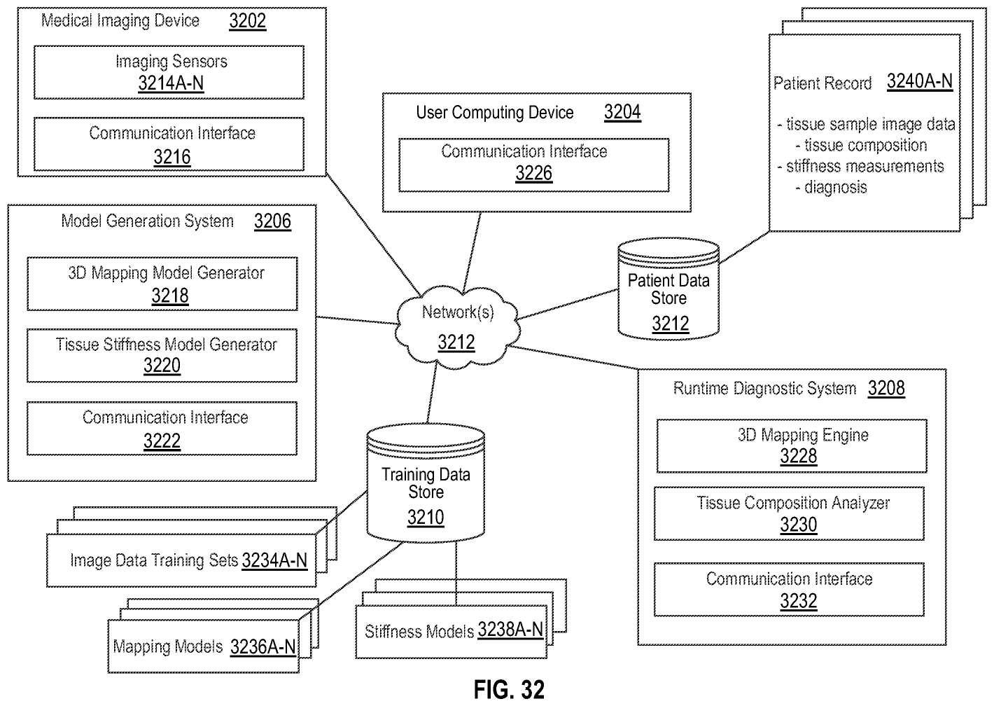

Referring to FIG. 23, the process 2300 can include breast tissue acquisition, characterization, and selection of classes for deep learning composition analysis. The process 2300 can be performed by one or more computer systems, such as model generation system 3206 and runtime diagnostic system 3208 in FIG. 32.

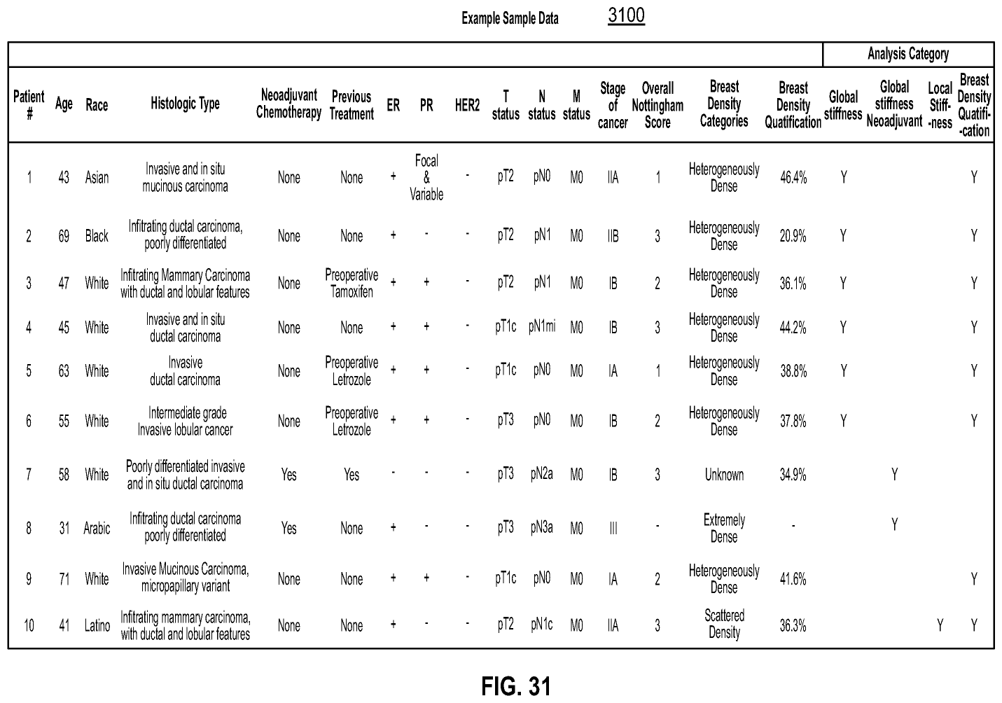

In the process 2300, as shown in 2302, patients can receive diagnostic breast imaging via mammogram, pathologic examination, and characterization, and finally surgery. This imaging can occur prior to release of tissue samples for mechanical measurements, H&E staining, and deep learning analysis. As an illustrative example, the disclosed technology can be used with patients, such as the 10 patients listed in example sample data table 3100 in FIG. 31. 2302 is a schematic detailing breast tissue acquisition and characterization, which can start with medical imaging, diagnosis, treatment, mechanical measurements, histology, and machine learning. For example, patient demographics can be collected, such as age and race. Breast density can be determined from mammography. Determining the breast density can include categorizing and quantifying the breast density. Next, diagnosis and treatment of an identifier tumor in the breast can be determined. Determining the diagnosis and treatment can be based at least in part on histological type, hormone expression, neoadjuvant chemotherapy, preoperative treatment, stage of cancer, and/or TNM status. Using the disclosed technology, mechanobiology techniques can be employed to calculate global stiffness (e.g., Young's Modulus) and local stiffness (e.g., elastic modulus) of the breast tissue. The tissue sample can be stained with H&E and imaged using histology techniques to identify tissue components. Application of the deep learning CNN described herein can then be used to identify cellular components and extracellular matrix (ECM) components. Based on the steps identified in 2302, the disclosed technology can provide for assessing breast tissue stiffness as a biomarker in breast cancer diagnosis and treatment.

Breast tissue histology can be complex and heterogeneous, as many components change in content and organization during tumor progression. Deep learning classifiers can identify normal and cancerous components in histological sections. The disclosed technology therefore utilizes a CNN-based deep learning pipeline to classify histological images into pathologically relevant subtypes. 7 clinically relevant and computationally identifiable tissue classes can be identified, as shown in 2304 and 2306. These classes can be consistent across most tested breast tissues. 4 H&E stained images of cell component classes include blood vessels (capillaries and venules/arterioles), ducts (excretory, terminal/acini/alveoli), fat, and tumor cells (viable, necrotic), as shown in 2304. These classes are scaled to 50 μm. 3 H&E stained images of ECM classes include wavy collagen, straight collagen, and fibrotic tissue, as shown in 2306. These classes are also scaled to 50 μm. Second harmonic generation (SHG) images can be used to confirm that the wavy ECM class is wavy collagen, the straight ECM class is straight collagen, and the fibrotic tissue is not collagen detectable with SHG, as shown in 2308. Thus, the wavy and straight ECM classes are fibrillar collagen. The wavy and straight stromal phenotypes can be identified from a visual assessment of the histology sections. These classes can be scaled to 100 μm. Finally, the 8^{th} class, not depicted in FIG. 23, can be white space, which can encapsulate all non-tissue space in the image data.

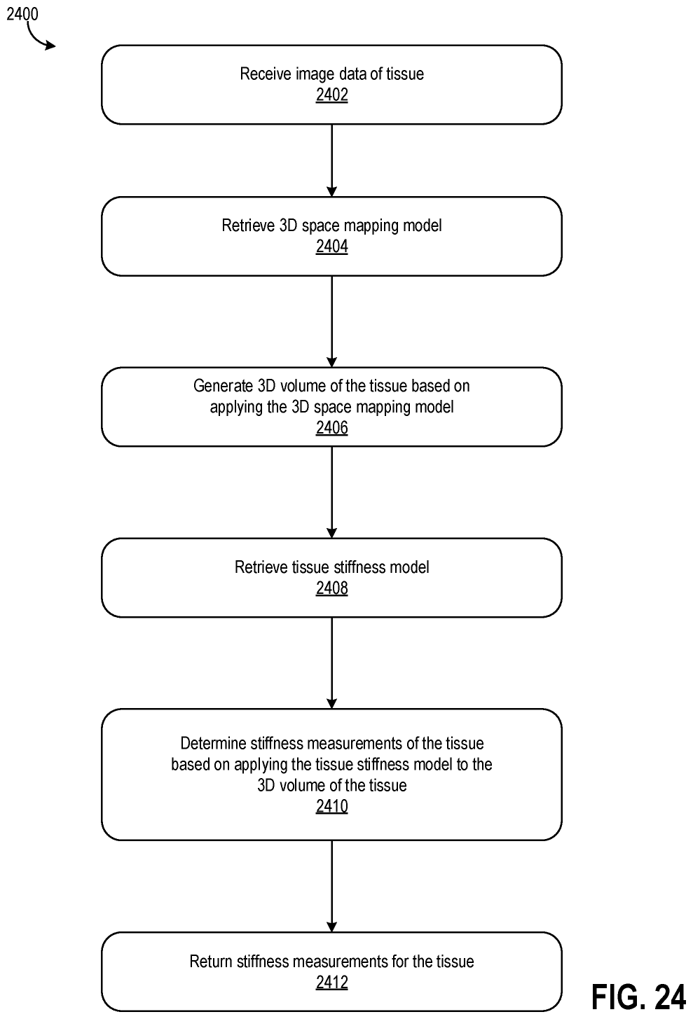

FIG. 24 is a flowchart of a process 2400 for determining breast stiffness measurements using the techniques described herein. The process 2400 can be performed by a computing system, such as runtime diagnostic system 3208 depicted in FIG. 32. For illustrative purposes, the process 2400 is described from a perspective of a computer system.

Referring to the process 2400, the computer system can receive image data of a tissue sample in 2402. The tissue depicted in the image data can be serially sectioned, stained, and scanned. Formalin-fixed, paraffin-embedded tissue samples can be sectioned and stained using H&E.

The computer system can also retrieve a 3D space mapping model in 2404. Although three dimensional (3D) mapping is described, mapping can be performed in one or more other dimensions. For example, the computer system can retrieve a two dimensional (2D) mapping model, which can be used to generate a 2D area of the tissue sample. As another example, the computer system can retrieve an n dimensional (e.g., 4D, 5D, etc.) mapping model, which can be used to generate an n dimensional volume of the tissue sample. The retrieved mapping model can be used to generate some volume or area of the tissue sample from the image data. Assessment of the generated volume or area of the tissue sample can glean insight composition of the tissue sample, such as stiffness, which, as described throughout this disclosure, can be a biomarker for breast cancer detection.

The computer system can apply the retrieved 3D space mapping model to the image data in order to generate a 3D volume of the tissue in 3D space (2406). To generate this digital volume of the tissue, the computer system can register the image data. Global and/or elastic registration can be calculated for the image data. The computer system can also normalize the image data, which can include normalizing color of the H&E stain across the image data. Cell coordinates can be identified from images that have normalized color. Once the image data is normalized, the computer system can identify tissue subtypes in the image data. The image data can be classified based on pixel resolution, a number of combine annotation tissue classes, color definitions for labeling of tissue classes, and names of tissue types corresponding to each class label. The classified images can also be aligned using registration displacement fields. Finally, the computer system can generate the annotated and classified tissue volume in 3D space.

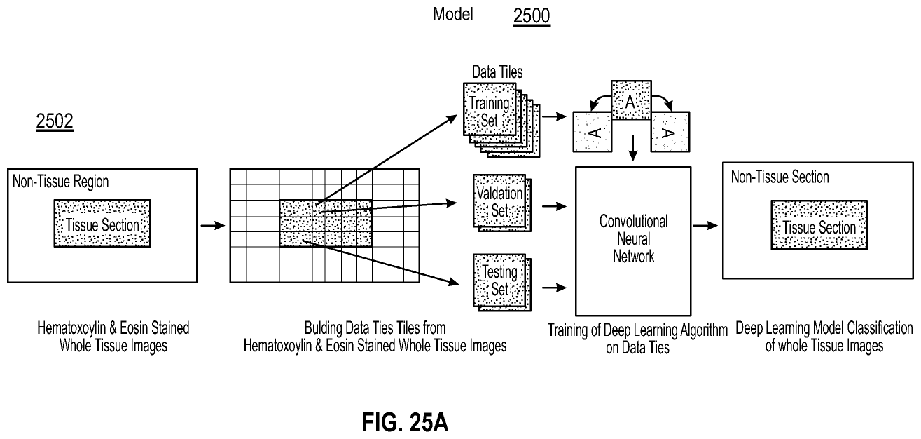

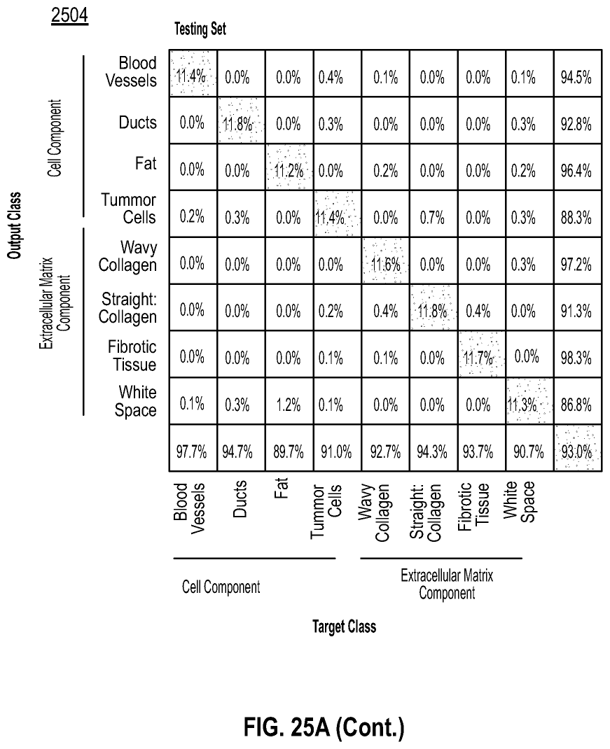

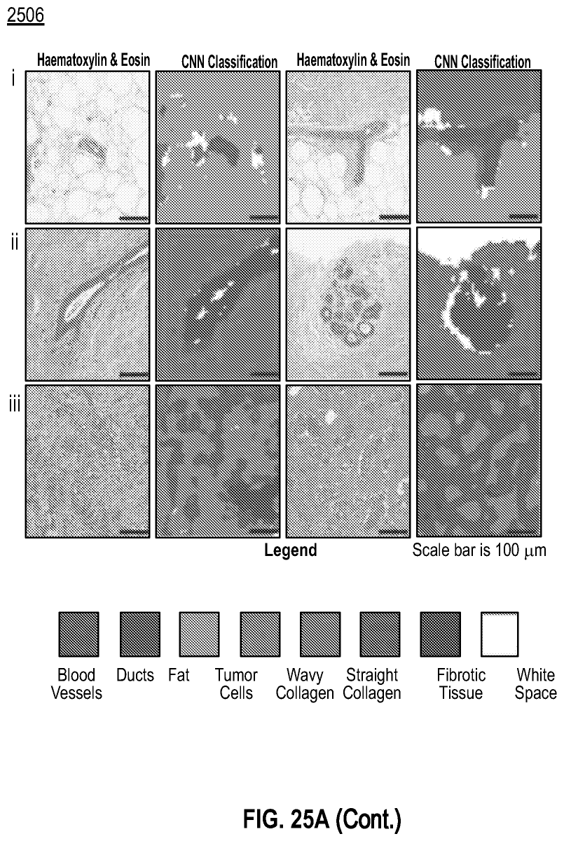

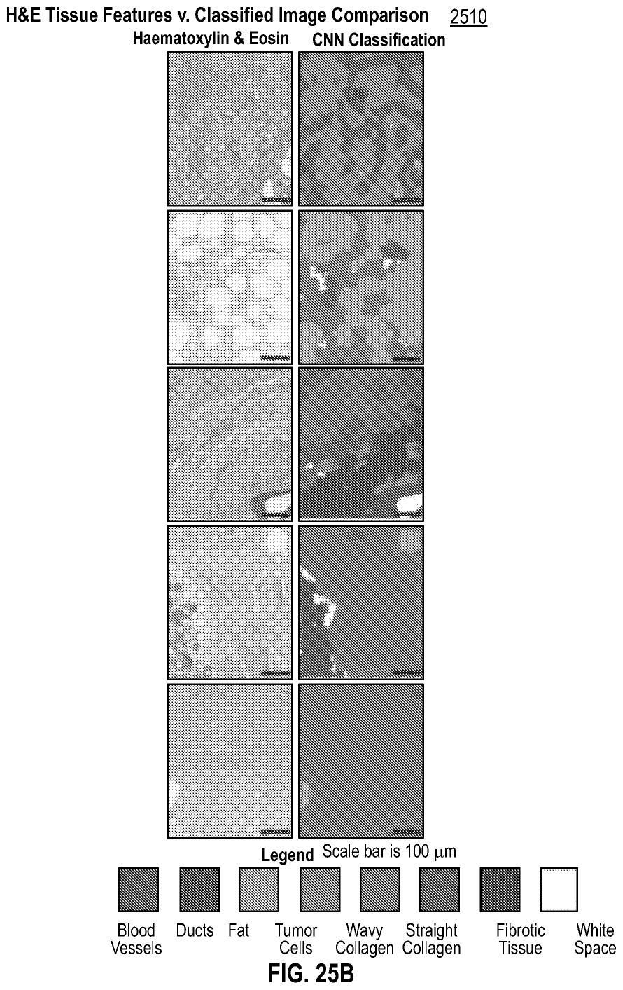

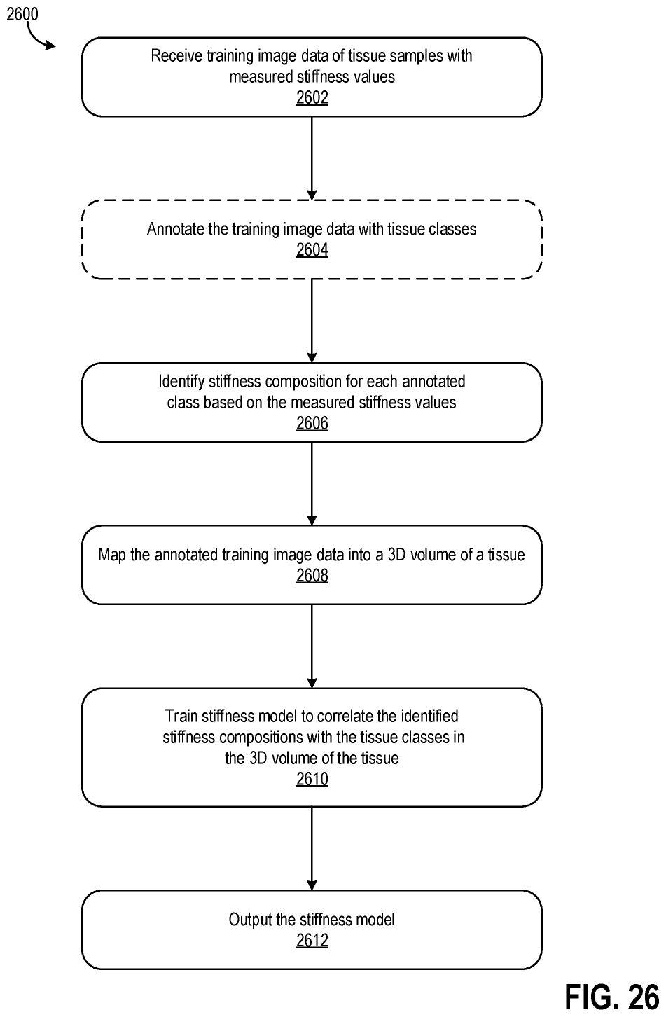

The computer system can retrieve a tissue stiffness model in 2408. In some implementations, the tissue stiffness model can be retrieved before, during, or after any of blocks 2402-2406. The tissue stiffness model can be trained to determine stiffness measurements of subtypes of the tissue represented in 3D space, as described throughout this disclosure (e.g., refer to FIGS. 25A and 26).

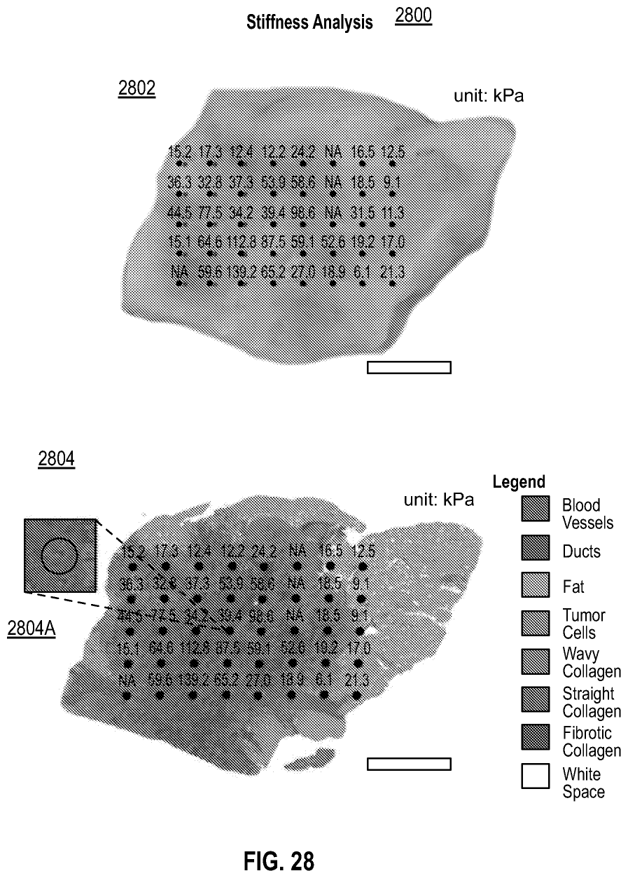

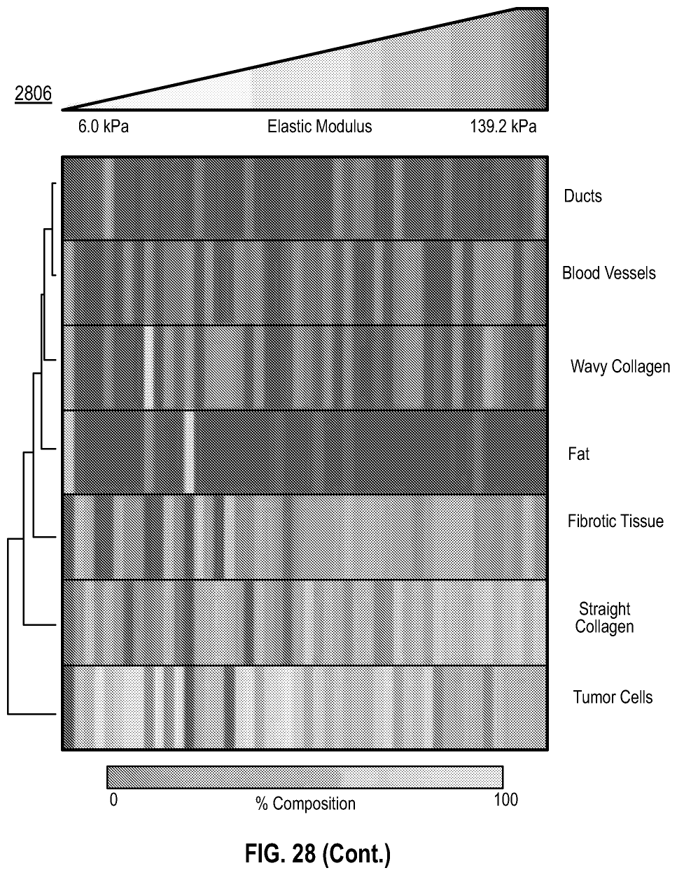

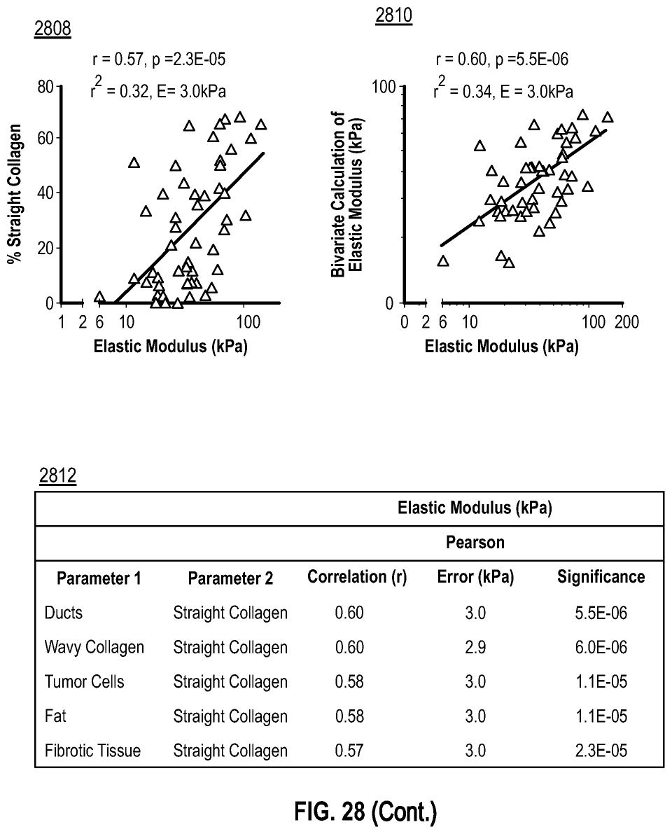

Based on applying the tissue stiffness model to the 3D volume of the tissue sample, the computer system can determine stiffness measurements for the tissue sample (2410). Refer to FIG. 28. The stiffness measurements can be referred to as elastic modulus. The stiffness measurements can also be referred to as Young's modulus. Stiffness can describe elastic modulus, and more specifically, stiffness measurements can define or otherwise describe tissue rigidity, compliance, resistances to deformation, elasticity, elastic modulus, and/or Young's modulus.

The computer system can return the determined stiffness measurements for the tissue sample in 2412. Returning the stiffness measurements can include transmitting and outputting the measurements at a user computing device. The user computing device can be used by a scientist, researcher, clinician, or other relevant user. Based on the returned stiffness measurements, the user can make diagnostics, determine treatments, and/or suggest one or more actions that can be taken for a patient associated with the tissue sample.

FIG. 25A is a diagram of a CNN 2500 used to reconstruct a tissue sample in n-dimensional space and identify tissue and cell classes. FIG. 25A depicts construction as well as quantitative and qualitative analysis of the CNN 2500. In the illustrative example described above, the CNN 2500 can identify the 7 tissue and cell classes in 32 patient tissue samples consisting of 13 tumor-adjacent and 19 tumor samples from all 10 patients (e.g., refer to the table 3100 in FIG. 31 for patient information).

Identification of tissue and cell classes 2502 includes identifying a tissue section from H&E stained whole tissue images and building data tiles from the H&E stained whole tissue images. In the illustrative example described throughout, H&E stained tissue slides from 32 tissue samples of 10 patients can be divided into data tiles for training, validation, and testing. Most of the data tiles can be used as a training set to train the CNN 2500. Data tiles can also be used for validation. Data tiles can also be used for testing the CNN 2500. While each dataset is from same patient tissue slides, the testing set can be developed from a separate set of annotations than the training and validation sets. Image processing and augmentation can be performed on the training set of data tiles. For example, the training images can be augmented by rotation [−90°,90°] before use in the CNN 2500. The augmented training set, validation set, and testing set can then be used to train the CNN 2500 or other similar deep learning algorithm. Accuracy of the CNN 2500 can be determined against the testing sets. Output from the training includes a deep learning model classification of whole tissue images.

Confusion matrix 2504 depicts quantitative class accuracy in the testing data set. Cell component classes include blood vessels, ducts, fat, tumor cells, wavy collagen, straight collagen, fibrotic tissue, and white space (blank space). Overall testing in the illustrative example described above had an accuracy of 93.0%, 300 images were analyzed per class. All tissue classes were identified with greater than 90% sensitivity, except for fat cells at 89.7%. In this case, fat tended to be misclassified as white space due to a chosen image window size in the CNN 2500. Histological subtyping can reveal that a subset of luminal A tumors has ductal morphologies, which can explain why ducts and tumor cells were misclassified as each other 2.5% of the time. Wavy collagen was also misclassified as straight collagen 3.2% of the time, however, straight collagen was never mistaken for wavy collagen. Separation of these ECM phenotypes was important in the illustrative example to ensure that a contribution of stroma to global and local modulus measurements can be analyzed. Any incorrectly classified straight collagen tended to be attributed to the tumor cell class, which was most likely a biological result of short straight fibers amongst tumor cells. White space misclassified as other cellular classes may be due to the presence of lumen.

Visual comparison 2506 highlights the trained CNN 2500's ability to distinguish histological features even in complex tissue microenvironments. The CNN 2500 can distinguish the cell and tissue classes mentioned above from the H&E stained whole tissue images. This qualitative analysis of the CNN model accuracy depicts original histology images side-by-side with the CNN classified image. A first set of images 306i highlights the CNN 2500's ability to identify blood vessels in both fat and wavy collagen. A second set of images 2506ii recognizes a distinction of ducts, both excretory and terminal, in wavy collagen. A third set of images 2506iii shows detection of cancer cells, straight collagen, and fibrotic tissue. Scale bars at a corner of each image are 100 μm.

Similarly, like the visual comparison 2506 in FIG. 25A, FIG. 25B depicts a comparison 2510 of H&E tissue features with CNN classified image data of a tissue sample. This qualitative analysis of the CNN model accuracy also shows original histology images side-by-side with the corresponding CNN classified image. Scale bars at a corner of each image are also 100 μm.

FIG. 26 is a flowchart of a process 2600 for training a model to determine stiffness measurements of a tissue sample. One or more blocks in the process 2600 can be performed by a computing system, such as model generation system 3206 in FIG. 32. For illustrative purposes, one or more blocks in the process 2600 are described from a perspective of a computer system.

Referring to the process 2600, the computer system can receive training image data of tissue samples with measured stiffness values in 2602. In the illustrative example described herein, tumor-adjacent and tumor tissue samples can be received from patients and kept in 4° C. DPBS immediately after mastectomy or lumpectomy. Tumor samples can be transferred for mechanical tests within 4 hours of resection. The tumor tissue samples can then be sectioned to expose regions of interest for micromechanical mapping and bulk compression tests. In the illustrative example, 15 tissues from 6 luminal A patients that did not receive neoadjuvant chemotherapy can be chosen as training image data for global stiffness analysis. 6 tissues from 2 patients, one with luminal A subtype and one with TNBC subtype, that received neoadjuvant chemotherapy can be used in a separate analysis of a relationship between global stiffness and tissue composition to avoid any confounding tissue composition distributions associated with neoadjuvant chemotherapy. 2 tissues from 1 patient with a luminal A subtype and no neoadjuvant chemotherapy can be used for complementary local stiffness analysis. Only luminal A patients who did not receive neoadjuvant chemotherapy can be used to analyze quantified breast density. Tissue samples from all patients can be used to train the stiffness model described herein, which can be a CNN.

Still referring to the tissue samples in the image data, each tissue can be fixed in formalin for 24 hours after stiffness measurements are manually obtained (e.g., refer to 2606). The tissue can be transferred to PBS prior to embedding in paraffin, sectioning (4 μm), and staining with H&E. To minimize batch effects of H&E image staining and scanning conditions, all tissues can be stained in and scanned by a same laboratory.

The training image data can be annotated with tissue classes in 2604. In some implementations, annotations can be manually made by a relevant user, such as a scientist or clinician, and entered into a user computing device that is in communication with the computer system. For example, cellular and extracellular components can be identified manually in H&E-stained tissue slides by outlining the feature using an annotating function at the user computing device. As an illustrative example, within each tissue slide, 30 or more instances of a feature type can be annotated to create the tissue and non-tissue-based classes. In some implementations, the annotations can also be verified by a trained pathologist. 7 tissue classes can be annotated in the illustrative example, including blood vessels, ducts, fat, tumor cells, wavy collagen, straight collagen, and fibrotic tissue; and 1 non-tissue class, which can be termed white space.

In some implementations, one or more annotations can be made by the computer system. In yet some implementations, the training image data may already be annotated and the block 2604 can be skipped or otherwise optionally performed.

Moreover, in some implementations, pectoral muscle can be removed from mammogram image data. The image data can be processed (e.g., cropped) to remove any identifiers and keep only the breast image. The image data can be converted to type 8-bit. Thresholding can be performed and a histogram can be taken to determine a total breast pixel size. Reverting to the original 8-bit image, thresholding and taking a histogram can determine a number of dense breast tissue pixels. A breast density percentage can be obtained by dividing a number of white pixels by a number of white pixels and multiplying by 100.

Next, stiffness composition can be identified for each annotated class based on the measured stiffness values (2606). For example, before the tissue sample is imaged, the tissue sample, such as a tumor section, can be mounted on a customized stage and DPBS can be applied to keep the tissue hydrated throughout measurements. Dynamic indentation by a nanoindenter can be used to characterize the tumor elastic modulus. Sneddon's stiffness equation can be applied to relate dynamic stiffness of the contact to the elastic storage modulus of the samples. 500 μm flat cylindrical probe can be used for indentations. Briefly, procedure of indentation can include 3 steps: 1) approaching and finding tissue surface at the indenter's resonant frequency to enhance contact sensitivity and accuracy, 2) pre-compression of 50 μm to ensure good contact, and 3) dynamic measurement at 100 Hz oscillation frequency with amplitude of 250 nm. The indentation procedure mentioned above can be performed consecutively on multiple regions of a single tissue surface in a grid pattern to obtain elastic moduli map of the tumor. Because obtaining a perfectly flat tissue surface can be difficult due to tissue heterogeneity, individual indentation processes can be observed using a microscope camera to determine inappropriate contact of the probe to the tissue for inaccurate measurement. The inaccurate measurements can be excluded from training the stiffness model. Typically, a number of indentation points per tissue mapping can be 20-40 with the resolution of 2.5±0.5 mm spacing between points depending on size of the tumor sample. A duration of stiffness mapping can be 30 min on average. A single stiffness measurement was obtained for each indentation.

Moreover, the tissue samples can be sectioned to obtain flat and parallel surfaces on all sides. Once the sample is sectioned, it can be immediately staged on tensile/compression tester (MTS Criterion) for measurement. A top compression plate can be lowered until in full contact with the tissue sample at minimal load. Once in contact, the samples can relax and stabilize for 1 min before actual compression testing. The tissue samples can be compressed at 0.25 mm/sec deformation rate until 20% strain. Young's modulus calculations can be done on a best-fitted slope of an initial linear region (˜5-10%) of the obtained stress-strain curve. A single measurement can be obtained for each tissue.

Still referring to 2606, histogram analysis can be performed on the image data to provide tissue composition values for global stiffness (e.g., in the illustrative example, 15 tissue samples, 6 patients). For local stiffness composition, a fresh patient tissue image can contain the original microindentation map overlay, as described above. A CNN classified image can be scaled and manually registered to match the original fresh patient tissue image. Histogram analysis inside of 500 μm (62.5 px) diameter circles on the CNN classified image can provide local stiffness composition (e.g., in the illustrative example, 3 tissue samples, 2 patients).

In 2608, the computer system can map the annotated training image data into a 3D volume of a tissue. Refer to the process 2400 in FIG. 24 for 3D mapping. The computer system can then train a stiffness model to correlate the identified stiffness compositions with the tissue classes in the 3D volume of the tissue in 2610. The stiffness model (e.g., a CNN) can be trained and validated with 3,600 randomly selected non-repeating image tiles per annotation class from all patient slides (e.g., tissue samples). In the illustrative example described throughout this disclosure, of these 3,600 images per class, 3,000 can be used for training, and 300 can be used for validation and testing. Dropout layers and a window size of 103 pixels×103 pixels×3 channels can be used to facilitate classification of both cellular and extracellular classes in the stiffness model. The training images can be augmented via positive or negative 90° rotations to increase the training size and prevent overfitting. Adam (adaptive moment estimation) optimization can be used with an initial learning rate of 0.013 to train the stiffness model. Training can be completed when validation accuracy does not improve for 5 epochs.

A network architecture of the CNN stiffness model can contain 4 convolutional layers each followed by a batch normalization and rectified linear unit (ReLu) layers. The second convolutional layer can be followed by a dropout layer of 0.1. Then there can be 6 convolutional layers in parallel, each with a batch and ReLu layer. An additional layer and ReLu layer can be added before 5 more convolutional/batch/ReLu layers. There can be a max pooling layer, convolutional layer, dropout layer of 0.1, batch and ReLu layers. Next, a convolutional/batch/ReLu/max pooling can be set before a fully connected layer with batch normalization and ReLu layers. The architecture can end with a fully connected layer, batch normalization layer, and softmax output layer.

As part of training, univariate analysis can be performed, resulting in either a Pearson or Spearman correlation and statistical significance for identified tissue compositions. Bivariate analysis can also be performed, resulting in a correlation coefficient, fit error, and statistical significance for each pair, as described throughout this disclosure. Global and local stiffness measurements can be converted to log base 10 values before analysis. The distribution used can be ‘normal,’ and the link can be ‘identity.’ General form of an equation used can be μ=Xb, where μ can be a response with a normal distribution, X can be a matrix of predictors, and b can be a vector of coefficient estimates.

As part of training, heatmaps of global and local stiffness data can be created. Clustering can be performed using Euclidean distance with a complete linkage method.

Once training is complete, the computer system can output the stiffness model in 2612. For example, the stiffness model can be stored in a data store. The stiffness model can then be retrieved during runtime use to determine stiffness measurements of one or more imaged tissue samples. As another example, the stiffness model can be transmitted to a computing system, such as the runtime diagnostic system 3208 in FIG. 32 in order to measure stiffness in different portions of imaged tissue samples.

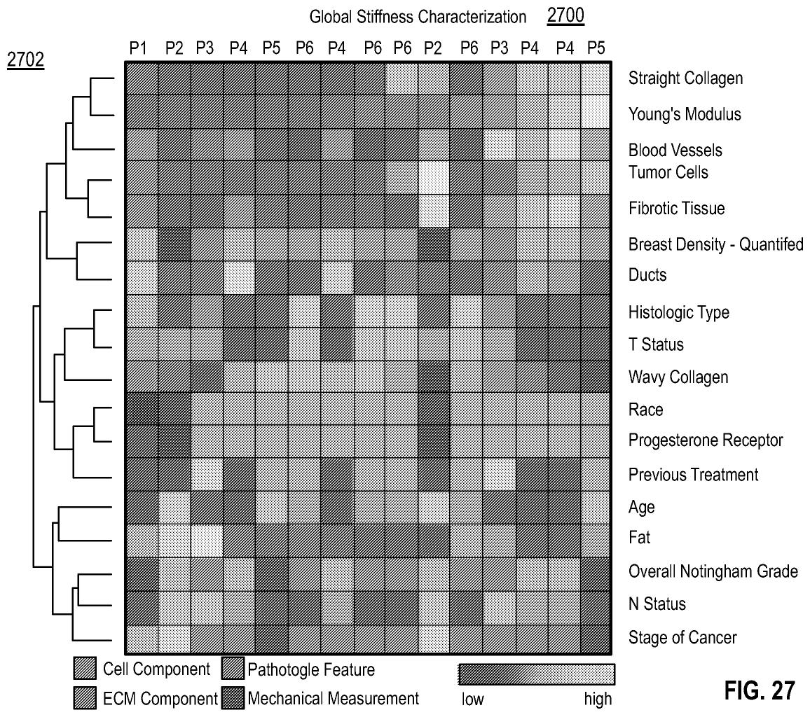

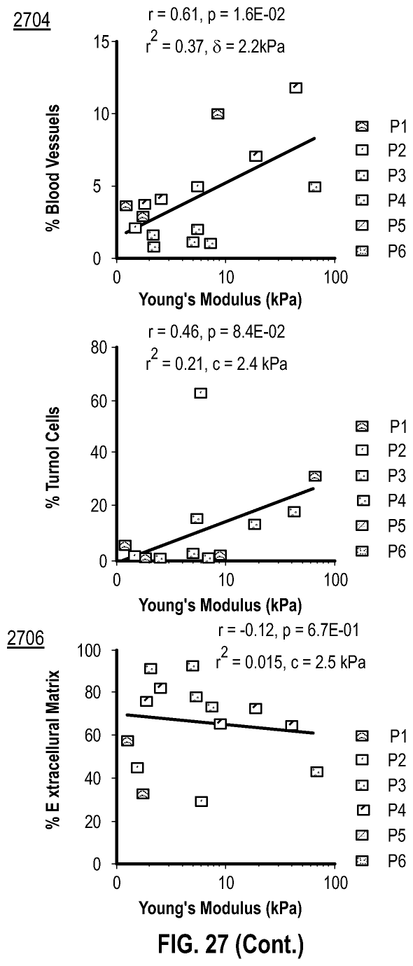

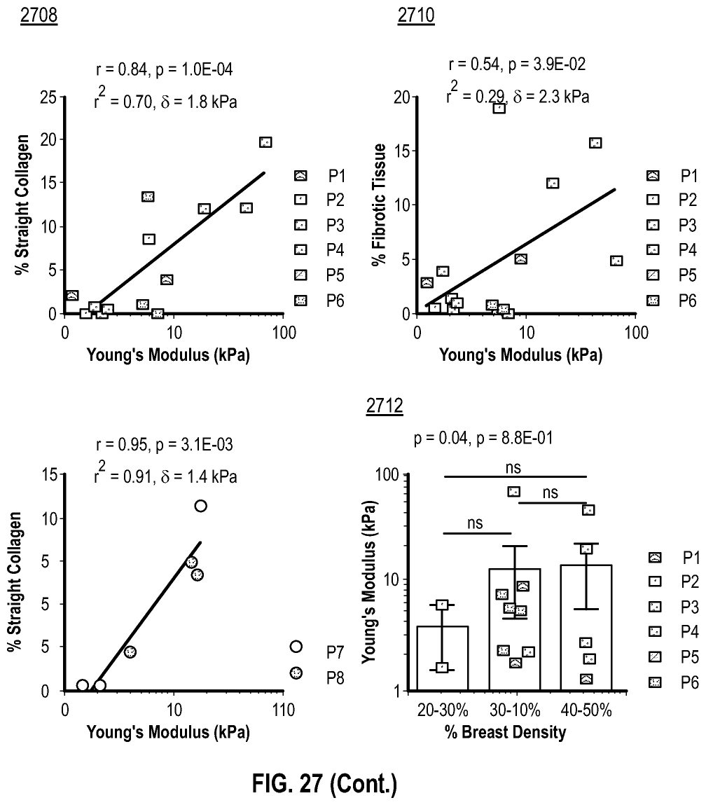

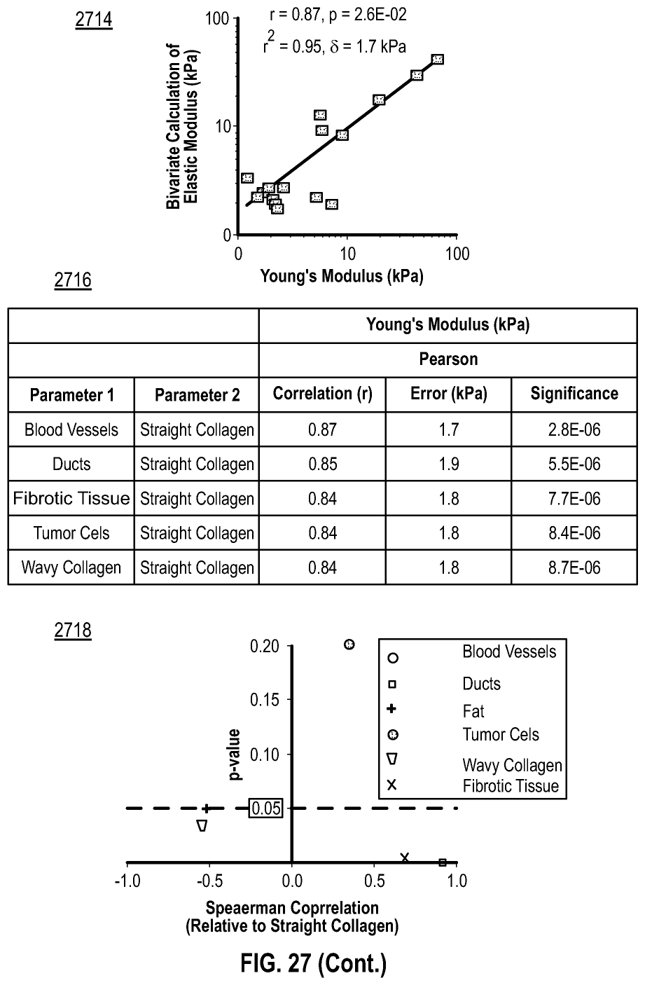

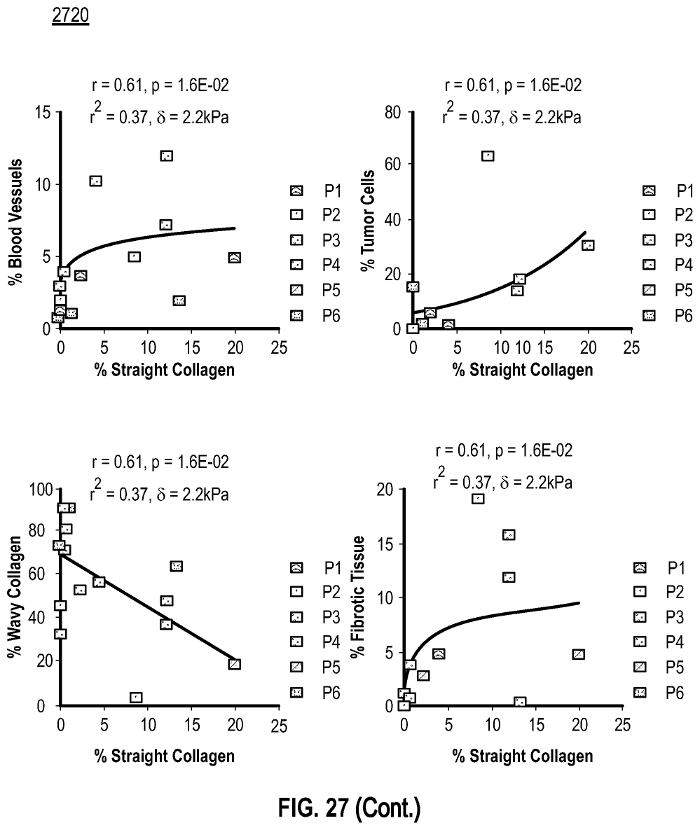

FIG. 27 depicts global stiffness characterization and composition analysis 2700 of breast tissue. As shown using the techniques described herein, straight collagen may be strongly correlated with global stiffness. Heatmap 2702 includes (columns) 15 tissue samples from 6 patients clustered using Euclidean distance with complete linkage by (rows) related features. Each parameter in the heatmap 2702 can be normalized using a z score. Values within each feature can be color-coded by low to high. The heatmap 2702 key denotes the following color-coded parameters of each feature: cell component, ECM component, pathologic feature, or mechanical measurement. Histograms of fully classified whole-tissue slides can provide cell and ECM composition for all tissue samples. Stiffness measurements of tumor-adjacent and tumor tissues can reveal that both global stiffness and composition are heterogeneous within each patient. Mechanically soft tissue can include a highest percentage of fat and wavy collagen. The tissues with the highest Young's moduli can contain greater percentages of blood vessels, tumor cells, straight collagen, and fibrotic tissue, as depicted in the heatmap 2702.

Further analysis of the data using the techniques described herein also suggests that the Young's modulus, the global stiffness measurement of each tissue, has a logarithmic relationship with each tissue component. Plots of log stiffness value versus percent composition of each class yield a linear line of best fit and associated Pearson correlation, as shown in plots 2704-2710.

Plots 2704i-ii depict univariate analysis comparing Young's Modulus (global stiffness, kPA) to percent composition of cell component classes that include blood vessels and tumor cells. Blood vessels plot 2704i demonstrates a significant but moderately strong positive correlation with global stiffness (r=0.61, p=0.016), thereby suggesting that this relationship is important but does not fully describe the system. This is highlighted by tumor cells plot 2704ii, which depicts that tissue with the greatest tumor cell composition belongs to a tissue with a stiffness value of 5.8 kPa, while the lowest composition belongs to a stiffness of 7.2 kPa (r=0.46, p=0.084). The plot 2704ii suggests that tumor stiffness does not always increase with the percentage of tumor cells.

Plot 2706 depicts univariate analysis comparing Young's Modulus (global stiffness, kPA) to percent composition of cell component classes that include ECM combined. Combining all matrix (non-cellular) classes into one category can reveal that there is no clear correlation (r=−0.12, p=0.67) between total ECM content and global breast tissue stiffness, as shown in ECM plot 2706. This may be a result of a high percentage of wavy collagen, an ECM class that does not significantly correlate with stiffness in each tissue sample.

Plots 2708i-ii depict univariate analysis comparing Young's Modulus (global stiffness, kPA) to percent composition of cell component classes that include straight collagen and fibrotic tissue. While percentage of fibrotic tissue shows a moderately strong correlation (r=0.54, p=0.039) with the Young's modulus of the tissue in fibrotic tissue plot 2708ii, there can be a strong positive correlation (r=0.84, p=0.0001) between percentage of straight collagen and the Young's modulus, as shown in straight collagen plot 2708i. Parsing the ECM classes can demonstrate a need to evaluate ECM components separately from the bulk.

Plot 2710 depicts univariate analysis comparing Young's Modulus (global stiffness, kPA) to percent composition of cell component classes that include straight collagen from patients who received neoadjuvant chemotherapy. In a clinical setting, neoadjuvant chemotherapy can be a confounding factor in resulting breast tissue composition as it contributes to generation of fibrotic tissue. As an illustrative example, in two patients who received neoadjuvant chemotherapy, there can be a significantly strong positive correlation (r=0.95, p=0.0031) between straight collagen and Young's modulus, as shown in neoadjuvant chemotherapy patients plot 2710. This result suggests that a relationship between straight collagen and global stiffness is independent of whether a patient has received neoadjuvant chemotherapy.

Graph 2712 depicts univariate analysis comparing Young's Modulus (global stiffness, kPA) to percent composition of cell component classes that include percent breast density. In the illustrative example described throughout, the 8 patients in luminal A, non-neoadjuvant chemotherapy cohort had mammographically heterogeneously dense breasts (e.g., refer to the table 3100 in FIG. 31). When quantified, this category can span a range of 20-50% dense breast tissue, as shown in breast density graph 2712. Binning of percent density into 3 categories demonstrates that there may be no significant relationship between breast density and global tissue stiffness.

Plot 2714 depicts a highest correlated pair of tissue composition classes with Young's Modulus. A general linearized model can be used to perform bivariate analysis of tissue composition classes in patients without neoadjuvant chemotherapy. Stiffness measurements can be converted into log scale values prior to performing this analysis. The correlation between Young's Modulus and any 2 tissue classes may only slightly increase in strength (r=0.87, p=0.000026), as shown in bivariate calculation of Young's Modulus plot 2714. An effect of straight collagen can dominate top 5 strongest bivariate correlations, as shown in table 2716. The table 2716 demonstrates top 5 correlated tissue composition pairs from bivariate analysis using normal distribution and identity linking. The pairs are ranked by correlation and error is fit-error. The percentage of blood vessels in combination with straight collagen can yield the highest correlation. This result can also be supported by the above univariate analyses depicted in plots 2704i and 2708i.

Moreover, using the disclosed technology, straight collagen content can correlate with other cellular and extracellular classes. Given importance of straight collagen composition in determining breast tissue stiffness, the disclosed technology can be used to identify a relationship of straight collagen composition to other cellular and extracellular classes, as shown in plots 2718-2720. Tissue stiffness can be compared based on orders of magnitude changes, and frequently visualized on a logarithmic scale. Percentage of straight collagen cannot be assumed as a linear, proportional response with other tissue components. Accordingly, Spearman correlation is depicted in the plots 2718-2720.

Plot 2718 depicts Spearman Correlation (ρₛ) versus the p-value for all cellular and extracellular classes versus straight collagen. Values below the dashed line where p=0.05 can be significant. Plots 2720i-iv show monotonic relationships between straight collagen and blood vessels (2720i), tumor cells (2720ii), wavy collagen (2720iii), and fibrotic tissue (2720iv). The plots 2720i-iv show r² value and root mean squared error (RMSE) at a top of each plot. Plots with square data points represent luminal A patients who have not received chemotherapy. Plots with circles represent patients who received neoadjuvant chemotherapy. Each data point can be color coded by patient. The lines denote best fit trend lines.

Referring to both the plots 2718 and 2720i, there can be a significant, moderately strong Spearman correlation (ρₛ) (ρₛ=0.69, p=0.0045) between percentage of blood vessels and straight collagen. The positive correlation means that a higher percentage of blood vessels moderately parallels a higher percentage of straight collagen. The best fit line to describe the relationship can be logarithmic. Increased vascular density can be linked to poor tumor differentiation and an increase in cancer cell proliferation, which suggests that there may be a trade-off between vascularization and an effort by cancer cells to align collagen.

With respect to the plots 2718 and 2720ii, a percentage of tumor cells has a strongly positive correlation with straight collagen (ρₛ=0.91, p=0.0000024). This relationship suggests a near perfect monotonic relationship between these parameters, which can confirm that tumor cells may be responsible for restructuring the ECM to create aligned fibers. The line of best fit for the data based on the R-squared value can be an exponential curve, however a root mean squared error (RMSE) can be high using this fit, as shown in the plot 2720ii. This finding can be distinct from an earlier observation that percentage of tumor cells may not strongly or significantly correlate with tissue stiffness (ρₛ=0.55, p=0.035; r=0.46, p=0.084) (e.g., refer to the plot 2704ii. The correlations between each combination of the 3 parameters suggest complex relationships between tumor development through changes in tissue composition and mechanical properties like tissue stiffness.

With respect to the other ECM classes, percentage of straight collagen can increase as wavy collagen decreases (ρₛ=−0.55, p=0.034) and fibrotic tissue increases (ρₛ=0.68, p=0.0054), as shown in the plot 2718. The best fit line for wavy collagen can be linear but can have a high RMSE, as shown in the plot 2720iii. A degree of collagen curvature (e.g., straight versus curly) can be related to its location from the tumor, and can be independent of a grade of malignancy. For fibrotic tissue, the best fit line can be logarithmic, as shown in the plot 2720iv.

Finally, Pearson Correlation (r), p-value, r² value, and error are listed at the top of the plots 2704-2710 and 2714. In some implementations, one-way ANOVA can used to perform statistics in 2720.

FIG. 28 depicts an example tissue analysis 2800 with microindentation mapping, characterization, and composition analysis. Based on the analysis 2800, local stiffness can be best described by straight collagen content.

2802 depicts fresh patient tissue with elastic modulus (local stiffness; kPa) map overlay. A scale bar can be 5000 μm. Local measurements reveal large variations in stiffness values of the fresh patient tissue sample.

2804 depicts a corresponding CNN classified image of the patient tissue from 2802 with microindentation stiffness (kPa) map overlay. The scale bar can also be 5000 μm. 2804A shows composition of a representative microindentation point. Poor measurements can be listed as NA and may not contribute to the analysis 2800. Manual registration of microindentation values on to the CNN-classified histology image can allow for a direct comparison between local elastic moduli and local tissue composition. Manual registration can be used here since the microindentation images and map can be performed on whole tissues lacking resolution that may be required to identify tissue components. Therefore, a section must be aligned to the whole tissue image based on whole tissue shape and knowledge of microindentation sampling. Compositions can be determined for a region directly under the microindenter (e.g., a 500 μm-diameter circle, as shown in 2804A). In the illustrative example described throughout, 2 tissue samples from 1 patient in the luminal A non-neoadjuvant cohort, not previously used in the global stiffness analysis, can be chosen for the local stiffness analysis 2800 since the processed samples can be directly matched to unprocessed images obtained from microindentation mapping.

Heatmap 2806 can be clustered using Euclidean distance with complete linkage by (row) each cell or ECM class detailing percent composition (0 to 100%). Each column can be a different microindentation point organized from lowest to the highest stiffness (kPa) value (49 measurements, 2 tissues, 1 patient). Visualizing increasing local stiffness demonstrates that indentations with the greatest stiffness values can have highest percentages of straight collagen, as shown by the heatmap 2806. The greatest percentages of tumor cells and fat can also coincide with some of the lower and middle stiffness values.

Univariate analysis 2808 demonstrates a comparison of elastic modulus (local stiffness; kPa) to percent composition of straight collagen. As with the global Young's modulus, logarithm of the local elastic modulus versus the tissue classes can also be considered. The log of the elastic modulus can have a significant, moderately strong linear relationship with straight collagen (r=0.57, p=0.000023), as shown in the analysis 2808. In some implementations, this may be the only cellular or extracellular relationship to the elastic modulus that can be significant.

Bivariate analysis 2810 showcases a tissue composition pair with a highest correlation to local stiffness. The line denotes best fit line. Pearson Correlation (r), p-value, r² value, and fit-error can be listed at a top of the bivariate analysis plot 2810. Bivariate analysis 2810 may only slightly increase the correlation of the tissue composition classes to the elastic modulus (r=0.60, p=0.0000055), as shown.

Table 2812 demonstrates top 5 tissue composition pairs correlated with elastic modulus. These pairs can be rank ordered by correlation. Error can be fit-error. Again, straight collagen dominates the top 5 correlations. A strongest bivariate pair can be ducts combined with straight collagen, as shown in bivariate analysis 2810 and the table 2812.

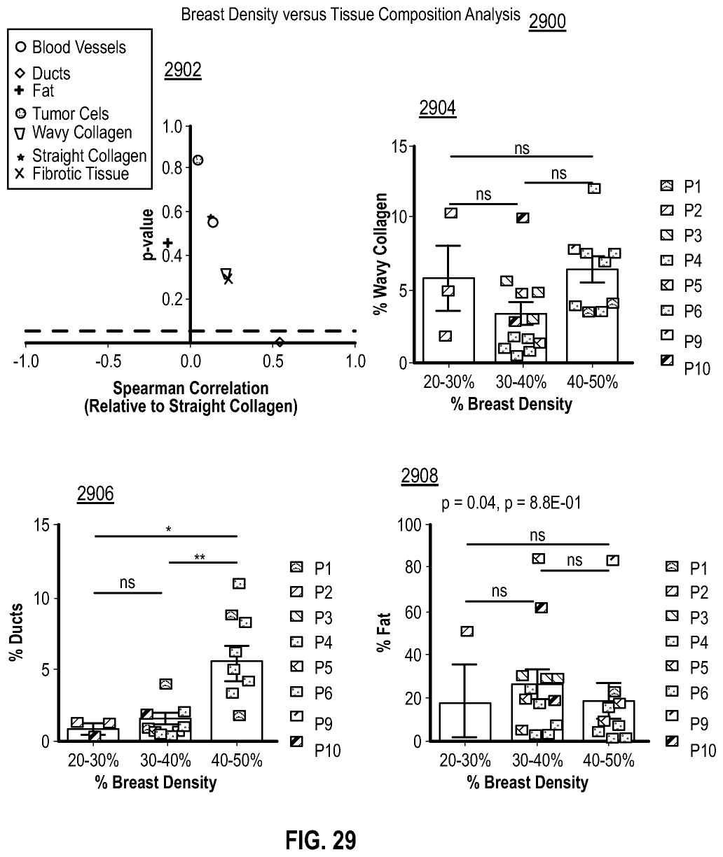

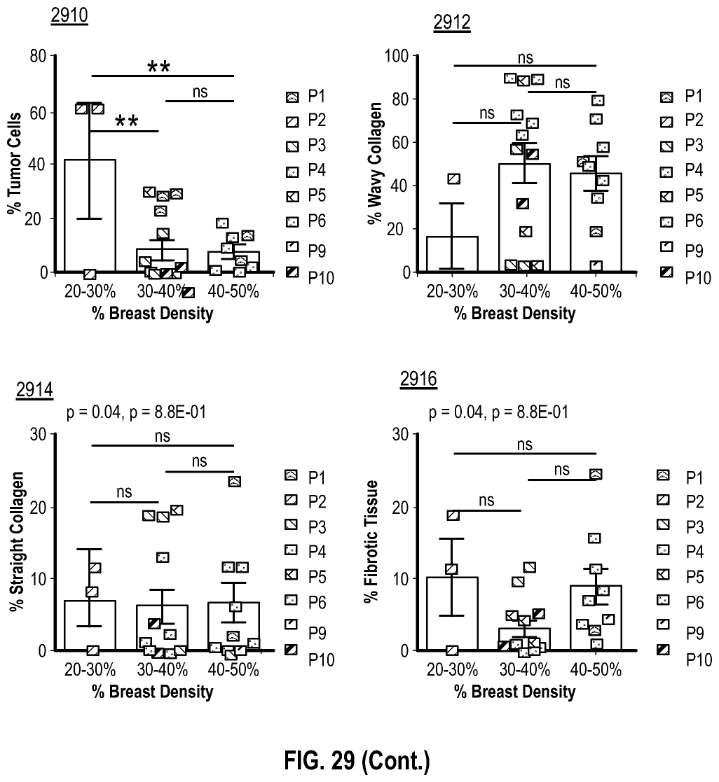

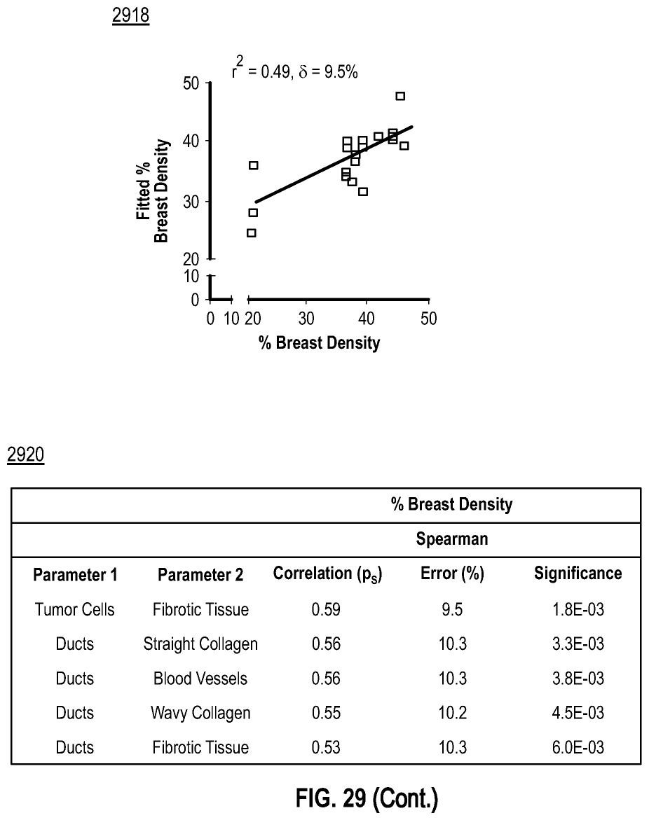

FIG. 29 depicts analysis 2900 of relationships between breast density and tissue composition. The analysis 2900 suggests that breast density does not strongly correlate with tissue classes. As depicted in the analysis 2900, plot 2902 demonstrates Spearman Correlation (ρₛ) versus p-value for all cellular and extracellular classes versus percent breast density. Values below the dashed line where p=0.05 can be significant. Percent breast density versus cell classes can be depicted in blood vessels plot 2904, ducts plot 2906, fat plot 2908, tumor cells plot 2910, and extracellular classes wavy collagen plot 2912, straight collagen plot 2914, and fibrotic tissue plot 2916. When binned, the quantified breast density can be related via bar chart using a one-way ANOVA. Bivariate analysis 2918 depicts a highest pair of features that correlate with the percent breast density. The r² value and fit-error are at the top of the bivariate analysis plot 2918. The line denotes best fit line. Table 2920 also highlights top 5 tissue composition pairs correlated with percent of breast density. These pairs are rank ordered by correlation. The error is fit-error.

As described herein, the concept of breast density is often conflated with breast tissue stiffness. Using the techniques described herein, global stiffness measurements that quantify breast density do not have a clear correlation with Young's modulus of the tissue (e.g., refer to FIG. 27, plot 2712). The relationship between component and percentage breast density can be determined using two methods. The first can be through a Spearman Correlation (ρₛ), highlighting a monotonic relationship between ranked values, as shown in plot 2902. The second can be by binning the percent breast density into 3 intervals and comparing the composition, as shown in plots 2904-2916.

A percentage of blood vessels and fat alone may not correlate with percent density, as shown in the plot 2902, and may not be significantly different from 20-50% dense breast tissue, as shown in the plot 2904. Percentage of ducts can have a significant, moderately positive correlation with percent of dense breast tissue. Furthermore, 40-50% dense breast tissue can be significantly greater percentage of ducts than 20-30% or 30-40% dense breast tissue, as shown in the plot 2906. Although there may not be a correlation between tumor cells alone and breast density (ρₛ=0.04, p=0.84), there can be more tumor cells in tissues with a breast density of 20-30% than 30-40% and 40-50%, as shown in plot 2910. There may be no significant correlation between any of the ECM classes and the percent breast density, nor may there be a significant relationship between breast densities within each of the components, as shown in the plots 2912-2916. Assuming a normal distribution, tumor cells and fibrotic tissue combined can have a significant and moderately positive correlation with breast density (ρₛ=0.59, p=0.0018), as shown in plot 2918 and the table 2920. After this first combination, the percentage of ducts can dominate the bivariate relation shown in the table 2920.

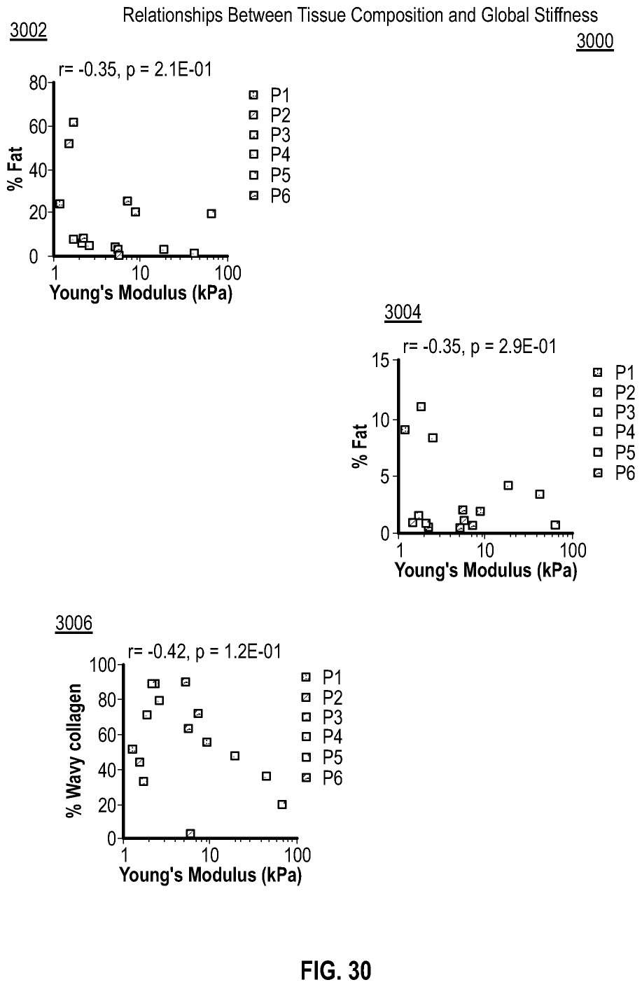

FIG. 30 depicts analysis 3000 of relationships between tissue composition and global stiffness. Depicted are univariate analyses. Plot 3002 depicts univariate analysis comparing Young's Modulus (global stiffness; kPa) to percent composition of a cell component class that includes fat. Plot 3004 depicts univariate analysis comparing Young's Modulus to percent composition of a cell component class that ducts. Plot 3006 depicts univariate analysis comparing Young's Modulus to percent composition of ECM class of wavy collagen. The Pearson Correlation (r) and p-value are listed at a top of the plots 3002-3006.

FIG. 31 is a table 3100 of example sample patient data used with the techniques described herein. As described in reference to the illustrative example described throughout this disclosure, 10 patients can be used in different analysis categories. For example, patients 1-6 can be used in global stiffness and breast density quantification analyses. Patients 7-8 can be used in global stiffness-neoadjuvant analysis. Patients 9-10 can be used in breast density quantification. Finally, patient 10 can also be used in local stiffness analysis. The patients 1-10 had a luminal A subtype and were designated as having categorical heterogeneously dense breasts. Within this specific category, the quantified breast density ranged between 20-50%. Using the disclosed techniques with these patients 1-10, it can be found that mammographic density may not correlate with aligned collagen.

The table 3100 merely depicts example patient data used in the illustrative example described throughout. The disclosed techniques can be applied to a variety of other patients having different demographics and pathologic information.

As described throughout this disclosure, tissue component identification via a deep learning model can be used to connect mechanical measurements to patient tissue composition. Highest univariate correlates of both global and local stiffness can be identified, using the disclosed techniques, as straight collagen (e.g., refer to FIG. 27, plot 2708i and FIG. 28, plot 2808). The disclosed techniques can provide for identifying straight collagen as a biomechanical marker in human tissue. The disclosed techniques also demonstrate that straight collagen has strong monotonic relationships with other cellular and extracellular classes. Moreover, the disclosed techniques demonstrate that Young's modulus can be dependent on tissue composition. Using the disclosed techniques further demonstrates that fibrillar phenotype can be identifiable using H&E without SHG or additional staining. Moreover, the disclosed technology demonstrates that straight collagen may not directly relate to breast density. Separation of wavy and straight fibrillar collagen and fibrotic tissue can highlight importance of separating ECM classes into pathologically relevant subtypes to properly identify how ECM may contribute to mechanical stiffness in patient tissue.

FIG. 32 is a system diagram depicting one or more components used to perform the techniques described herein. A medical imaging device 3202, user computing device 3204, model generation system 3206, runtime diagnostic system 3208, training data store 3210, and a patient data store 3212 can be in communication via network(s) 3200 to perform the techniques described herein. In some implementations, one of more of 3202, 3204, 3206, 3208, 3210, and 3212 can be combined into one or more computing systems, servers, and/or devices. Moreover, in some implementations, one or more techniques performed by any one or more of 3202, 3204, 3206, and 3208 can be performed by one or more other computing systems, servers, and/or devices.

The medical imaging device 3202 can be configured to generate image data of a patient's body. For example, the medical imaging device 3202 can include a mammogram, ultrasound, MRI, and tomosynthesis. One or more other medical imaging devices can be used with the disclosed techniques. The medical imaging device 3202 can include one or more imaging sensors 3214A-N and a communication interface 3216. The imaging sensors 3214A-N can be configured to capture images the patient's body, such as a patient's breasts, pancreas, and other internal parts of the body.

The model generation system 3206 can be configured to generate one or more machine learning models used to perform the techniques described herein. For example, the model generation system 3206 can generate models that map image data of a tissue sample into multi-dimensional space. The model generation system 3206 can also be configured to generate models that measure stiffness measurements of the tissue sample from a 3D or other multi-dimensional volume or rendition of the tissue sample. Thus, the model generation system 3206 can include a 3D mapping model generator 3218, a tissue stiffness model generator 3220, and a communication interface 3222.

The 3D mapping model generator 3218 can be configured to generate and train one or more machine learning models that can be used to map tissue samples into multi-dimensional space. Refer to FIG. 24 for discussion on generating and training such mapping models. The mapping models can be generated using image data training sets 3234A-N, which can be retrieved from the training data store 3210. The generated models can be stored in the training data store 3210 as mapping models 3236A-N.

The tissue stiffness model generator 3220 can be configured to generate and train one or more machine learning models that can be used to identify tissue composition and determine stiffness measurements of imaged tissue samples. Refer to FIGS. 25A-B, 26, and 28 for training such models. The stiffness models can be trained using the image data training sets 3234A-N, which can be retrieved from the training data store 3210. The stiffness models can also be trained using the mapping models 3236A-N that can also be retrieved from the training data store 3210. The generated stiffness models can be stored in the training data store 3210 as stiffness models 3238A-N.

The runtime diagnostic system 3208 can be configured to use the mapping models 3236A-N and the stiffness models 3238A-N during runtime. The runtime diagnostic system 3208 can be part of or separate from the medical imaging device 3202, the user computing device 3204, and/or the model generation system 3206. The runtime diagnostic system 3208 can also be part of or separate from a radiology system. The runtime diagnostic system 3208 can include components such as a 3D mapping engine 3228, a tissue composition analyzer 3230, and a communication interface 3232.

The 3D mapping engine 3228 can be configured to map image data of a tissue sample into 3D space using the mapping models 3236A-N. For example, the 3D mapping engine 3228 can receive image data of a patient's tissue sample from the medical imaging device 3202. The 3D mapping engine 3228 can retrieve the mapping models 3236A-N from the training data store 3210. The 3D mapping engine 3228 can then applying the mapping models 3236A-N to the image data from the medical imaging device 3202 to render the imaged tissue sample into 3D space.

The tissue composition analyzer 3230 can be configured to identify a tissue composition of the 3D volume of the tissue sample and determine stiffness measurements of the tissue. For example, the tissue composition analyzer 3230 can receive the 3D rendering of the tissue sample from the 3D mapping engine 3228. The tissue composition analyzer 3230 can also retrieve stiffness models 3238A-N from the training data store 3210. The tissue composition analyzer 3230 can apply the models 3238A-N to the 3D rendering of the tissue sample in order to determine compositional attributes of the tissue sample, as described throughout this disclosure.

Determinations made and analysis performed by the runtime diagnostic system 3208 can be stored in the patient data store 3212. Each patient can have a patient record 3240A-N. Each patient record 3240A-N can include tissue sample image data, tissue composition, stiffness measurements, and diagnosis. One or more additional or fewer information can be stored and associated with the patient records 3240A-N. Thus, the runtime diagnostic system 3208 can store the generated 3D volume of the tissue sample in the corresponding patient record 3240A-N. The runtime diagnostic system 3208 can also store any determinations made about tissue composition and stiffness measurements in the corresponding patient record 3240A-N.

The user computing device 3204 can be used by a relevant user, such as a clinician, scientist, or other professional. Via the user computing device 3204, the relevant user can annotate image data of the tissue samples. For example, the image data can be transmitted from the medical imaging device 3202 to the user computing device 3204. The relevant user can manually annotate the image data with tissue classes, types, subtypes, and/or measurements. This annotated image data can then be transmitted from the user computing device 3204 to the model generation system 3206, where the annotated image data can be used to train one or more of the models described herein. The annotated image data can also be transmitted from the user computing device 3204 to the training data store 3210 to be stored as image data training sets 3234A-N.

During runtime, the user computing device 3204 can be used by the relevant user to view information about the imaged tissue sample. For example, the 3D volume of the tissue sample can be transmitted by the runtime diagnostic system 3208 to the user computing device 3204 for display. Similarly, tissue composition analysis and tissue stiffness measurements can also be transmitted by the runtime diagnostic system 3208 to the user computing device 3204 for display. The relevant user can view and analyze the displayed information to assess a condition of a patient associated with the depicted tissue. For example, the relevant user can determine whether the patient has cancer, what stage of cancer the patient is at, and one or more other diagnostics, treatments, and/or predictions. Determinations made by the relevant user can be stored in the corresponding patient record 3240A-N in the patient data store 3212.

Finally, the communication interfaces 3216, 3222, 3226, and 3232 can provide for the components described herein to communicate (e.g., wired and/or wirelessly) with each other and/or via the network(s) 3200.

The technology disclosed in reference to FIGS. 23-32 provide for using imaging data to determine the composition of patient tissue samples, such as determining the stiffness of breast tissue (an example tissue measurement) and the extent to which such stiffness measurements are indicators of cancer and/or other diseases. The disclosed technology can apply to a variety of tissue types, including those of human organs such as a pancreas and breasts. As described herein, the disclosed technology can provide for a deep learning convolutional neural network (CNN) that analyzes patient tissue samples and correlates mechanical measurements of the tissue samples to tissue composition. The disclosed technology can then provide for correlating tissue stiffness, tissue composition, and breast density in a breast cancer application setting to diagnose patients with breast and/or determine or otherwise identify treatments for breast cancer patients. For example, automatic identification of cellular and extracellular features from hematoxylin and eosin (H&E) stained tissue samples can reveal that global and local breast tissue stiffness is a biomarker for malignancy compared to a mammogram. Accordingly, tissue stiffness can be used as a biomarker for screening and breast cancer risk prediction. Information gained from the CNN can be used to generate a prediction score for identifying risk, diagnosis, and treatment of breast cancer.

Furthermore, the disclosed technology of FIGS. 23-32 provides for diagnosing and treating breast cancer based on determining tissue stiffness, a mechanical property known to promote a malignant phenotype in vitro and in vivo. The disclosed technology demonstrates that global and local breast tissue stiffness can correlate with a percentage of straight collagen. Global breast tissue mechanics can correlate weakly with a percentage of blood vessels and fibrotic tissue, and non-significantly with a percentage of fat, ducts, tumor cells, and wavy collagen in tissue. Importantly, a percentage of dense breast tissue may not directly correlate with tissue stiffness or straight collagen content. The techniques described herein can also be applied to various other application settings, as described herein.

One or more embodiments described herein include a method for determining stiffness measurements of a tissue sample from image data, the method including: receiving, at a computing system and from a medical imaging device, image data of a tissue sample, and retrieving, by the computing system and from a data store, one or more deep learning models that were trained using patient tissue training data. The one or more deep learning models can be configured to (i) generate multi-dimensional volumes of patient tissue from patient tissue image data and (ii) determine stiffness measurements of tissue components in the multi-dimensional volumes of patient tissue. The patient tissue training data can be different than the tissue sample and the patient tissue image data can be different than the image data. The method can also include generating, by the computing system, a three-dimensional (3D) volume of the tissue sample based on applying the one or more deep learning models to the image data, determining, by the computing system, stiffness measurements of the tissue components of the tissue sample based on applying the one or more deep learning models to the generated 3D volume of the tissue sample, and returning, by the computing system, the determined stiffness measurements for the tissue components of the tissue sample.

In some implementations, the method can optionally include one or more of the following features. The one or more deep learning models can be convolutional neural networks (CNN). Training, by the computing system, the one or more deep learning models can include identifying tissue components from hematoxylin and eosin (H&E) stained sections of patient tissue in the patient tissue training data, determining global stiffness of the patient tissue using a compression test, determining local stiffness from microindentation measurements made across surfaces of the patient tissue, and correlating the tissue components, the global stiffness, and the local stiffness with diagnosis of a condition of the patient. Moreover, the patient tissue can be breast tissue and the condition of the patient can be breast cancer. The tissue sample can also be a breast tissue. The tissue components can include blood vessels, ducts, fat, tumor cells, wavy collagen, straight collagen, and fibrotic tissue. Determining, by the computing system, stiffness measurements of the tissue components of the tissue sample can include determining Pearson or Spearman correlation and statistical significance for each of the tissue components in the 3D volume of the tissue sample.

As another example, each of the CNNs can include first, second, third, and fourth convolutional layers, where each of the first, second, third, and fourth convolutional layers can be followed by a first batch normalization layer and a first rectified linear unit (ReLu) layer, a first dropout layer of 0.1 following the second convolutional layer, fifth, sixth, seventh, eighth, ninth, and tenth convolutional layers in parallel, where each of the fifth, sixth, seventh, eighth, ninth, and tenth convolutional layers further can include a second batch normalization layer and a second ReLu layer, an eleventh convolutional layer followed by a third ReLu layer, twelfth, thirteenth, fourteenth, fifteenth, and sixteenth convolutional layers in parallel, where each of the twelfth, thirteenth, fourteenth, fifteenth, and sixteenth convolutional layers further can include a third batch normalization layer and a fourth ReLu layer, a max pooling layer, a seventeenth convolutional layer, a second dropout layer of 0.1, a fourth batch normalization layer, a fifth ReLu layer, a first fully connected layer with a fifth batch normalization layer and a sixth ReLu layer, and a second fully connected layer with a sixth batch normalization layer and a softmax output layer.

As yet another example, the stiffness measurements can correspond to resistances of the tissue components of the tissue sample to deformation. The stiffness measurements can also correspond to elastic modulus. Sometimes, the stiffness measurements can correspond to Young's modulus.

One or more embodiments described herein also include a method for training a deep learning model to determine stiffness measurements of a tissue sample from image data, the method including: receiving, at a computing system, training image data of a tissue sample with measured stiffness values, where the training image data can include H&E stained whole tissue image data, annotating, by the computing system, the training image data with tissue classes, identifying, by the computing system, stiffness composition for each annotated class based on the measured stiffness values, mapping, by the computing system, the annotated training image data into a 3D volume of the tissue sample, training, by the computing system, a deep learning model to correlate the identified stiffness compositions with the tissue classes in the 3D volume of the tissue sample, and outputting, by the computing system, the deep learning model.

One or more of the following features can optionally be included in the method. For example, annotating, by the computing system, the training image data with tissue classes can include identifying tissue sections from the training image data, generating data tiles based on the identified tissue sections, augmenting the generated data tiles based on rotating the generated data tiles [−90°,90° ], and using the augmented generated data tiles as input for training the deep learning model. As another example, the tissue classes can include blood vessels, ducts, fat, tumor cells, wavy collagen, straight collagen, and fibrotic tissue. The training image data can include a microindentation map overlay indicating the measured stiffness values of different sections of the tissue sample. The different sections of the tissue sample can correspond to the annotated tissue classes. Identifying, by the computing system, stiffness composition for each annotated class based on the measured stiffness values can also include performing histogram analysis on the training image data with the microindentation map overlay.

One or more embodiments described herein can also include a computer system for determining stiffness measurements of a tissue sample from image data, the system can include one or more processors, and one or more computer-readable devices including instructions that, when executed by the one or more processors, cause the computer system to perform operations that include receiving, from a medical imaging device, image data of a tissue sample, retrieving, from a data store, one or more deep learning models that were trained using patient tissue training data, where the one or more deep learning models are configured to (i) generate multi-dimensional volumes of patient tissue from patient tissue image data and (ii) determine stiffness measurements of tissue components in the multi-dimensional volumes of patient tissue, where the patient tissue training data is different than the tissue sample and where the patient tissue image data is different than the image data, generating a three-dimensional (3D) volume of the tissue sample based on applying the one or more deep learning models to the image data, determining stiffness measurements of the tissue components of the tissue sample based on applying the one or more deep learning models to the generated 3D volume of the tissue sample, and returning the determined stiffness measurements for the tissue components of the tissue sample.

The system can optionally include one or more of the following features. For example, training the one or more deep learning models can include identifying tissue components from hematoxylin and eosin (H&E) stained sections of patient tissue in the patient tissue training data, determining global stiffness of the patient tissue using a compression test, determining local stiffness from microindentation measurements made across surfaces of the patient tissue, and correlating the tissue components, the global stiffness, and the local stiffness with diagnosis of a condition of the patient. The patient tissue can be breast tissue and the condition of the patient can be breast cancer. Moreover, determining stiffness measurements of the tissue components of the tissue sample can include determining Pearson or Spearman correlation and statistical significance for each of the tissue components in the 3D volume of the tissue sample.

The devices, system, and techniques described herein may provide one or more of the following advantages. For example, the disclosed technology described in reference to FIGS. 23-32 can provide adjunct information on tissue characteristics and composition from tissue pathology that may confirm and support clinical understanding of a patient's cancer diagnosis as well as inform clinical decisions regarding supplemental imaging and/or treatment. The disclosed technology can provide for modeling patient breast tissue in n-dimensional space so that professionals can more easily analyze dense tissue structures. The disclosed technology can further be used to reconstruct tissues of potentially unlimited size. Use of deep learning models and algorithms can provide for incorporating additional digital markers into tissue samples to expand datasets and reconstruct tissues of potentially unlimited size.

As another example, the disclosed technology can provide a research tool to better characterize distinctions between breast stiffness and breast density. Using the disclosed technology as a research tool, professionals can determine whether breast stiffness is an independent risk factor for breast cancer.

Moreover, the disclosed technology can provide for reducing variability and insufficiencies in pathology, mammography, and other diagnostic and prognostic modalities.

The disclosed technology can provide for improved analysis and diagnosis of stages of cancer and invasion of tumor(s) to other parts of a patient's body. The disclosed technology can also assist clinicians in predicting or otherwise determining prognostic and drug responsiveness for patients who have been identified as having cancer.

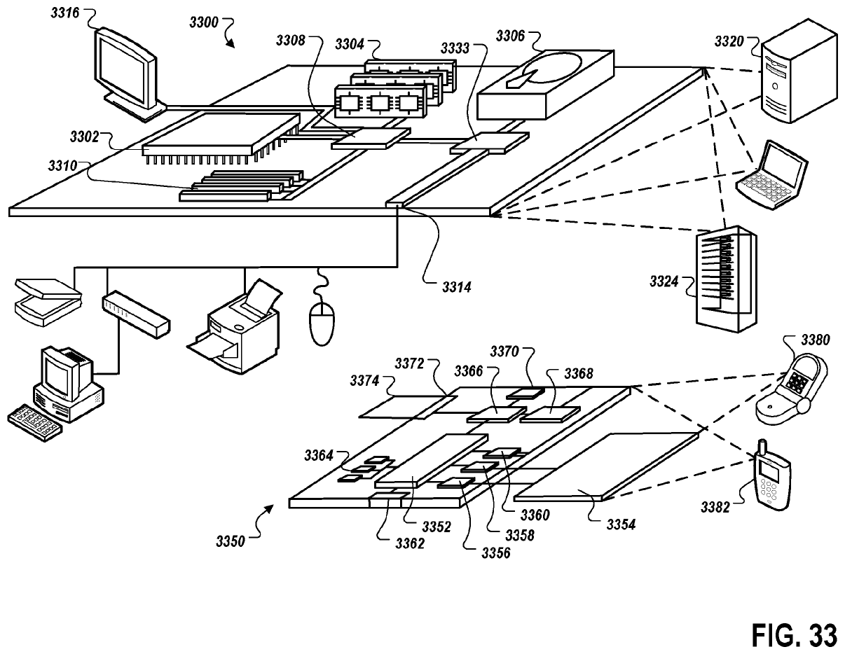

FIG. 33 shows an example of a computing device 3300 and an example of a mobile computing device that can be used to implement the techniques described here. The computing device 3300 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 3300 includes a processor 3302, a memory 3304, a storage device 3306, a high-speed interface 3308 connecting to the memory 3304 and multiple high-speed expansion ports 3310, and a low-speed interface 3312 connecting to a low-speed expansion port 3314 and the storage device 3306. Each of the processor 3302, the memory 3304, the storage device 3306, the high-speed interface 3308, the high-speed expansion ports 3310, and the low-speed interface 3312, are interconnected using various busses, and can be mounted on a common motherboard or in other manners as appropriate. The processor 3302 can process instructions for execution within the computing device 3300, including instructions stored in the memory 3304 or on the storage device 3306 to display graphical information for a GUI on an external input/output device, such as a display 3316 coupled to the high-speed interface 3308. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 3304 stores information within the computing device 3300. In some implementations, the memory 3304 is a volatile memory unit or units. In some implementations, the memory 3304 is a non-volatile memory unit or units. The memory 3304 can also be another form of computer-readable medium, such as a magnetic or optical disk.

The storage device 3306 is capable of providing mass storage for the computing device 3300. In some implementations, the storage device 3306 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 3304, the storage device 3306, or memory on the processor 3302.

The high-speed interface 3308 manages bandwidth-intensive operations for the computing device 3300, while the low-speed interface 3312 manages lower bandwidth-intensive operations. Such allocation of functions is exemplary only. In some implementations, the high-speed interface 3308 is coupled to the memory 3304, the display 3316 (e.g., through a graphics processor or accelerator), and to the high-speed expansion ports 3310, which can accept various expansion cards (not shown). In the implementation, the low-speed interface 3312 is coupled to the storage device 3306 and the low-speed expansion port 3314. The low-speed expansion port 3314, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 3300 can be implemented in a number of different forms, as shown in the figure. For example, it can be implemented as a standard server 3320, or multiple times in a group of such servers. In addition, it can be implemented in a personal computer such as a laptop computer 3322. It can also be implemented as part of a rack server system 3324. Alternatively, components from the computing device 3300 can be combined with other components in a mobile device (not shown), such as a mobile computing device 3350. Each of such devices can contain one or more of the computing device 3300 and the mobile computing device 3350, and an entire system can be made up of multiple computing devices communicating with each other.

The mobile computing device 3350 includes a processor 3352, a memory 3364, an input/output device such as a display 3354, a communication interface 3366, and a transceiver 3368, among other components. The mobile computing device 3350 can also be provided with a storage device, such as a micro-drive or other device, to provide additional storage. Each of the processor 3352, the memory 3364, the display 3354, the communication interface 3366, and the transceiver 3368, are interconnected using various buses, and several of the components can be mounted on a common motherboard or in other manners as appropriate.

The processor 3352 can execute instructions within the mobile computing device 3350, including instructions stored in the memory 3364. The processor 3352 can be implemented as a chipset of chips that include separate and multiple analog and digital processors. The processor 3352 can provide, for example, for coordination of the other components of the mobile computing device 3350, such as control of user interfaces, applications run by the mobile computing device 3350, and wireless communication by the mobile computing device 3350.

The processor 3352 can communicate with a user through a control interface 3358 and a display interface 3356 coupled to the display 3354. The display 3354 can be, for example, a TFT (Thin-Film-Transistor Liquid Crystal Display) display or an OLED (Organic Light Emitting Diode) display, or other appropriate display technology. The display interface 3356 can comprise appropriate circuitry for driving the display 3354 to present graphical and other information to a user. The control interface 3358 can receive commands from a user and convert them for submission to the processor 3352. In addition, an external interface 3362 can provide communication with the processor 3352, so as to enable near area communication of the mobile computing device 3350 with other devices. The external interface 3362 can provide, for example, for wired communication in some implementations, or for wireless communication in other implementations, and multiple interfaces can also be used.

The memory 3364 stores information within the mobile computing device 3350. The memory 3364 can be implemented as one or more of a computer-readable medium or media, a volatile memory unit or units, or a non-volatile memory unit or units. An expansion memory 3374 can also be provided and connected to the mobile computing device 3350 through an expansion interface 3372, which can include, for example, a SIMM (Single In Line Memory Module) card interface. The expansion memory 3374 can provide extra storage space for the mobile computing device 3350, or can also store applications or other information for the mobile computing device 3350. Specifically, the expansion memory 3374 can include instructions to carry out or supplement the processes described above, and can include secure information also. Thus, for example, the expansion memory 3374 can be provide as a security module for the mobile computing device 3350, and can be programmed with instructions that permit secure use of the mobile computing device 3350. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 3364, the expansion memory 3374, or memory on the processor 3352. In some implementations, the computer program product can be received in a propagated signal, for example, over the transceiver 3368 or the external interface 3362.

The mobile computing device 3350 can communicate wirelessly through the communication interface 3366, which can include digital signal processing circuitry where necessary. The communication interface 3366 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 3368 using a radio-frequency. In addition, short-range communication can occur, such as using a Bluetooth, WiFi, or other such transceiver (not shown). In addition, a GPS (Global Positioning System) receiver module 3370 can provide additional navigation- and location-related wireless data to the mobile computing device 3350, which can be used as appropriate by applications running on the mobile computing device 3350.

The mobile computing device 3350 can also communicate audibly using an audio codec 3360, which can receive spoken information from a user and convert it to usable digital information. The audio codec 3360 can likewise generate audible sound for a user, such as through a speaker, e.g., in a handset of the mobile computing device 3350. Such sound can include sound from voice telephone calls, can include recorded sound (e.g., voice messages, music files, etc.) and can also include sound generated by applications operating on the mobile computing device 3350.

The mobile computing device 3350 can be implemented in a number of different forms, as shown in the figure. For example, it can be implemented as a cellular telephone 3380. It can also be implemented as part of a smart-phone 3382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for generating a digital reconstruction of tissue, the method comprising:
receiving, at a computing system, image data of a tissue sample, wherein one or more sections of the tissue sample are stained with hematoxylin and eosin (H&E);
registering, by the computing system, the image data to generate registered image data based on mapping independent serial images of the image data to a common coordinate system using non-linear image registration;
identifying, by the computing system, tissue subtypes based on application of a machine learning model to the registered image data;
annotating, by the computing system, the identified tissue subtypes to generate annotated image data;
determining, by the computing system, a digital volume of the tissue sample in three dimensional (3D) space based on the annotated image data; and
returning, by the computing system, the digital volume of the tissue sample in 3D space to be presented in a graphical user interface (GUI) display at a user computing device.

2. The method of claim 1, wherein the tissue sample is at least one of a pancreatic tissue sample, a skin tissue sample, a breast tissue sample, a lung tissue sample, and a small intestines tissue sample.

3. The method of claim 1, further comprising determining, by the computing system, 3D radial density of each identified tissue subtype and each cell in the digital volume of the tissue sample.

4. The method of claim 1, wherein the image data is between 1× and 40× magnification, wherein lateral x and y resolution is between 0.2 μm and 10 μm and axial z resolution is between 0.5 μm and 40 μm.

5. The method of claim 1, wherein registering, by the computing system, the image data to generate registered image data further comprises:
identifying, as a point of reference, a center image of the image data; and
calculating global registration for each of the image data based on the point of reference.

6. The method of claim 5, wherein calculating global registration further comprises iteratively calculating registration angle and translation for each of the image data.

7. The method of claim 6, further comprising calculating elastic registration for each of the image data based on calculating rigid registration of cropped image tiles of each of the globally registered image data at intervals that range between 0.1 mm and 5 mm.

8. The method of claim 1, wherein the tissue sample includes at least one of normal human tissue, precancerous human tissue, and cancerous human tissue.

9. The method of claim 1, further comprising normalizing, by the computing system, the registered image data to generate normalized image data based on:
correcting two dimensional (2D) serial cell counts based on in-situ measured nuclear diameter of cells in the tissue sample;
locating nuclei in each histological section of the registered image data based on color deconvolution;
for each located nuclei, measuring in-situ diameters of each cell type;
mapping the nuclei in a serial 2D z plane; and
extrapolating true cell counts from the serial 2D z plane.

10. The method of claim 1, further comprising normalizing, by the computing system, the registered image data to generate normalized image data based on:
extracting, using color deconvolution, a hemotoxylin channel from each of the image data depicting the one or more sections of the tissue samples stained with H&E; and
for each of the image data depicting the one or more sections of the tissue samples stained with H&E:
identifying a tissue region in the image data based on detecting regions of the image data with low green channel intensity and high red-green-blue (rbg) standard deviation;
converting rgb channels in the image data to optical density;
identifying clusters, based on kmeans clustering, to represent one or more optical densities of the image data; and
deconvolving the image data, based on the one or more optical densities, into hemotoxylin, eosin, and background channel images.

11. The method of claim 10, further comprising:
smoothing, for each of the image data, the hemotoxylin channel image; and
identifying, for each of the image data, a nuclei in the smoothed hemotoxylin channel image.

12. The method of claim 1, wherein the machine learning model was trained, by the computing system, with manual annotations of one or more tissue subtypes in a plurality of training tissue image data, wherein the machine learning model is at least one of a deep learning semantic segmentation model, a convolutional neural network (CNN), and a U-net structure.

13. The method of claim 12, further comprising training, by the computing system, the machine learning model based on randomly overlaying extracted annotated regions of one or more tissue samples on a training image and cutting the training image into the plurality of training tissue image data.

14. The method of claim 13, wherein training the machine learning model further comprises:
identifying, by the computing system, bounding boxes around each annotated region of the one or more tissue samples; and
randomly overlaying each identified bounding box containing a least represented tissue subtype on a blank image tile until the tile is at least 65% full of annotated regions of the one or more tissue samples.

15. The method of claim 14, wherein the image tile is an rgb image composed of overlaid manual annotations, and wherein the image tile is cut, by the computing system, into a plurality of image tiles for use with the machine learning model.

16. The method of claim 1, wherein the machine learning model is trained, by the computing system, to identify at least one of inflammation, cancer cells, and extracellular matrix (ECM) in the image data.

17. The method of claim 1, wherein the tissue subtypes include at least one of normal ductal epithelium, pancreatic intraepithelial neoplasia, intraductal papillary mucinous neoplasm, PDAC, smooth muscle and nerves, acini, fat, ECM, and islets of Langerhans.

18. The method of claim 1, wherein determining, by the computing system, the digital volume of the tissue sample in 3D space based on the annotated image data comprises consolidating multi-labeled image data into a 3D matrix based on registering (i) the annotated image data and (ii) cell coordinates counted on unregistered histological sections of the annotated image data.

19. The method of claim 18, wherein the 3D matrix is subsampled, by the computing system, using nearest neighbor interpolation from original voxel dimensions of 2×2×12 μm³/voxel to an isotropic 12×12×12 μm³/voxel.

20. The method of claim 1, further comprising classifying, by the computing system, the image data based on pixel resolution, annotation tissue classes, color definitions for labeling of tissue classes, and names of tissue subtypes corresponding to labels associated with each class of tissue subtypes.

21. The method of claim 1, further comprising, for each tissue subtype:
summing, by the computing system, pixels of the tissue sample in a z dimension;
generating, by the computing system, a projection of a volume of the tissue sample on an xy axis;
normalizing, by the computing system, the projection based on the projection's maximum; and
visualizing, by the computing system, the projection using a same color scheme created for visualization of the tissue sample in the 3D space.

22. The method of claim 1, further comprising calculating, by the computing system, cell density of each tissue subtype in the tissue sample using the digital volume of the tissue sample.

23. The method of claim 1, further comprising measuring, by the computing system, tissue connectivity in the tissue sample using the digital volume of the tissue sample.

24. The method of claim 1, further comprising calculating, by the computing system, collagen fiber alignment in the tissue sample using the digital volume of the tissue sample.

25. The method of claim 1, further comprising calculating, by the computing system, a fibroblast aspect ratio of the tissue sample based on measuring a length of major and minor axis of nuclei in a ductal submucosa in the digital volume of the tissue sample.

26. The method of claim 1, further comprising generating, by the computing system, immune cell heatmaps of pancreatic cancer precursor legions based on the digital volume of the tissue sample and using at least one of H&E, immunocytochemistry (HC), immunofluorescence (IF), imaging mass cytometry (IMC), and spatial transcriptomics.

27. The method of claim 1, further comprising:
retrieving, by the computing system and from a data store, one or more deep learning models that were trained using patient tissue training data, wherein the one or more deep learning models are configured to (i) generate multi-dimensional volumes of patient tissue from patient tissue image data and (ii) determine stiffness measurements of tissue components in the multi-dimensional volumes of patient tissue, wherein the patient tissue training data is different than the tissue sample and wherein the patient tissue image data is different than the image data;
generating, by the computing system, the digital volume of the tissue sample in 3D space based on applying the one or more deep learning models to the image data;
determining, by the computing system, stiffness measurements of the tissue components of the tissue sample based on applying the one or more deep learning models to the digital volume of the tissue sample; and
returning, by the computing system, the determined stiffness measurements for the tissue components of the tissue sample.

28. The method of claim 27, wherein the tissue sample is a breast tissue.

29. The method of claim 27, wherein determining, by the computing system, stiffness measurements of the tissue components of the tissue sample comprises determining Pearson or Spearman correlation and statistical significance for each of the tissue components in the digital volume of the tissue sample.

30. The method of claim 27, wherein the stiffness measurements correspond to at least one of (i) resistances of the tissue components of the tissue sample to deformation, (ii) elastic modulus, and (iii) Young's modulus.
